(19) United States
(12) Patent Application Publication
(10) Pub. No.: US 2026/0159443 A1
(43) Pub. Date: Jun. 11, 2026

(54) FOLDABLE APPARATUS, FOLDABLE SUBSTRATE, AND METHODS OF TREATING A GLASS SUBSTRATE

(71) Applicant: CORNING INCORPORATED, CORNING, NY (US)

(72) Inventors: Joy Banerjee, Corning, NY (US); Timothy James Kiczenski, Corning, NY (US); Peter Joseph Lezzi, Corning, NY (US); Aize Li, Painted Post, NY (US); Michelle Diane Pierson-Stull, Painted Post, NY (US); Vitor Marino Schneider, Painted Post, NY (US)

(21) Appl. No.: 19/406,236

(22) Filed: Dec. 2, 2025

Related U.S. Application Data
(60) Provisional application No. 63/729,688, filed on Dec. 9, 2024.

(51) Int. Cl. C03C 21/00; C03C 3/087; C03C 15/00; C03C 23/00

(52) U.S. Cl. CPC C03C 21/002; C03C 3/087; C03C 15/00; C03C 23/007

(57) ABSTRACT

Methods of treating a glass substrate including heating the glass substrate at a first temperature for a first period of time from greater than or equal to 1 minute to less than or equal to 2 hours to form a heat-treated glass substrate. The first temperature is less than an annealing point of the glass substrate by from greater than or equal to 10° C. to less than or equal to 150° C. The glass substrate has a substrate thickness from greater than or equal to 25 micrometers to less than or equal to 300 micrometers. Methods further comprise chemically strengthening the heat-treated glass substrate to form a chemically strengthened glass substrate having a first compressive stress region extending from the first major surface to a first depth of compression from greater than or equal to 5 μm to less than or equal to 30% of the substrate thickness.

This application claims the benefit of priority under 35 U.S.C. § 119 of U.S. Provisional Application Ser. No. 63/729,688 filed on Dec. 9, 2024, the content of which is relied upon and incorporated herein by reference in its entirety.

### FIELD

The present disclosure relates generally to foldable apparatus, foldable substrates, and methods of treating a glass substrate and, more particularly, to foldable substrates that are chemically strengthened, foldable apparatus containing the same, and methods of treating a glass substrate including chemically strengthening the glass substrate.

### BACKGROUND

Glass-based substrates are commonly used, for example, in display devices, e.g., liquid crystal displays (LCDs), electrophoretic displays (EPD), organic light-emitting diode displays (OLEDs), plasma display panels (PDPs), or the like.

There is a desire to develop foldable versions of displays as well as foldable protective covers to mount on foldable displays. Foldable displays and covers should have good impact and puncture resistance. At the same time, foldable displays and covers should have small minimum bend radii (e.g., 10 millimeters (mm) or less). Plastic displays and covers with small minimum bend radii tend to have poor impact resistance and/or puncture resistance. Furthermore, conventional wisdom suggests that ultra-thin glass-based sheets (e.g., 75 micrometers (μm or microns) or less thick) with small minimum bend radii tend to have poor impact resistance and/or puncture resistance. Still further, thicker glass-based sheets (e.g., greater than 125 micrometers) with good impact resistance and/or puncture resistance tend to have relatively large minimum bend radii (e.g., 30 millimeters or more). Consequently, there is a need to develop foldable apparatus that have increased compressive stress, low minimum bend radii, good impact resistance, and/or good puncture resistance.

### SUMMARY

There are set forth herein methods of treating glass substrates prior to being chemically strengthened. Unexpectedly, as demonstrated by the examples herein (e.g., see FIGS. 18-19 and 21), the heating can enable increased compressive stress to be developed from the chemical strengthening even though the duration of the heating too short (and/or the temperature too low) to significantly modify the fictive temperature. In contrast to annealing, the heating of the present disclosure is at a temperature less than the annealing temperature and for a period of time less than or equal to 1.5 hours. Further, FIG. 19 demonstrates that the increase in compressive stress is largely time-independent—for as short as 1 minute—in contrast to the expected time-dependence. For example, these results indicate that compressive stress increases comparable to that of an 8+ hour heat treatment can be achieved by a 30-minute heat treatment (16× less time). This indicates that comparable increases in compressive stress can be achieved by shorter duration heat treatments than would have otherwise been thought possible. Also, this represents a significant savings in energy costs (for maintaining the temperature during the heat treatment) and increased throughput (due to shorter heat treatments). Moreover, FIG. 21 demonstrates that this increase in compressive stress cannot be attributed to changes in the fictive temperature since the fictive temperature is not significantly effected by the heating.

The temperature range of the heating associated with the unexpectedly increased compressive stress is bounded, as shown in FIG. 18. At higher temperatures, changes in fictive temperature become more pronounced. At lower temperatures, the compressive stress is decreased as a result of heating. Consequently, the unexpectedly increased compressive stress as a result of the heating occurs between 150° C. below the annealing point temperature to less than the annealing point temperature (e.g., 10° C. less than the annealing point temperature)—with more pronounced increases in compressive stress seen in the range from 100° C. below the annealing point temperature to 25° C. less than the annealing point temperature. Also, heating the foldable substrate before chemically strengthening the foldable substrate can reduce thermal shock to the foldable substrate in addition to facilitating a more even compressive stress region across the surfaces of the foldable substrate.

Additionally, providing the first potassium salt with multiple (i.e., two or more) potassium atoms per anion can increase an effective concentration and/or activity of potassium in the molten salt solution, which can facilitate increased maximum compressive stress in the resulting chemically-strengthened foldable substrate. Providing a first potassium salt in the molten salt solution with a pKa of 9 or above can improve the strength and/or foldability of the resulting chemically-strengthened foldable substrate, for example, by selectively etching flaws inherent in the foldable substrate that might otherwise be magnified by the chemical strengthening treatment. Exemplary aspects of potassium salts with more than two potassium atoms per anion and a pKa of 9 or more include potassium carbonate (K₂CO₃) and potassium phosphate (K₃PO₄). Providing pH from 9 to 12 of the molten salt solution can improve the strength and/or foldability of the resulting chemically-strengthened foldable substrate, for example, by selectively etching flaws inherent in the foldable substrate that might otherwise be magnified by the chemical strengthening treatment.

Additionally, without wishing to be bound by theory, it is believed that the carbonate anion can facilitate precipitation of other cations (e.g., lithium, sodium) exchanged out of the foldable substrate, which can increase a longevity of the molten salt solution (e.g., by removing components from the solution phase that could otherwise “poison” the molten salt solution). As demonstrated by the Examples discussed herein, providing a first temperature of the molten salt solution less than 400° C. can increase a maximum compressive stress developed for a predetermined depth of layer and/or depth of compression. Also, for some of the molten salt solutions discussed herein, a temperature of 350° C. or more may be used to ensure that salts are molten. Further, increases in compressive stress from the heating are cumulative with increases using the molten salt bath having multiple anions (e.g., including the carbonate anion), as demonstrated in FIGS. 34, 36, 38, and 40.

For example, the presence of the first potassium salt can increase a compressive stress imparted by the contacting the existing first major surface (in at least step 1005) with the molten salt solution 1303 by 5% or more (e.g., 10% or more, from 5% to 20%, from 5% to 15%, or from 7% to 10%) relative to immersing the foldable substrate in a comparative molten salt solution with the same composition as the molten salt solution with the absence of the first potassium salt-even when the foldable substrate is heat treated in step 1003. As demonstrated by the examples herein, the combination of the heat treatment (step 1003) and the multiple anions in the molten salt solution (step 1005) provides further increases to compressive stress relative to doing either treatment on its own. Providing an initial temperature of the cooling chamber that is lower than the molten salt solution (e.g., by 50° C. or more, 100° C. or more, or 140° C. or more) can decrease a residual chemical strengthening occurring from any residual portion of the molten salt solution or deposits from the molten salt solution on the foldable substrate after it is removed from the molten salt solution). In particular, it has been observed that foldable substrates with a thickness of 50 μm or less (e.g., from 10 μm to 50 μm or from 10 μm to 30 μm) are unexpectedly sensitive to what happens after the foldable substrate is removed from the molten salt solution. For these thin foldable substrates, even a relatively small difference in compressive stress across the surface thereof can result in waviness and/or warp that can produce optical distortions that can be visible to a user of a consumer electronic product that the foldable substrate may be incorporated in. Consequently, the controlled temperature of the cooling chamber can facilitate a relatively even compressive stress across the surface of the foldable substrate. Also, providing an initial temperature of the cooling chamber of 180° C. or more (e.g., 200° C. or more or 220° C. or more) can facilitate the removal of a residual portion of the molten salt solution before it solidifies. Reducing the temperature of the cooling chamber to a final temperature of 90° C. or less can enable the foldable substrate to be subsequently treated (e.g., relatively quickly or immediately) thereafter using aqueous solutions (e.g., rinsing with water or an alkaline detergent solution, contact with an aqueous acidic solution). Providing a cooling rate from 4° C./min to 20° C./min can quickly reduce a temperature of the cooling chamber (and foldable substrate) while being able to maintain a relatively consistent temperature throughout the cooling chamber (and/or foldable substrate), for example, to produce a relatively consistent compressive stress across the surface of the foldable substrate.

Taken together, FIGS. 30-31 demonstrate that the heating of Example 3 provides the warp and curvature metrics (including maximum, skewness, and kurtosis) that is comparable or better than Example AA while Example 3 further provides increased compressive stress (and foldability) relative to Example AA. Providing an etching rate of 1.0 μm/min or less (e.g., 0.55 μm/min or less) can facilitate a substantially uniform removal of material from the surface(s) of the foldable substrate. As discussed above, foldable substrates with a thickness of 50 μm or less are quite sensitive to differences in compressive stress and thickness variation across its surface. Consequently, providing an etching rate of 1.5 μm/min can remove a relatively uniform thickness and portion of the compressive stress from the surface(s) to reduce an incidence of waviness and/or warp that can produce optical distortions that can be visible to a user of a consumer electronic product that the foldable substrate may be incorporated in.

Some example aspects of the disclosure are described below with the understanding that any of the features of the various aspects may be used alone or in combination with one another.
Aspect 1. A method of treating a glass substrate:
heating the glass substrate at a first temperature for a first period of time from greater than or equal to 1 minute to less than or equal to 2 hours to form a heat-treated glass substrate, the first temperature is less than an annealing point of the glass substrate by from greater than or equal to 10° C. to less than or equal to 150° C., and the glass substrate having a substrate thickness between a first major surface and a second major surface in a range from greater than or equal to 25 micrometers to less than or equal to 300 micrometers; and
chemically strengthening the heat-treated glass substrate to form a chemically strengthened glass substrate having a first compressive stress region extending from the first major surface to a first depth of compression from greater than or equal to 5 μm to less than or equal to 30% of the substrate thickness.
Aspect 2. The method of aspect 1, wherein the first temperature is less than an annealing point of the glass substrate by from greater than or equal to 50° C. to less than or equal to 75° C.
Aspect 3. The method of any one of aspects 1-2, wherein the first period of time is from greater than or equal to 5 minutes to less than or equal to 1.5 hours.
Aspect 4. The method of any one of aspects 1-2, wherein the first period of time is from greater than or equal to 5 minutes to less than or equal to 30 minutes.
Aspect 5. The method of any one of aspects 1-4, wherein the heating occurs in air.
Aspect 6. The method of any one of aspects 1-5, wherein the heating occurs in a non-strengthening molten salt solution, where the heating does not develop a compressive stress region in the heat-treated glass substrate.
Aspect 7. The method of aspect 6, wherein the non-strengthening molten salt solution comprises an alkali chloride or an alkali sulfate salt.
Aspect 8. The method of any one of aspects 1-7, wherein a temperature of the heat-treated glass substrate is maintained at a temperature greater than or equal to 300° C. between the heat treating and the chemically strengthening the heat-treated glass substrate.
Aspect 9. The method of any one of aspects 1-8, wherein a maximum compressive stress of the first compressive stress region is from greater than or equal to 800 MegaPascals to less than or equal to 1,500 MegaPascals.
Aspect 10. The method of any one of aspects 1-9, wherein a maximum compressive stress of the first compressive stress region is greater than a glass substrate without the heating by greater than or equal to 100 MegaPascals.
Aspect 11. The method of any one of aspects 1-9, wherein a maximum compressive stress of the first compressive stress region is greater than a comparative compressive stress of a comparative compressive stress region of a glass substrate chemically strengthened without the heating by greater than or equal to 10% of the comparative compressive stress.
Aspect 12. The method of any one of aspects 1-9, wherein a comparative etching rate of a glass substrate chemically strengthened without the heating is greater than an etching rate of the chemically strengthened glass substrate including the heat treatment by greater than or equal to 3% to less than or equal to 10% of the comparative etching rate.
Aspect 13. The method of any one of aspects 1-9, wherein a comparative minimum parallel plate distance of a glass substrate chemically strengthened without the heating is greater than a minimum parallel plate distance of the chemically strengthened glass substrate by greater than or equal to 10% of the comparative minimum parallel plate distance.
Aspect 14. The method of any one of aspects 1-9, wherein a survival rate of the chemically strengthened glass substrate including the heat treatment at a parallel plate distance of 3 millimeters is greater than a comparative survival rate of a glass substrate chemically strengthened without the heating at the parallel plate distance of 3 millimeters by greater than or equal to 10%.
Aspect 15. The method of any one of aspects 1-9, wherein a comparative shape kurtosis of a glass substrate chemically strengthened without the heating is greater than a shape kurtosis of the chemically strengthened glass substrate including the heat treatment by greater than or equal to 15% to less than or equal to 75%.
Aspect 16. The method of any one of aspects 1-14, wherein the chemically strengthened glass substrate exhibits a shape kurtosis from greater than or equal to 2 to less than or equal to 6.
Aspect 17. The method of any one of aspects 1-16, wherein the chemically strengthened glass substrate exhibits a warp of less than or equal to 1 millimeter.
Aspect 18. The method of any one of aspects 1-17, wherein the chemically strengthened glass substrate exhibits a shape skewness from greater than or equal to −1.5 to less than or equal to 1.5.
Aspect 19. The method of any one of aspects 1-18, wherein the chemically strengthened glass substrate exhibits a maximum curvature less than or equal to 1 Diopter.
Aspect 20. The method of any one of aspects 1-19, wherein the chemically strengthened glass substrate exhibits a curvature skewness from greater than or equal to −1 to less than or equal to 1 and a curvature kurtosis from greater than or equal to 2 to less than or equal to 4.
Aspect 21. The method of any one of aspects 1-20, wherein the chemical strengthening comprises contacting the heat-treated glass substrate with a molten salt solution maintained at a second temperature from greater than or equal to 350° C. to less than or equal to 450° C. for a second period of time from greater than or equal to 10 minutes to less than or equal to 180 minutes.
Aspect 22. The method of aspect 21, wherein the molten salt solution comprises at least two anions associated with at least a first potassium salt and a second potassium salt, a concentration of the first potassium salt potassium salt and a concentration of the second potassium salt is greater than or equal to 2 wt % to less than or equal to 12 wt % of the molten salt solution, the second temperature is from greater than or equal to 350° C. to less than or equal to 400° C., and the second period of time is from greater than or equal to 10 minutes to less than or equal to 90 minutes.
Aspect 23. The method of aspect 22, wherein the first potassium salt comprises two or more potassium atoms per anion, and a pKa of the potassium salt is greater than or equal to 9, and a concentration of the first potassium salt is in a range from greater than or equal to 2.0 wt % to less than or equal to 5.0 wt % of the molten salt solution.
Aspect 24. The method of any one of aspects 22-23, wherein the first potassium salt is potassium carbonate K₂CO₃, and a concentration of the first potassium salt is in a range from greater than or equal to 2.0 wt % to less than or equal to 5.0 wt % of the molten salt solution.
Aspect 25. The method of any one of aspects 21-24, further comprising:
transferring the substrate from the molten salt solution to a cooling chamber, a temperature of the cooling chamber decreases from an initial temperature to a final temperature at a cooling rate in a range from greater than or equal to 4° C./min to less than or equal to 20° C./min, the initial temperature is in a range from greater than or equal to 180° C. to less than or equal to 300° C., and the final temperature is in a range from greater than or equal to 25° C. to less than or equal to 90° C.
Aspect 26. The method of aspect 25, further comprising, after the cooling chamber reaches the final temperature, rinsing the chemically strengthened glass substrate with water, an alkaline detergent solution, or combinations thereof.
Aspect 27. The method of any one of aspects 1-26, further comprising: rinsing the chemically strengthened glass substrate with an alkaline detergent solution.
Aspect 28. The method of any one of aspects 1-27, further comprising: contacting the first major surface with an acidic solution for a second period of time to remove an outer layer from the first major surface to form a new first major surface; and then rinsing the new first major surface with water or an alkaline detergent solution.
Aspect 29. The method of aspect 28, wherein a pH of the acidic solution is in a range from 3.5 to 4.5, and the second period of time is from 10 seconds to 3.5 minutes.
Aspect 30. The method of any one of aspects 28-29, wherein the acidic solution removes the outer layer at rate of 1.0 micrometers per minute or less.
Aspect 31. The method of any one of aspects 1-30, wherein the substrate thickness is from greater than or equal to 30 micrometers to less than or equal to 100 micrometers.
Aspect 32. The method of any one of aspects 1-31, wherein the foldable substrate exhibits a survival rate of greater than 50% at a parallel plate distance in millimeters equal to 0.08 mm/μm times the substrate thickness in micrometers.
Aspect 33. The method of any one of aspects 1-31, wherein the foldable substrate exhibits a survival rate of greater than 20% at a parallel plate distance in millimeters equal to 0.067 mm/μm times the substrate thickness in micrometers.
Aspect 34. The method of any one of aspects 1-33, wherein a composition of the glass substrate, as a mol % of the glass substrate, comprises:
from greater than or equal to 60 mol % to less than or equal to 70 mol % SiO₂;
from greater than or equal to 8 mol % to less than or equal to 16 mol % Al₂O₃;
from greater than or equal to 12 mol % to less than or equal to 18 mol % Na₂O;
from greater than or equal to 2 mol % to less than or equal to 6 mol % MgO; and
from greater than or equal to 0.1 mol % to less than or equal to 2.0 mol % CaO.
Aspect 35. The method of any one of aspects 1-33, wherein a composition of the foldable substrate comprises:
from greater than or equal to 60 mol % to less than or equal to 72 mol % SiO₂;
from greater than or equal to 8 mol % to less than or equal to 17 mol % Al₂O₃;
from greater than or equal to 0 mol % to less than or equal to 2 mol % B₂O₃;
from greater than or equal to 0 mol % to less than or equal to 2 mol % P₂O₅;
from greater than or equal to 12 mol % to less than or equal to 20 mol % R₂O; and
from greater than or equal to 3 mol % to less than or equal to 7 mol % RO.
Aspect 36. The method of any one of aspects 34-35, wherein the composition of the foldable substrate comprises:
from greater than or equal to 14 mol % to less than or equal to 19 mol % Na₂O;
from greater than or equal to 0 mol % to less than or equal to 1 mol % Li₂O; and
from greater than or equal to 0 mol % to less than or equal to 0.5 mol % K₂O.
Aspect 37. The method of any one of aspects 34-36, wherein the composition of the foldable substrate exhibits Al₂O₃—Na₂O from greater than or equal to −6.0 mol % to less than or equal to −2.0 mol %.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### BRIEF DESCRIPTION OF THE DRAWINGS

The above and other features and advantages of aspects of the present disclosure are better understood when the following detailed description is read with reference to the accompanying drawings, in which:

FIG. 1 is a schematic view of an example foldable apparatus in a flat configuration according to aspects, wherein a schematic view of the folded configuration may appear as shown in FIG. 5;

FIG. 2 is a cross-sectional view of an example foldable apparatus consisting of a foldable substrate taken along line 2-2 of FIG. 1 according to aspects;

FIG. 3 is a cross-sectional view of an example foldable apparatus along line 2-2 of FIG. 1 according to aspects;

FIG. 4 is a schematic view of example foldable apparatus of aspects of the disclosure in a folded configuration wherein a schematic view of the flat configuration may appear as shown in FIG. 1;

FIG. 5 is a cross-sectional view of a testing apparatus to determine the minimum parallel plate distance of an example modified foldable apparatus and/or foldable substrate along line 5-5 of FIG. 4;

FIG. 6 is a schematic perspective view of a pen drop apparatus;

FIG. 7 is a schematic perspective view of a foldable consumer electronic product;

FIG. 8 is a schematic plan view of an example consumer electronic device according to aspects;

FIG. 9 is a schematic perspective view of the example consumer electronic device of FIG. 8;

FIG. 10 is a flow chart illustrating example methods of chemically strengthening a substrate to form a foldable substrate and/or foldable apparatus in accordance with aspects of the disclosure;

FIG. 11 schematically illustrates a step in a method of treating a glass substrate comprising heating the substrate;

FIG. 12 schematically illustrates a step in a method of treating a glass substrate comprising heating the substrate in a non-strengthening molten salt solution;

FIG. 13 schematically illustrates a step in a method of treating a glass substrate comprising chemically strengthening the glass substrate in a molten salt solution;

FIG. 14 schematically illustrates a step in a method of treating a glass substrate comprising decreasing a temperature of a cooling chamber and/or allowing the molten salt solution to drip off of the glass substrate;

FIG. 15 schematically illustrates a step in a method of treating a glass substrate comprising rinsing the chemically strengthened glass substrate;

FIG. 16 schematically illustrates a step in a method of treating a glass substrate comprising contacting the substrate with an alkaline detergent solution or an acidic solution;

FIG. 17 is a cross-sectional view of a foldable apparatus after the step shown in FIG. 13 and/or before the step shown in FIG. 16;

FIG. 18 schematically illustrates a change in compressive stress (%) following chemical strengthening (vertical axis—y-axis) as a function of heating temperature (° C.) (horizontal axis—x-axis) of the heat treatment;

FIG. 19 schematically illustrates a change in compressive stress (%) following chemical strengthening (vertical axis—y-axis) as a function of time in minutes (min) (horizontal axis—x-axis) of the heat treatment;

FIG. 20 schematically illustrates fictive temperature (Tf) in ° C. (vertical axis-y-axis) as a function of heat treatment (horizontal axis—x-axis);

FIG. 21 schematically illustrates a change in compressive stress (%) following chemical strengthening (vertical axis—y-axis) due to the heat treatment of Example 9 for glasses of composition C1 and C2;

FIG. 22 schematically illustrates a concentration profile in mol % (vertical axis-y-axis) of alkali metal oxides as a function of depth in micrometers (μm) from the first major surface of glass substrates (horizontal axis—x-axis) for Examples AA and 7 having a composition C1 that were chemically strengthened with condition K3;

FIG. 23 schematically illustrates a concentration profile in mol % (vertical axis-y-axis) of alkali metal oxides as a function of depth in micrometers (μm) from the first major surface of glass substrates (horizontal axis—x-axis) for Examples AA and 8 having a composition C2 that were chemically strengthened with condition K3;

FIG. 24 schematically illustrates a ratio of compressive stress (CS) to Young's modulus (E-CS/E) of glass substrates (vertical axis—y-axis) as a function of heating time (t) in hours (h) of the heat treatment (horizontal axis—x-axis) have a substrate thickness of 0.8 mm;

FIG. 25 schematically illustrates a survival rate (yield—Y) in percent (vertical axis—y-axis) as a function of parallel plate distance (PP) in millimeters (horizontal axis—x-axis) for Examples AA and 3 having composition C2 and a substrate thickness of 30 μm;

FIG. 26 schematically illustrates compressive stress (CS) in MegaPascals (MPa) of glass substrates (vertical axis—y-axis) as a function of a square root of heating time (Vt) in Vminute (Vmin) (horizontal axis—x-axis) for substrates of Composition 2 having a substrate thickness of 30 μm subjected to the heat treatment of Example 4 and chemically strengthened under condition K3;

FIG. 27 schematically illustrates a depth of layer (DOL) in micrometers (μm) of glass substrates (vertical axis—y-axis) as a function of a square root of heating time (Vt) in Vminute (Vmin) (horizontal axis—x-axis) for substrates of Composition 2 having a substrate thickness of 30 μm subjected to the heat treatment of Example 4 and chemically strengthened under condition K3;

FIG. 28 schematically illustrates a failure load (F) in Newtons (N) in a Quasi-Static Puncture Test (vertical axis—y-axis) as a function of heating time (t) in minutes (min) of the heat treatment (horizontal axis—x-axis) for glass substrates of composition C2 having a substrate thickness of 30 μm;

FIG. 29 schematically illustrates a warp (W) in millimeters (mm) (vertical axis-y-axis) for various example substrates subjected to the heat treatment of Example 7, 9, or 10 followed by chemical strengthening under condition K3 in accordance with aspects;

FIG. 30 schematically illustrates a warp (W) in millimeters (mm), warp skewness (Sk), warp kurtosis (ku) (vertical axis—y-axis) for substrates having composition C2 and a substrate thickness subjected to the heat treatment Examples 1˜4 and AA followed by chemical strengthening under condition K3;

FIG. 31 schematically illustrates a curvature (C) in diopters (D), curvature skewness (Sk), curvature kurtosis (ku) (vertical axis—y-axis) for substrates having composition C2 and a substrate thickness subjected to the heat treatment Examples 1˜4 and AA followed by chemical strengthening under condition K3;

FIG. 32 schematically illustrates a thickness etched (RD) in micrometers (μm) (vertical axis—y-axis) for Examples 7, 9, and AA etched in an aqueous solution of 2 wt % HF for 300 seconds for substrates of composition C1;

FIG. 33 schematically illustrates a thickness etched (RD) in micrometers (μm) (vertical axis—y-axis) for Examples 7, 9, and AA etched in a buffered HF solution for 300 seconds for substrates of composition C2;

FIG. 34 schematically illustrates compressive stress (CS) in MegaPascals (MPa) (vertical axis—y-axis) for substrates having composition C1 and a substrate thickness of 75 μm subjected to the heat treatments of Examples 5-8 and AA chemically strengthened under conditions K1-K3;

FIG. 35 schematically illustrates depth of layer (DOL) in micrometers (μm) (vertical axis—y-axis) for substrates having composition C1 and a substrate thickness of 75 μm subjected to the heat treatments of Examples 5-8 and AA chemically strengthened under conditions K1-K3;

FIG. 36 schematically illustrates compressive stress (CS) in MegaPascals (MPa) (vertical axis—y-axis) for substrates having composition C2 and a substrate thickness of 75 μm subjected to the heat treatments of Examples 5-8 and AA chemically strengthened under conditions K1-K3;

FIG. 37 schematically illustrates depth of layer (DOL) in micrometers (μm) (vertical axis—y-axis) for substrates having composition C2 and a substrate thickness of 75 μm subjected to the heat treatments of Examples 5-8 and AA chemically strengthened under conditions K1-K3;

FIG. 38 schematically illustrates compressive stress (CS) in MegaPascals (MPa) (vertical axis—y-axis) for substrates having composition C1 and a substrate thickness of 30 μm subjected to the heat treatments of Examples 5-8 and AA chemically strengthened under conditions K1-K3;

FIG. 39 schematically illustrates depth of layer (DOL) in micrometers (μm) (vertical axis—y-axis) for substrates having composition C1 and a substrate thickness of 30 μm the heat treatments of Examples 5-8 and AA chemically strengthened under conditions K1-K3;

FIG. 40 schematically illustrates compressive stress (CS) in MegaPascals (MPa) (vertical axis—y-axis) for substrates having composition C2 and a substrate thickness of 30 μm subjected to the heat treatments of Examples 5-8 and AA chemically strengthened under conditions K1-K3; and

FIG. 41 schematically illustrates depth of layer (DOL) in micrometers (μm) (vertical axis—y-axis) for substrates having composition C2 and a substrate thickness of 30 μm subjected to the heat treatments of Examples 5-8 and AA chemically strengthened under conditions K1-K3.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Aspects will now be described more fully hereinafter with reference to the accompanying drawings in which example aspects are shown. Whenever possible, the same reference numerals are used throughout the drawings to refer to the same or like parts. However, claims may encompass many different aspects of various aspects and should not be construed as limited to the aspects set forth herein.

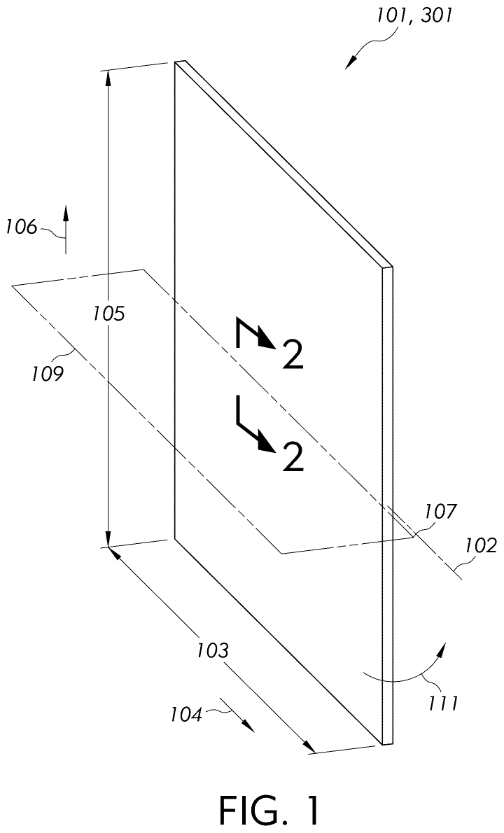

FIGS. 1-5 illustrate schematic views of foldable apparatus 101, 301, and/or 401 comprising a foldable substrate 201 in accordance with aspects of the disclosure. Unless otherwise noted, a discussion of features of aspects of one foldable apparatus and/or foldable substrate can apply equally to corresponding features of any aspects of the disclosure. For example, identical part numbers throughout the disclosure can indicate that, in some aspects, the identified features are identical to one another and that the discussion of the identified feature of one aspect, unless otherwise noted, can apply equally to the identified feature of any of the other aspects of the disclosure.

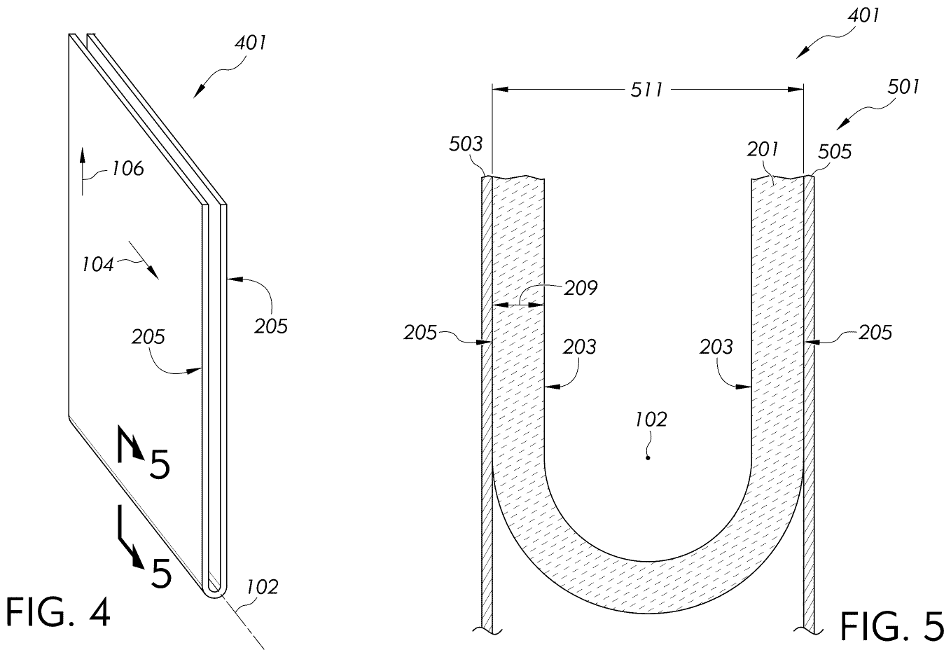

As shown in FIGS. 1-3, example aspects of foldable apparatus 101 and/or 301 can comprise the foldable substrate 201 in accordance with aspects of the disclosure in an unfolded (e.g., flat) configuration while FIG. 5 demonstrate a foldable apparatus 401 comprising the foldable substrate 201 in accordance with aspects of the disclosure in a folded configuration. In aspects, as shown in FIGS. 4-5, the foldable apparatus 401 can comprise and/or consist of the foldable substrate 201. In aspects, as shown in FIG. 3, the foldable apparatus 301 can comprise a layer (e.g., PET sheet 321) attached to the foldable substrate 201 by an adhesive layer 311 with the understanding that other layers (e.g., release liners, display devices, additional substrates) can be used in addition or instead of the shown layer.

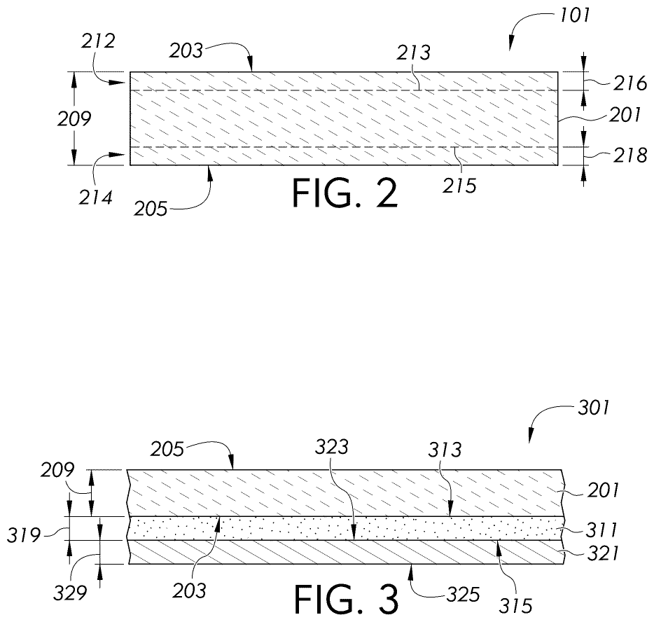

Throughout the disclosure, with reference to FIG. 1, the width 103 of the foldable apparatus 101 and/or 301 is considered the dimension of the foldable apparatus taken between opposed edges of the foldable apparatus in a direction 104 of a fold axis 102 of the foldable apparatus, wherein the direction 104 also comprises the direction of the width 103. Furthermore, throughout the disclosure, the length 105 of the foldable apparatus 101 and/or 301 is considered the dimension of the foldable apparatus 101 and/or 301 taken between opposed edges of the foldable apparatus 101 and/or 301 in a direction 106 perpendicular to the fold axis 102 of the foldable apparatus. In aspects, as shown in FIGS. 1-3, the foldable apparatus of any aspects of the disclosure can comprise a fold plane 109 that includes the fold axis 102 and a direction of a substrate thickness 209 when the foldable apparatus is in the flat configuration (e.g., see FIG. 2). The fold plane 109 may comprise a central axis 107 of the foldable apparatus positioned, for example, at a second major surface 205 of the foldable apparatus 101 and 301 (see FIGS. 2-3). In aspects, the foldable apparatus can be folded in a direction 111 (e.g., see FIG. 1) about the fold axis 102 extending in the direction 104 of the width 103 to form a folded configuration (e.g., see FIGS. 4-5). In aspects, as shown in FIGS. 2-3, the foldable apparatus 101 and/or 301 and/or the foldable substrate 201 can comprise a first major surface 203 and/or a second major surface 205 that are substantially planar, where a central portion of the foldable apparatus can be indistinguishable from adjacent portions. As shown in FIGS. 1-5, the foldable apparatus may include a single fold axis to allow the foldable apparatus to comprise a bifold wherein, for example, the foldable apparatus may be folded in half. In further aspects, the foldable apparatus may include two or more fold axes, for example, with each fold axis including a corresponding central portion similar or identical to the central portion discussed herein. For example, providing two fold axes can allow the foldable apparatus to comprise a trifold wherein, for example, the foldable apparatus may be folded with the first portion, the second portion, and a third portion similar or identical to the first portion or second portion with the central portion and another central portion similar to or identical to the central portion positioned between the first portion and the second portion and between the second portion and the third portion, respectively.

Foldable apparatus 101 and/or 301 of the disclosure comprise the foldable substrate 201. In aspects, the foldable substrate 201 can comprise a glass substrate having a pencil hardness of 8H or more, for example, 9H or more. A glass material comprises an amorphous material (e.g., glass) that may be strengthened. As used herein, the term “strengthened” may refer to a material that has been chemically strengthened, for example, through ion exchange of larger ions for smaller ions in the surface of the substrate, as discussed below. However, other strengthening methods, for example, thermal tempering, or utilizing a mismatch of the coefficient of thermal expansion between portions of the substrate to create compressive stress and central tension regions, may be utilized to form strengthened substrates. Exemplary glass materials, which may be free of lithia or not, comprise soda lime glass, alkali aluminosilicate glass, alkali-containing borosilicate glass, alkali-containing aluminoborosilicate glass, alkali-containing phosphosilicate glass, and alkali-containing aluminophosphosilicate glass.

In aspects, the composition of the foldable substrate 201 can comprise from 40 mol % to 80 mol % SiO₂, from 5 mol % to 30 mol % Al₂O₃, from 5 mol % to 20 mol % Na₂O and/or R₂O, and optionally: from 0 mol % to 15 mol % RO; from 0 mol % to 10 mol % B₂O₃; and/or from 0 mol % to 5 mol % ZrO₂. In further aspects, the composition of the foldable substrate 201 can comprise from 60 mol % to 72 mol % SiO₂, from 8 mol % to 17 mol % Al₂O₃, from 12 mol % to 20 mol % Na₂O and/or R₂O, from 3 mol % to 7 mol % MgO and/or RO, and optionally from 0 mol % to 2 mol % of one or more of B₂O₃ and/or P₂O₅. In even further aspects, the composition of the foldable substrate 201 can further comprise from 14 mol % to 19 mol % Na₂O, from 0 mol % to 1 mol % Li₂O, and/or from 0 mol % to 0.5 mol % K₂O. In further aspects, the composition of the foldable substrate 201 can comprise from 60 mol % to 72 mol % SiO₂, from 8 mol % to 16 mol % Al₂O₃, from 12 mol % to 18 mol % Na₂O and/or R₂O, from 2 mol % to 6 mol % MgO and/or RO, optionally from 0 mol % to 2 mol % of one or more of Li₂O, CaO, B₂O₃, and/or P₂O₅ (e.g., from 0.1 mol % to 2.0 mol % CaO) and optionally from 0 mol % to 1 mol % K₂O. In further aspects, the composition of the foldable substrate 201 can comprise from 64.0 mol % 70 mol % SiO₂, from 9.5 mol % to 14.5 mol % Al₂O₃, from 14 mol % to 17 mol % Na₂O, from 3.0 mol % to 5.5 mol % MgO, from 0 mol % to 1 mol % of one or more of Li₂O, CaO, B₂O₃, and/or P₂O₅, and from 0.0 mol % to 0.5 mol % K₂O. In further aspects, Al₂O₃—R₂O (e.g., Al₂O₃—Na₂O) can be from −6.0 mol % to −2.0 mol % or from −5.8 mol % to −2.2 mol %.

In aspects, the glass substrate can be free of one or more of P₂O₅, B₂O₃, TiO₂, ZnO, ZrO₂, Ta₂O₅, HfO₂, La₂O₃, and/or Y₂O₃. Unless otherwise indicated, as used herein, the term “free” does not require absolute precision nor atomic-scale accuracy, but rather “free” means that the component may be present in the final glass-based composition in very small amounts (e.g., as a contaminant, such as less than 0.1 mol %) that could be practically obtained by a reasonable practitioner, which does include 0.0 mol % in some aspects. For example, the inclusion of ZrO₂ in the glass composition may result in the formation of undesirable zirconia inclusions in the glass material, due at least in part to the low solubility of ZrO₂ in the glass material. Also, the inclusion of Ta₂O₅, HfO₂, La₂O₃, and/or Y₂O₃ may increase the cost of raw materials associated with the glass substrate.

The foldable substrate 201 can comprise a glass substrate, and the first major surface 203 and/or second major surface 205 can comprise one or more compressive stress regions. In aspects, a compressive stress region may be created by chemically strengthening. Chemically strengthening may comprise an ion exchange process, where ions in a surface layer are replaced by—or exchanged with—larger ions having the same valence or oxidation state. Methods of chemically strengthening will be discussed later. Without wishing to be bound by theory, chemically strengthening the foldable substrate 201 can enable good impact and/or puncture resistance (e.g., resists failure for a pen drop height of 20 centimeters). Without wishing to be bound by theory, chemically strengthening the foldable substrate 201 can enable small (e.g., 10 mm or less) bend radii because the compressive stress from the chemical strengthening can counteract the bend-induced tensile stress on the outermost surface of the substrate. A compressive stress region may extend into a portion of the first portion and/or second portion for a depth called the depth of compression. As used herein, depth of compression means the depth at which the stress in the chemically-strengthened substrates and/or portions described herein changes from compressive stress to tensile stress. Depth of compression may be measured by a surface stress meter or a scattered light polariscope (SCALP, wherein values reported herein were made using SCALP-5 made by Glasstress Co., Estonia) depending on the ion exchange treatment and the thickness of the article being measured. Where the stress in the substrate and/or portion is generated by exchanging potassium ions into the substrate, a surface stress meter, for example, the FSM-6000 (Orihara Industrial Co., Ltd. (Japan)), is used to measure depth of compression. Unless specified otherwise, compressive stress (including surface CS) is measured by surface stress meter (FSM) using commercially available instruments, for example the FSM-6000, manufactured by Orihara. Surface stress measurements rely upon the accurate measurement of the stress optical coefficient (SOC), which is related to the birefringence of the glass. Unless specified otherwise, SOC is measured according to Procedure C (Glass Disc Method) described in ASTM standard C770-16, entitled “Standard Test Method for Measurement of Glass Stress-Optical Coefficient,” the contents of which are incorporated herein by reference in their entirety. Where the stress is generated by exchanging sodium ions into the substrate, and the article being measured is thicker than 400 μm, SCALP is used to measure the depth of compression and central tension (CT). Where the stress in the substrate and/or portion is generated by exchanging both potassium and sodium ions into the substrate and/or portion, and the article being measured is thicker than 400 μm, the depth of compression and CT are measured by SCALP. Without wishing to be bound by theory, the exchange depth of sodium may indicate the depth of compression while the exchange depth of potassium ions may indicate a change in the magnitude of the compressive stress (but not the change in stress from compressive to tensile). The refracted near-field (RNF; the RNF method is described in U.S. Pat. No. 8,854,623, entitled “Systems and methods for measuring a profile characteristic of a glass sample”, which is incorporated herein by reference in its entirety) method also may be used to derive a graphical representation of the stress profile. When the RNF method is utilized to derive a graphical representation of the stress profile, the maximum central tension value provided by SCALP is utilized in the RNF method. The graphical representation of the stress profile derived by RNF is force balanced and calibrated to the maximum central tension value provided by a SCALP measurement. As used herein, “depth of layer” (DOL) means the depth that the ions have exchanged into the substrate and/or portion (e.g., sodium, potassium). Through the disclosure, when the maximum central tension cannot be measured directly by SCALP (as when the article being measured is thinner than 400 μm) the maximum central tension can be approximated by a product of a maximum compressive stress and a depth of compression divided by the difference between the thickness of the substrate and twice the depth of compression, wherein the compressive stress and depth of compression are measured by FSM. Throughout the disclosure, an absolute value of compressive stress is reported as compressive stress, and an absolute value of central tensile stress is reported as central tensile stress.

In aspects, as shown in FIG. 2, the first major surface 203 of the foldable substrate 201 can comprise a first compressive stress region 212 extending to a first depth of compression 216 from the first major surface 203. Although not shown, the first compressive stress region 212 can also comprise a first depth of layer of one or more alkali metal ions (e.g., potassium) associated with the first compressive stress region. In aspects, as shown in FIG. 2, the second major surface 205 of the foldable substrate 201 can comprise a second compressive stress region 214 extending to a second depth of compression 218 from the second major surface 205. Although not shown, the second compressive stress region 214 can also comprise a second depth of layer of one or more alkali metal ions (e.g., potassium) associated with the first compressive stress region. As shown in FIG. 2, dashed lines 213 and 215 correspond to a location where a stress in the foldable substrate switched from compressive to tensile (or visa versa) corresponding to a boundary (i.e., depth of compression) of the corresponding compressive stress region. It is to be understood that the first compressive stress region 212 and/or the second compressive stress region 214 shown in FIG. 2 for the foldable substrate 201 of the foldable apparatus 101 can also be present in other foldable apparatus (e.g., foldable apparatus 301 and/or 401 shown in FIGS. 3-5 even though not explicitly labeled in FIGS. 3-5).

In aspects, the first depth of compression 216 and/or the second depth of compression 218 as a percentage of the substrate thickness 209 can be 5% or more, 10% or more, 12% or more, 14% or more, 16% or more, 18% or more, 20% or more, 30% or less, 26% or less, or 22% or less, 20% or less, 19% or less, 18% or less, 17% or less, or 16% or less. In aspects, the first depth of compression 216 and/or the second depth of compression 218 as a percentage of the substrate thickness 209 can range from 5% to 30%, from 10% to 26%, from 12% to 22%, from 14% to 20%, from 16% to 19%, from 16% to 19%, from 16% to 18%, or any range or subrange therebetween. In aspects, the first depth of compression 216 and/or the second depth of compression 218 as a percentage of the substrate thickness 209 can be 15% or more, for example, in a range from 16% to 30%, from 16% to 26%, from 18% to 24%, from 20% to 22%, or any range or subrange therebetween. In exemplary aspects, the first depth of compression 216 and/or the second depth of compression 218 as a percentage of the substrate thickness 209 can be in a range from 10% to 30%, from 12% to 19%, or from 16% to 26%. In aspects, the first depth of compression 216 and/or the second depth of compression 218 can be 5 μm or more, 6 μm or more, 7 μm or more, 8 μm or more, 10 μm or more, 12 μm or more, 15 μm or more, 20 μm or more, 50 μm or less, 30 μm or less, 25 μm or less, 20 μm or less, 17 μm or less, 15 μm or less, 13 μm or less, 10 μm or less, 9 μm or less, 8 μm or less, or 7 μm or less. In aspects, the first depth of compression 216 and/or the second depth of compression 218 can be in a range from 5 μm to 50 μm, from 6 μm to 30 μm, from 7 μm to 25 μm, from 8 μm to 20 μm, from 10 μm to 17 μm, from 12 μm to 15 μm, or any range or subrange therebetween. In preferred aspects, the first depth of compression 216 and/or the second depth of compression 218 can be in a range from 5 μm to 50 μm, from 7 μm to 30 μm, or from 10 μm to 15 μm. In aspects, the first depth of compression 216 and/or the second depth of compression 218 can be from greater than or equal to 5 μm to less than or equal to 30% of the substrate thickness, from greater than or equal to 7 μm to less than or equal to 25% of the substrate thickness, from greater than or equal to 10 μm to less than or equal to 20% of the substrate thickness, from greater than or equal to 12 μm to less than or equal to 18% of the substrate thickness, from greater than or equal to 15 μm to less than or equal to 15% of the substrate thickness, or any range or subrange therebetween.

In aspects, the first depth of layer and/or the second depth of layer of one or more alkali metal ions (e.g., potassium) as a percentage of the substrate thickness 209 can be 5% or more, 10% or more, 12% or more, 14% or more, 16% or more, 18% or more, 20% or more, 30% or less, 26% or less, or 22% or less, 20% or less, 19% or less, 18% or less, 17% or less, or 16% or less. In aspects, the first depth of layer and/or the second depth of layer of one or more alkali metal ions (e.g., potassium) as a percentage of the substrate thickness 209 can range from 5% to 30%, from 10% to 26%, from 12% to 22%, from 14% to 20%, from 16% to 19%, from 17% to 18%, or any range or subrange therebetween. In aspects, the first depth of layer and/or the second depth of layer of one or more alkali metal ions (e.g., potassium) as a percentage of the substrate thickness 209 can be 15% or more, for example, in a range from 16% to 30%, from 16% to 26%, from 18% to 24%, from 20% to 22%, or any range or subrange therebetween. In preferred aspects, the first depth of layer and/or the second depth of layer of one or more alkali metal ions (e.g., potassium) as a percentage of the substrate thickness 209 can be in a range from 10% to 30%, from 12% to 19%, or from 16% to 26%. In aspects, the first depth of layer and/or the second depth of layer of one or more alkali metal ions (e.g., potassium) can be 3 μm or more, 5 μm or more, 7 μm or more, 10 μm or more, 12 μm or more, 15 μm or more, 30 μm or less, 25 μm or less, 20 μm or less, 17 μm or less, 15 μm or less, 14 μm or less, 13 μm or less, 12 μm or less, 10 μm or less, or 8 μm or less. In aspects, the first depth of layer and/or the second depth of layer of one or more alkali metal ions (e.g., potassium) can be in a range from 3 μm to 30 μm, from 5 μm to 25 μm, from 70 μm to 20 μm, from 10 μm to 17 μm, from 12 μm to 15 μm, or any range or subrange therebetween. In preferred aspects, the first depth of layer and/or the second depth of layer of one or more alkali metal ions (e.g., potassium) can be in a range from 3 μm to 20 μm, from 5 μm to 17 μm, or from 10 μm to 15 μm.

In aspects, the first compressive stress region 212 can comprise a first maximum compressive stress and/or the second compressive stress region 214 can comprise a second maximum compressive stress. In further aspects, the first maximum compressive stress can be substantially equal to the second maximum compressive stress. In further aspects, the first maximum compressive stress and/or second maximum compressive stress can be 800 MegaPascals (MPa) or more, 850 MPa or more, 900 MPa or more, 950 MPa or more, 1,000 MPa or more, 1050 MPa or more, 1,500 MPa or less, 1,300 MPa or less, 1,250 MPa or less, 1,200 MPa or less, 1,150 MPa or less, 1,100 MPa or less, 1,050 MPa or less, 1,000 MPa or less, 950 MPa or less, 900 MPa or less, or 850 MPa or less. In further aspects, the first maximum compressive stress and/or second maximum compressive stress can be in a range from 800 MPa to 1,500 MPa, from 850 MPa to 1,300 MPa, from 900 MPa to 1,250 MPa, from 950 MPa to 1,200 MPa, from 1,000 MPa to 1,150 MPa, from 1,050 MPa to 1,100 MPa, or any range or subrange therebetween. In preferred aspects, the first maximum compressive stress and/or second maximum compressive stress can be in a range from 800 MPa to 1,500 MPa, from 850 MPa to 1,200 MPa, or from 900 MPa to 1,100 MPa. In further aspects, the maximum compressive stress of the foldable substrate 201 in accordance with the present disclosure can be greater than a comparative compressive stress of a comparative substrate manufactured identically to the foldable substrate other than the heat treating prior to being chemically strengthened (discussed below with reference to step 1003) by greater than or equal to 100 MPa, greater than or equal to 150 MPa (e.g., from 100 MPa to 500 MPa, from 150 MPa to 300 MPa, or any range or subrange therebetween), greater than or equal to 10% of the comparative compressive stress, greater than or equal to 15% of the comparative compressive stress, or greater than or equal to 20% of the comparative compressive stress (e.g., from 10% to 50%, from 15% to 33%, from 20% to 25% of the comparative compressive stress, or any range or subrange therebetween).

Throughout the disclosure, a tensile strength, ultimate elongation (e.g., strain at failure), and yield point of a polymeric material (e.g., adhesive, polymer-based portion) is determined using ASTM D638 using a tensile testing machine, for example, an Instron 3400 or Instron 6800, at 23° C. and 50% relative humidity with a type I dogbone shaped sample. Throughout the disclosure, an elastic modulus (e.g., Young's modulus) and/or a Poisson's ratio is measured using ISO 527-1:2019. Throughout the disclosure, the Young's modulus of glass materials are measured using the resonant ultrasonic spectroscopy technique set forth in ASTM E2001-13, titled “Standard Guide for Resonant Ultrasound Spectroscopy for Defect Detection in Both Metallic and Non-metallic Parts.” In aspects, the foldable substrate 201 can comprise an elastic modulus of 50 GPa or more, 60 GPa or more, 65 GPa or more, 70 GPa or more, 72 GPa or more, 75 GPa or more, 120 GPa or less, 100 GPa or less, 90 GPa or less, 80 GPa or less, 75 GPa or less, 72 GPa or less, or 70 GPa or less. In further aspects, the foldable substrate 201 can comprise a glass material comprising an elastic modulus ranging from 50 GPa to 120 GPa, from 60 GPa to 100 GPa, from 65 GPa to 90 GPa, from 70 GPa to 80 GPa, from 72 GPa to 75 GPa, or any range or subrange therebetween.

As shown in FIGS. 2-3, the foldable substrate 201 can comprise a first major surface 203 and a second major surface 205 opposite the first major surface 203. In aspects, the first major surface 203 can extend along a first plane, and/or the second major surface 205 can extend along a second plane. In further aspects, the second plane (second major surface 205) can be parallel to the first plane (first major surface 203). As used herein, a substrate thickness 209 of the foldable substrate 201 is defined between the first major surface 203 and the second major surface 205 as an average distance therebetween. In aspects, the foldable substrate 201 can be an ultra-thin substrate, meaning that the substrate thickness 209 is 100 micrometers or less. In aspects, the substrate thickness 209 can be 25 micrometers (μm) or more, 30 μm or more, 40 μm or more, 50 μm or more, 60 μm or more, 75 μm or more, 100 μm or more, 120 μm or more, 150 μm or more, 300 μm or less, 250 μm or less, 200 μm or less, 150 μm or less, 120 μm or less, 100 μm or less, 70 μm or less, 60 μm or less, 50 μm or less, or 40 μm or less. In aspects, the substrate thickness 209 can range from 25 μm to 300 μm, from 30 μm to 250 μm, from 40 μm to 200, from 50 μm to 150 μm, from 60 μm to 120 μm, from 75 μm to 100 μm, or any range or subrange therebetween. In aspects, the substrate thickness 209 can be less than or equal to 100 μm, for example in a range from 25 μm to 100 μm, from 30 μm to 70 μm, from 40 μm to 60 μm, or any range or subrange therebetween. In aspects, the substrate thickness 209 can be greater than or equal to 100 μm, which can exhibit greater impact resistance and/or puncture resistance than even thinner foldable substrates and reasonable foldability, for example in a range from 100 μm to 300 μm, from 120 μm to 250 μm, from 150 μm to 200 μm, or any range or subrange therebetween. In aspects, as shown, a local thickness of the foldable substrate 201 can be substantially uniform (e.g., substantially equal to the substrate thickness 209) across the first major surface 203 and/or the second major surface 205.

As used herein, if a first layer and/or component is described as “disposed over” a second layer and/or component, other layers may or may not be present between the first layer and/or component and the second layer and/or component. Furthermore, as used herein, “disposed over” does not refer to a relative position with reference to gravity. For example, a first layer and/or component can be considered “disposed over” a second layer and/or component, for example, when the first layer and/or component is positioned underneath, above, or to one side of a second layer and/or component. As used herein, a first layer and/or component described as “bonded to” a second layer and/or component means that the layers and/or components are bonded to each other, either by direct contact and/or bonding between the two layers and/or components or via an adhesive layer. As used herein, a first layer and/or component described as “contacting” or “in contact with” a second layer and/or components refers to direct contact and includes the situations where the layers and/or components are bonded to each other.

As shown in FIG. 3, the foldable apparatus 301 can comprise an adhesive layer 311. As shown, the adhesive layer 311 can comprise a first contact surface 313 and a second contact surface 315 that can be opposite the first contact surface 313. In aspects, as shown, the first contact surface 313 of the adhesive layer 311 can comprise a planar surface, and/or the second contact surface 315 of the adhesive layer 311 can comprise a planar surface. An adhesive thickness 319 of the adhesive layer 311 can be defined between the first contact surface 313 and the second contact surface 315 as the average distance therebetween. In aspects, the adhesive thickness 319 of the adhesive layer 311 can be 1 μm or more, 5 μm or more, 10 μm or more, 100 μm or less, 60 μm or less, 30 μm or less, or 20 μm or less. In aspects, the adhesive thickness 319 of the adhesive layer 311 can range from 1 μm to 100 μm, from 5 μm to 60 μm, from 10 μm to 30 μm, from 10 μm to 20 μm, or any range or subrange therebetween. In aspects, as shown in FIG. 3, the first contact surface 313 of the adhesive layer 311 can face and/or contact the first major surface 203 of the foldable substrate 201. In aspects, as shown in FIG. 3, the second contact surface 315 of the adhesive layer 311 can face and/or contact the another layer (e.g., PET sheet 321 discussed below).

In aspects, the adhesive layer 311 can comprise one or more of a polyolefin, a polyamide, a halide-containing polymer (e.g., polyvinylchloride or a fluorine-containing polymer), an elastomer, a urethane, phenolic resin, parylene, polyethylene terephthalate (PET), and polyether ether ketone (PEEK). Example aspects of polyolefins include low molecular weight polyethylene (LDPE), high molecular weight polyethylene (HDPE), ultrahigh molecular weight polyethylene (UHMWPE), and polypropylene (PP). Example aspects of fluorine-containing polymers include polytetrafluoroethylene (PTFE), polyvinylfluoride (PVF), polyvinylidene fluoride (PVDF), perfluoropolyether (PFPE), perfluorosulfonic acid (PFSA), a perfluoroalkoxy (PFA), fluorinated ethylene propylene (FEP) polymers, and ethylene tetrafluoro ethylene (ETFE) polymers. Example aspects of elastomers include rubbers (e.g., polybutadiene, polyisoprene, chloroprene rubber, butyl rubber, nitrile rubber), and block copolymers (e.g., styrene-butadiene, high-impact polystyrene, poly(dichlorophosphazene). In further aspects, the adhesive layer 311 can comprise an optically clear adhesive. In even further aspects, the optically clear adhesive can comprise one or more optically transparent polymers: an acrylic (e.g., polymethylmethacrylate (PMMA)), an epoxy, silicone, and/or a polyurethane. Examples of epoxies include bisphenol-based epoxy resins, novolac-based epoxies, cycloaliphatic-based epoxies, and glycidylamine-based epoxies. In even further aspects, the optically clear adhesive can comprise, but is not limited to acrylic adhesives, for example, 3M 8212 adhesive, or an optically transparent liquid adhesive, for example, a LOCTITE optically transparent liquid adhesive. Exemplary aspects of optically clear adhesives comprise transparent acrylics, epoxies, silicones, and polyurethanes. For example, the optically transparent liquid adhesive could comprise one or more of LOCTITE AD 8650, LOCTITE AA 3922, LOCTITE EA E-05MR, LOCTITE UK U-09LV, which are all available from Henkel.

In aspects, although not shown, a coating can be disposed over the second major surface 205 of the foldable substrate 201. In even further aspects, a coating thickness of the coating can be 0.1 μm or more, 1 μm or more, 5 μm or more, 10 μm or more, 15 μm or more, 20 μm or more, 25 μm or more, 40 μm or more, 50 μm or more, 60 μm or more, 70 μm or more, 80 μm or more, 90 μm or more, 200 μm or less, 100 μm or less, or 50 μm or less, 30 μm or less, 25 μm or less, 20 μm or less, 20 μm or less, 15 μm or less, or 10 μm or less. In further aspects, the coating thickness of the coating can range from 0.1 μm to 200 μm, from 1 μm to 100 μm, from 5 μm to 100 μm, from 10 μm to 60 μm, from 15 μm to 40 μm, from 20 μm to 30 μm, or any range or subrange therebetween. In aspects, the coating can be a hard coating providing increased hardness, abrasion resistance, impact resistance, and/or puncture resistance to the foldable apparatus relative to the foldable substrate alone. In aspects, the coating, if provided, may also comprise one or more of an easy-to-clean coating, a low-friction coating, an oleophobic coating, a diamond-like coating, a scratch-resistant coating, or an abrasion-resistant coating. A scratch-resistant coating may comprise an oxynitride, for example, aluminum oxynitride or silicon oxynitride with a thickness of 500 micrometers or more. In such aspects, the abrasion-resistant layer may comprise the same material as the scratch-resistant layer. In aspects, a low friction coating may comprise a highly fluorinated silane coupling agent, for example, an alkyl fluorosilane with oxymethyl groups pendant on the silicon atom. In such aspects, an easy-to-clean coating may comprise the same material as the low friction coating. In other aspects, the easy-to-clean coating may comprise a protonatable group, for example an amine, for example, an alkyl aminosilane with oxymethyl groups pendant on the silicon atom. In such aspects, the oleophobic coating may comprise the same material as the easy-to-clean coating. In aspects, a diamond-like coating comprises carbon and may be created by applying a high voltage potential in the presence of a hydrocarbon plasma.

In aspects, as shown in FIG. 3, a layer (e.g., PET sheet 321) can be disposed over the first major surface 203 of the foldable substrate 201, and/or the layer (e.g., PET sheet 321) can be attached to the foldable substrate 201 by the adhesive layer 311. In further aspects, the layer (e.g., PET sheet 321) can be disposed over and/or contact the second contact surface 315 of the adhesive layer 311. In further aspects, as shown, a first surface area 323 of the PET sheet 321 can face the first major surface 203 of the foldable substrate 201, face the second contact surface 315 of the adhesive layer 311, and/or contact the second contact surface 315 of the adhesive layer 311. A thickness 329 of the PET sheet 321 is defined as an average distance between the first surface area 323 and a second surface area 325 opposite the first surface area 323. As discussed below with reference to the Pen Drop Test, the adhesive thickness 319 of the adhesive layer 311 (e.g., Optically Clear Adhesive 8212 available from 3M) can be 50 μm and a thickness 329 of the PET sheet 321 can be 100 μm, although other materials and/or thicknesses are possible in other aspects of the foldable apparatus. For example, in other aspects, the layer (e.g., PET sheet) can comprise a polymeric material (not limited to PET) such as polyesters (e.g., polyethylene terephthalate (PET)) and polyolefins (e.g., low-density polyethylene (LDPE), high-density polyethylene (HDPE), polypropylene (PP)). Also, in other aspects, the layer (e.g., PET sheet 321) can be replaced with a release liner, which can comprise a paper and/or a polymer. Exemplary aspects of paper comprise kraft paper, machine-finished paper, poly-coated paper (e.g., polymer coated, glassine paper, siliconized paper), or clay-coated paper. Additionally or alternatively, the layer can include and/or comprise a display device, for example, a liquid crystal display (LCD), an electrophoretic display (EPD), an organic light-emitting diode (OLED) display, or a plasma display panel (PDP). The display device can be part of a portable electronic device, for example, a consumer electronic product, a smartphone, a tablet, a wearable device, or a laptop.

In the Quasi-Static Puncture test, a tungsten carbide ball with a predetermined diameter is placed on the outer surface (e.g., first major surface 203) and pressed into the outer surface at a rate of 0.5 mm/min until failure. The foldable apparatus is configured such that the first major surface 203 of the foldable substrate 201 faces an aluminum plate (6063 aluminum alloy, as polished to a surface roughness with 400 grit paper) with the polymer sheet. No tape is used on the side of the sample resting on the aluminum plate. Unless otherwise indicated, the predetermined diameter of the tungsten carbide ball is 0.5 mm. The foldable substrate is prepared as discussed above for the Parallel Plate test with a test adhesive layer having a thickness of 250 μm of LDPE mounted opposite the surface being contacted. Further, the test is conducted with a 100 μm thick sheet 807 of polyethylene terephthalate (PET) rather than with the release liner 321 of FIGS. 2-3.

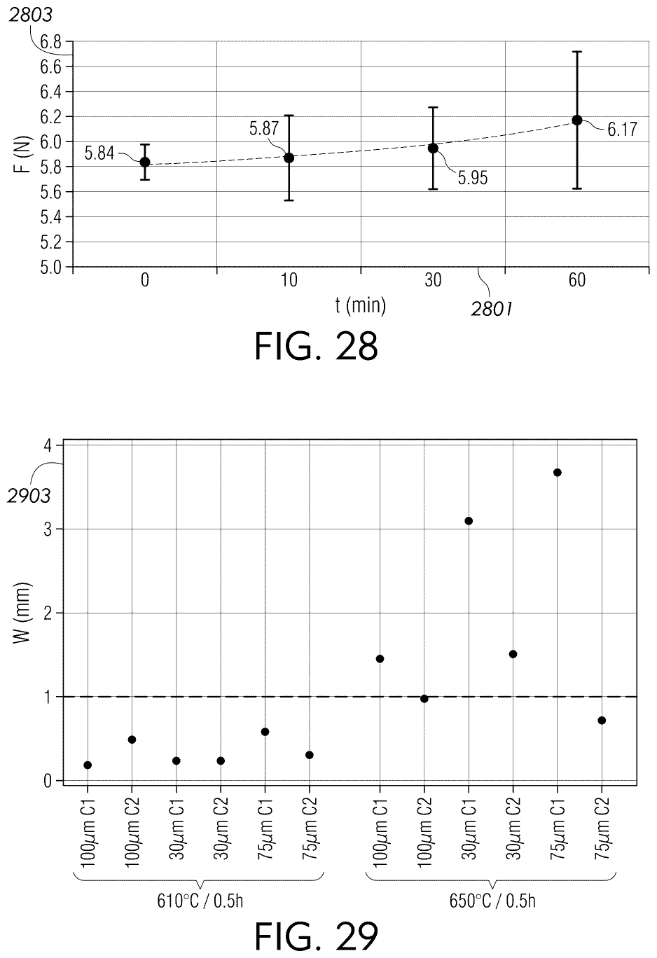

In aspects, the foldable apparatus can exhibit a puncture resistance as measured in a Quasi-Static Puncture Test of 5.5 kgf or more, 5.8 kgf or more, 5.9 kgf or more, 6.0 kgf or more, 6.1 kgf or more, or 6.2 kgf or more. In aspects, the foldable apparatus can exhibit a puncture resistance as measured in a Quasi-Static Puncture Test of from 5.5 kgf to 7.0 kgf, from 5.8 kgf to 6.5 kgf, from 5.9 kgf to 6.4 kgf, from 6.0 kgf to 6.3 kgf, from 6.1 kgf to 6.2 kgf, or any range or subrange therebetween. For example, FIG. 28 shows that the method of the present disclosure produce higher puncture resistance as evidenced by the Quasi-Static Puncture test than Example AA (t=0).

Aspects of the disclosure can comprise a consumer electronic product. The consumer electronic product can comprise a front surface, a back surface, and side surfaces. The consumer electronic product can further comprise electrical components at least partially within the housing. The electrical components can comprise a controller, a memory, and a display. The display can be at or adjacent to the front surface of the housing. The display can comprise a liquid crystal display (LCD), an electrophoretic display (EPD), an organic light-emitting diode (OLED) display, or a plasma display panel (PDP). The consumer electronic product can comprise a cover substrate disposed over the display. In aspects, at least one of a portion of the housing or the cover substrate comprises the foldable apparatus discussed throughout the disclosure. The consumer electronic product can comprise a portable electronic device, for example, a smartphone, a tablet, a wearable device, or a laptop.

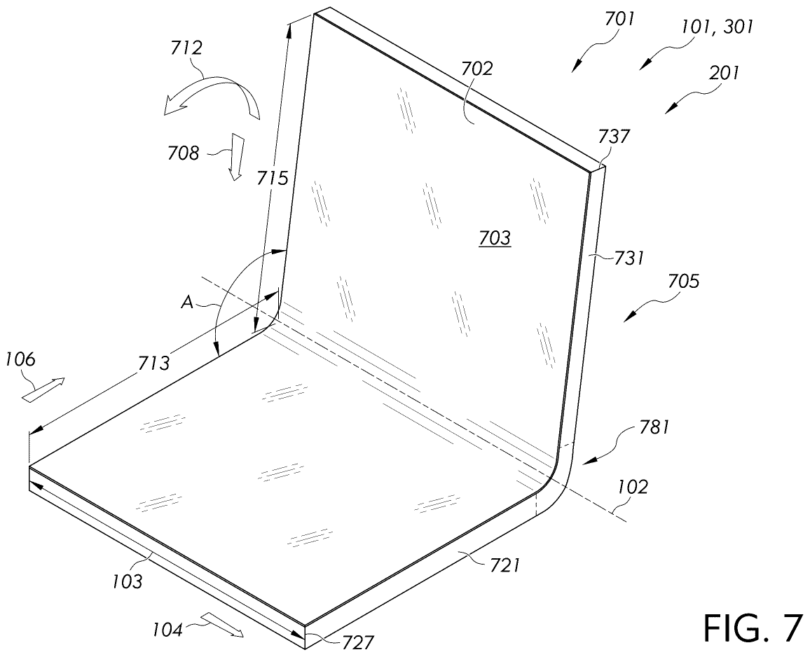

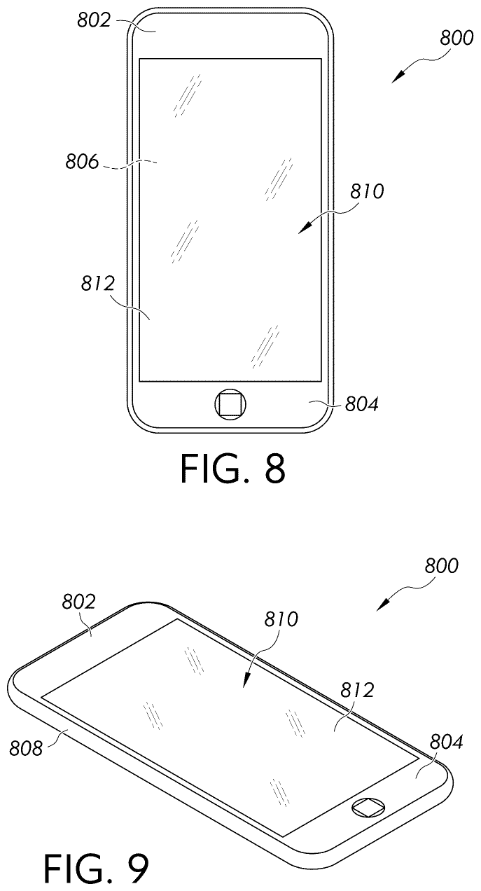

The foldable apparatus disclosed herein may be incorporated into another article, for example, an article with a display (or display articles) (e.g., consumer electronics, including mobile phones, tablets, computers, navigation systems, wearable devices (e.g., watches), and the like), architectural articles, transportation articles (e.g., automotive, trains, aircraft, sea craft, etc.), appliance articles, or any article that may benefit from some transparency, scratch-resistance, abrasion resistance or a combination thereof. An exemplary article incorporating any of the foldable apparatus 101 and/or 301 and/or foldable substrate 201 disclosed herein is shown in FIGS. 8-9. Specifically, FIGS. 8-9 show a consumer electronic device 800 including a housing 802 having front 804, back 806, and side surfaces 808. Although not shown, the consumer electronic device can comprise electrical components that are at least partially inside or entirely within the housing. For example, electrical components include at least a controller, a memory, and a display. As shown in FIGS. 8-9, the display 810 can be at or adjacent to the front surface of the housing 802. The consumer electronic device can comprise a cover substrate 812 at or over the front surface of the housing 802 such that it is over the display 810. In aspects, at least one of the cover substrate 812 or a portion of housing 802 may include any of the foldable apparatus disclosed herein, for example, the foldable substrate 201.

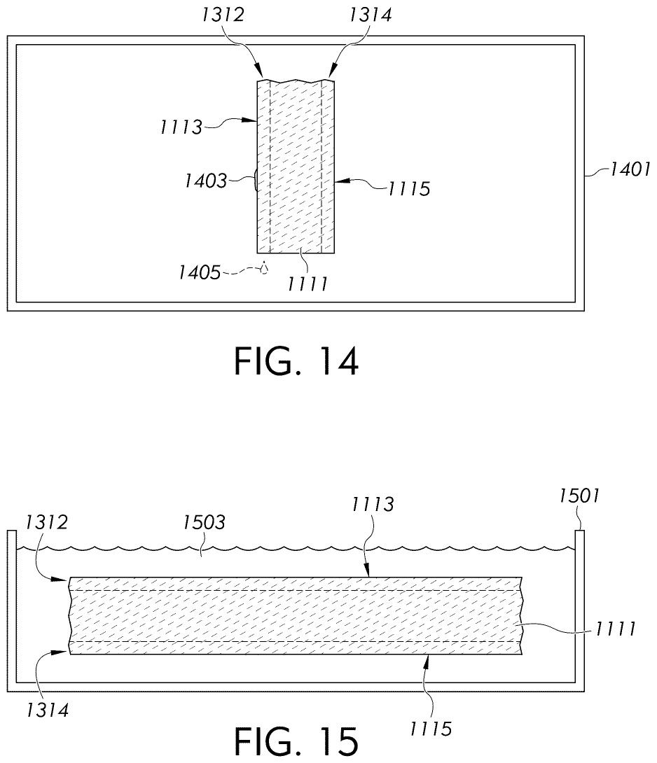

Also, FIG. 7 schematically shows a perspective view of a consumer electronic product 701 that is foldable. The consumer electronic product 701 can include the foldable apparatus 101 and/or 301 and/or the foldable substrate 201 in accordance with aspects of the present disclosure. As shown, the consumer electronic product 701 can include a front surface 703 and a side surface 705. The consumer electronic product 701 can include electronic components, including a display 702 that can be viewed through the front surface 703. In aspects, as shown, the consumer electronic product 701 can be folded in a direction 712 to form a folded configuration that brings a first end 727 and a second end 737 (opposite the first end 727) closer together (than in the unfolded configuration). Additionally, as shown, the consumer electronic product 701 can be folded so that the front surface 703 and/or display 702 faces itself, although the consumer electronic product could be folded opposite the direction 712 so that the front surface 703 is on the outside of the consumer electronic product in the folded configuration. The consumer electronic product 701 shown in FIG. 15 can be folded about the fold axis 102, where a central portion 781 is located between a first portion 721 including the first end 727 and a second portion 731 including the second end 737. A location of the fold axis 102 can determine a first distance 713 between the first end 727 and the fold axis 102 (e.g., in direction 106) relative to a second distance 715 between the second end 737 and the fold axis 102 (e.g., in direction 708). A total length of the consumer electronic product (e.g., length 105 in FIG. 1) can be the sum of the first distance 713 and the second distance 715). Also, as shown, the consumer electronic product is depicted as being in a folded or partially folded configuration with an angle A formed by front surface 703 about the fold axis 102.

FIG. 5 schematically illustrates aspects of the foldable apparatus 401 comprising and/or consisting of the foldable substrate 201 in accordance with aspects of the disclosure in a folded configuration. As shown in FIG. 4, the foldable apparatus 401 is folded such that the second major surface 205 of the foldable substrate 201 is on the outside of the foldable apparatus 401 and the first major surface 203 is on the inside of the foldable apparatus 401. In the folded configuration although not shown, if a display device was positioned on the inside of the bend, a user would view the display device through the foldable substrate 201 and, thus, would be positioned on the side of the second major surface 205. Alternatively, if the display device was positioned on the outside of the bend, a user would view the display device through the foldable substrate 201 and, thus, would be positioned on the side of the first major surface 203. Alternatively, although not shown, the foldable apparatus can be folded such that the first major surface of the foldable substrate is on the outside of the folded foldable apparatus, where a user would view the display device through the foldable substrate and, thus, would be positioned opposite the display device.

As used herein, “foldable” includes complete folding, partial folding, bending, flexing, or multiple capabilities. As used herein, the terms “fail,” “failure,” and the like refer to breakage, destruction, delamination, or crack propagation. A foldable apparatus achieves a parallel plat distance of “X,” or withstands a parallel plat distance of “X”, has a parallel plat distance of “X,” or comprises a parallel plate distance of “X” if it resists failure when the foldable apparatus is held at parallel plate distance of “X” for 10 minutes at 25° C. and 50% relative humidity. Likewise, a foldable apparatus achieves a parallel plate distance of “X,” or has a parallel plate distance of “X,” or comprises a parallel plate distance of “X” if it resists failure when the foldable apparatus is held at a parallel plate distance of “X” for 10 minutes at 50° C. and 50% relative humidity. In aspects, the foldable substrate and/or the foldable apparatus can be rollable. As used herein, a foldable substrate or a foldable apparatus is “rollable” if it can achieve a threshold parallel plate distance over a length of the corresponding foldable substrate and/or foldable apparatus that is the greater of 10 mm or 10% of the length of the corresponding foldable substrate and/or foldable apparatus. Throughout the disclosure, the “survival rate” or % of samples that can withstand a parallel plate distance of X mm refers to the percentage of at least 20 samples that withstand bending to the parallel distance of X mm.

As used herein, the “parallel plate distance” of a foldable apparatus and/or foldable substrate is measured with the following test configuration and process using a parallel plate apparatus 501 (see FIG. 5) that comprises a pair of parallel rigid stainless-steel plates 503 and 505 comprising a first rigid stainless-steel plate 503 and a second rigid stainless-steel plate 505. When measuring the “parallel plate distance”, the foldable apparatus or foldable substrate is placed between the pair of parallel rigid stainless-steel plates 503 and 505 as is (without modification). For example, as shown in FIG. 4, the foldable apparatus 101 shown in FIG. 2 consisting of the foldable substrate 201 is placed between the pair of parallel rigid stainless-steel plates 503 and 505 without modification with the second major surface 205 of the foldable substrate 201 contacting the pair of parallel rigid stainless-steel plates 503 and 505 as the foldable apparatus 401. For determining a “parallel plate distance”, the distance between the parallel plates is reduced at a rate of 1 millimeter per second (mm/sec) until the parallel plate distance 511 is equal to the “parallel plate distance” to be tested. Then, the parallel plates are held at the “parallel plate distance” to be tested for 10 minutes at 85° C. and 85% relative humidity. As used herein, the “minimum parallel plate distance” is the smallest parallel plate distance that the foldable apparatus can withstand without failure under the conditions and configuration described above.

In aspects, the foldable apparatus 101, 301, and/or 401 and/or the foldable substrate 201 can achieve a parallel plate distance (in mm) that is less than or equal to 0.1 (mm/μm) times the substrate thickness (in μm), less than or equal to 0.08 (mm/μm) times the substrate thickness (in μm), less than or equal to 0.067 (mm/μm) times, less than or equal to 0.05 (mm/μm) times the substrate thickness, less than or equal to 0.033 (mm/μm) times the substrate thickness, and/or less than or equal to 0.01 (mm/μm) times the substrate thickness. For example, a foldable substrate having a substrate thickness of 300 μm satisfies a parallel plate distance (in mm) that is less than or equal to 0.1 (mm/μm) times the substrate thickness if the foldable substrate achieves a parallel plate distance of 30 mm (i.e., 300 μm substate thickness×0.1 mm/μm=30 mm parallel plate distance). In aspects, the foldable apparatus can achieve a parallel plate distance (in mm) that is equal to the substrate thickness (in μm) times the following factor: from greater than or equal to 0.001 mm/μm to less than or equal to 0.1 mm/μm, from greater than or equal to 0.003 mm/μm to less than or equal to 0.08 mm/μm, from greater than or equal to 0.005 mm/μm to less than or equal to 0.05 mm/μm, from greater than or equal to 0.01 mm/μm to less than or equal to 0.03 mm/μm, or any range or subrange therebetween. In aspects, the foldable apparatus 101, 301, and/or 401 and/or the foldable substrate 201 can achieve a parallel plate distance of 30 mm or less, 20 mm or less, 10 mm or less, 7 mm or less, 5 mm or less, 3 mm or less, 2 mm or less, or 1 mm or less. In aspects, the foldable apparatus 101, 301, and/or 401 and/or the foldable substrate 201 can comprise a minimum parallel plate distance of 20 mm or less, 10 mm or less, 5 mm or less, 4 mm or less, 3 mm or less, 2 mm or less, or 1 mm or less. In aspects, the foldable apparatus 101, 301, and/or 401 and/or the foldable substrate 201 can comprise a minimum parallel plate distance ranging from 0.5 mm to 20 mm, from 0.5 mm to 10 mm, from 0.5 mm to 5 mm, from 0.5 mm to 4 mm, from 1 mm to 3 mm, from 1 mm to 2 mm, or any range or subrange therebetween.

In aspects, the foldable apparatus 101, 301, and/or 401 and/or the foldable substrate 201 can exhibit a survival rate of 90% or more, 92% or more, 95% or more, 97% or more, 98% or more, 99% or more, or 100% at a parallel plate distance of 0.1 (mm/μm) times the substrate thickness (in μm). In aspects, the foldable apparatus 101, 301, and/or 401 and/or the foldable substrate 201 can exhibit a survival rate of 50% or more, 60% or more, 66% or more, 70% or more, 75% or more, 80% or more, 85% or more, or 90% or more (e.g., from 50% to 100%, from 60% to 99%, from 66% to 98%, from 70% to 97%, from 75% to 95%, from 80% to 92%, from 85% to 90%, or any range or subrange therebetween) at a parallel plate distance of 0.08 (mm/μm) times the substrate thickness (in μm). In aspects, the foldable apparatus 101, 301, and/or 401 and/or the foldable substrate 201 can exhibit a survival rate of 20% or more, 25% or more, 30% or more, 33% or more, 40% or more, 50% or more, or 66% or more (e.g., from 20% to 100%, from 25% to 90%, from 30% to 75%, from 33% to 66%, from 40% to 50%, or any range or subrange therebetween) at a parallel plate distance of 0.067 (mm/μm) times the substrate thickness (in μm). In aspects, the foldable apparatus 101, 301, and/or 401 and/or the foldable substrate 201 can exhibit a survival rate of 90% or more, 92% or more, 95% or more, 97% or more, 98% or more, 99% or more, or 100% at a parallel plate distance of 10 mm, 7 mm, 5 mm, 4 mm, or even 3 mm. In aspects, the foldable apparatus 101, 301, and/or 401 and/or the foldable substrate 201 can exhibit a survival rate of 50% or more, 60% or more, 66% or more, 70% or more, 75% or more, 80% or more, 85% or more, or 90% or more (e.g., from 50% to 100%, from 60% to 99%, from 66% to 98%, from 70% to 97%, from 75% to 95%, from 80% to 92%, from 85% to 90%, or any range or subrange therebetween), at a parallel plate distance of 2.6 mm or even 2.4 mm. In aspects, the foldable apparatus 101, 301, and/or 401 and/or the foldable substrate 201 can exhibit a survival rate of 20% or more, 25% or more, 30% or more, 33% or more, 40% or more, 50% or more, or 66% or more (e.g., from 20% to 100%, from 25% to 90%, from 30% to 75%, from 33% to 66%, from 40% to 50%, or any range or subrange therebetween) at a parallel plate distance of 2.2 mm or even 2.0 mm. In aspects, the foldable apparatus 101, 301, and/or 401 and/or the foldable substrate 201 can exhibit a survival rate greater than or equal to 50% at a parallel plate distance equal to 0.08 (mm/μm) times the substrate thickness (in μm) and a survival rate greater than or equal to 20% at a parallel plate distance equal to 0.067 (mm/μm) times the substrate thickness (in μm). In further aspects, the survival rate of the foldable substrate 201 can be greater than a comparative survival rate of a comparative substrate manufactured identically to the foldable substrate other than the heat treating prior to being chemically strengthened (discussed below with reference to step 1003), for example: the survival rate minus the comparative survival rate can be greater than or equal to 10%, greater than or equal to 15%, greater than or equal to 20%, greater than or equal to 25%, or greater than or equal to 33%, where both the survival rate and the comparative survival rate are for a parallel plate distance (in mm) of 0.1 (mm/μm) times the foldable substrate (in μm) and/or 3 mm.

The foldable apparatus and/or the foldable substrate may have an impact resistance defined by the capability of a region of the foldable apparatus and/or foldable substrate to avoid failure at a pen drop height (e.g., 5 centimeters (cm) or more, 10 centimeters or more, 20 cm or more), when measured according to the “Pen Drop Test.” As used herein, the “Pen Drop Test” is conducted such that samples of foldable apparatus and/or foldable substrate are tested with the load (i.e., from a pen dropped from a certain height) imparted to a major surface (e.g., second major surface 205 of the foldable substrate 201 and/or foldable apparatus 101 and/or 301) with the foldable substrate 201 configured as shown in FIG. 3 when PET sheet 321 with a thickness 329 100 μm attached to the adhesive layer 311 LPDE with a thickness of 250 μm. As such, the PET sheet in the Pen Drop Test is meant to simulate a foldable electronic display device (e.g., an OLED device). During testing, the foldable substrate 201 bonded to the PET sheet is placed on an aluminum plate (6063 aluminum alloy, as polished to a surface roughness with 400 grit paper) with the PET sheet 321 in contact with the aluminum plate. No tape is used on the side of the sample resting on the aluminum plate.

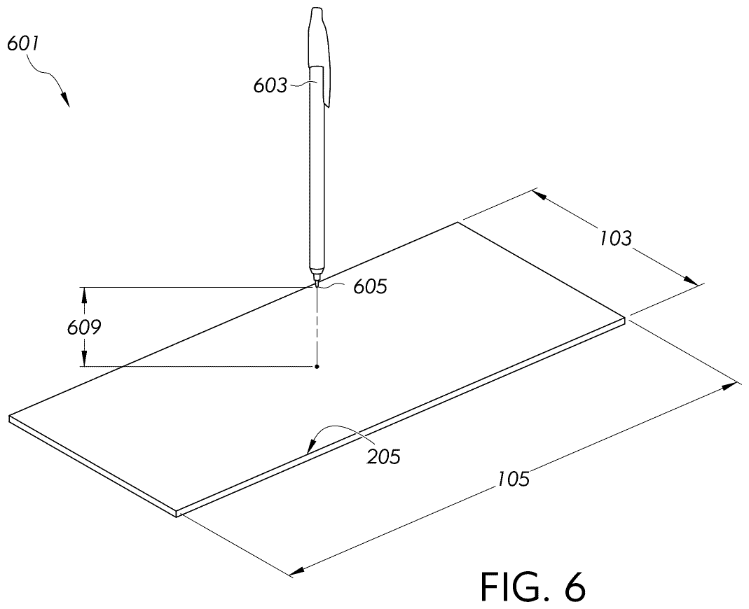

A tube is used for the Pen Drop Test to guide a pen to an outer surface of the foldable apparatus. For the foldable apparatus 101, 301, and/or 401 and/or the foldable substrate 201 shown in FIGS. 2-3 and 5 (modified as described in the previous paragraph), the pen is guided to the second major surface 205 of the foldable substrate 201, and the tube is placed in contact with the second major surface 205 of the foldable substrate 201 so that the longitudinal axis of the tube is substantially perpendicular to the second major surface 205 with the longitudinal axis of the tube extending in the direction of gravity. Referring to FIG. 6, a pen drop apparatus 601 includes a ballpoint pen 603, which is a BIC Easy Glide Pen, Fine comprising a tungsten carbide ballpoint tip 605 of 0.7 mm (0.68 mm) diameter, and a weight of 5.73 grams (g) including the cap. The ballpoint pen 603 is held at a predetermined height 609 from an outer surface (e.g., second major surface 205 of the foldable substrate 201) of the sample (see foldable apparatus 301 shown in FIG. 3). A tube (not shown for clarity) is used as part of the pen drop apparatus 601 to guide the ballpoint pen 603 to the outer surface (e.g., second major surface 205 of the foldable substrate 201) of the sample, and the tube is placed in contact with the outer surface so that the longitudinal axis of the tube is substantially perpendicular to the outer major surface with the longitudinal axis of the tube extending in the direction of gravity. The tube has an outside diameter of 1 inch (2.54 cm), an inside diameter of nine-sixteenths of an inch (1.4 cm), and a length of 90 cm. An acrylonitrile butadiene (“ABS”) shim (not shown) is employed to hold the ballpoint pen 603 at a predetermined height 609 for each test. After each drop, the tube is relocated relative to the sample to guide the pen to a different impact location on the sample.

For the Pen Drop Test, the pen is dropped with the cap attached to the top end (i.e., the end opposite the tip) so that the ballpoint can interact with the test sample. In a drop sequence according to the Pen Drop Test, one pen drop is conducted at an initial height of 1 cm, followed by successive drops in 0.5 cm increments up to 20 cm, and then after 20 cm, 2 cm increments until failure of the test sample. After each drop is conducted, the presence of any observable fracture, failure, or other evidence of damage to the sample is recorded along with the particular pen drop height. Using the Pen Drop Test, multiple samples can be tested according to the same drop sequence to generate a population with improved statistical accuracy. For the Pen Drop Test, the pen is to be changed to a new pen after every 5 drops, and for each new sample tested. In addition, all pen drops are conducted at random locations on the sample at or near the center of the sample, with no pen drops near or on the edge of the samples.

For purposes of the Pen Drop Test, “failure” means the formation of a visible mechanical defect in a laminate. The mechanical defect may be a crack or plastic deformation (e.g., surface indentation). The crack may be a surface crack or a through crack. The crack may be formed on an interior or exterior surface of a laminate. The crack may extend through all or a portion of the foldable substrate 201. A visible mechanical defect has a minimum dimension of 0.2 mm or more.

In aspects, the foldable substrate 201 and/or the foldable apparatus 101 and/or 301 can resist failure for a pen drop at a pen drop height of 10 centimeters (cm), 12 cm, 14 cm, 16 cm, or 20 cm. In aspects, a maximum pen drop height that the foldable substrate 201 and/or the foldable apparatus 101 and/or 301 can withstand without failure may be 10 cm or more, 12 cm or more, 14 cm or more, 15 cm or more, 16 cm or more, 18 cm or more, 20 cm or more 40 cm or less, or 30 cm or less, 25 cm or less, 20 cm or less, or 15 cm or less. In aspects, a maximum pen drop height that the foldable substrate 201 and/or the foldable apparatus 101 and/or 301 can withstand without failure can be in a range from 10 cm to 40 cm, from 12 cm to 40 cm, from 14 cm to 30 cm, from 16 cm to 30 cm, from 18 cm to 30 cm, from 20 cm to 25 cm, or any range or subrange therebetween. In aspects, when the substrate thickness 209 of the foldable substrate 201 is 50 μm or more (e.g., from 50 μm to 100 μm, from 50 μm to 90 μm, or any of the corresponding subranges discussed above), the foldable substrate 201 can withstand a pen drop from a pen drop height of 15 cm or more or even 20 cm or more. In aspects, when the substrate thickness 209 of the foldable substrate 201 is 50 μm or less (e.g., from 10 μm to 50 μm, from 10 μm to 30 μm, or any of the corresponding subranges discussed above), the foldable substrate 201 can withstand a pen drop from a pen drop height of 10 cm or more.

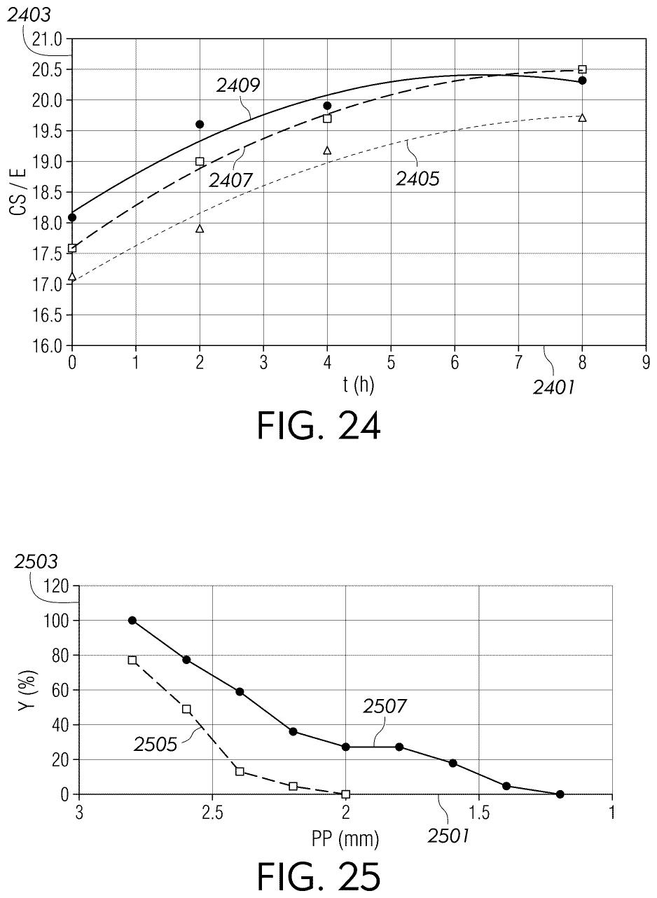

Without wishing to be bound by theory, fracture toughness (e.g., caused by a “flaw” near the surface of the glass article) is proportional to a glass strength of the glass article. The glass strength (e.g., σ_{NET}) can be approximated as a difference between a bend-induced stress (e.g., σ_{BEND} at the surface of the glass article) and a compressive stress (e.g., σ_{IOX} from chemically strengthening the glass article, the first and/or second maximum compressive stress) (i.e., σ_{NET}≈σ_{BEND}−σ_{IOX}). During bending, the stress on the glass article is proportional to a product of the elastic modulus (E). These expressions can be combined to state the glass strength as σ_{BEND}≈E [Z−CS/E], where Z is a constant for a predetermined bend (e.g., folding to a predetermined parallel plate distance for a glass article having a predetermined thickness. Consequently, a greater CS/E ratio is associated with improved foldability and/or reliability in folding to a predetermined parallel plate distance. It has generally been difficult to reach (let alone exceed) a CS/E (MPa/GPa) ratio of 16.0. Unexpectedly, the heat treatment discussed herein (see step 1003) provides increased CS, which allows glasses to exceed a CS/E (MPa/GPa) ratio of 16.0, as discussed herein with reference to FIG. 24. In aspects, the glasses can be chemically strengthened to have a CS/E (MPa/GPa) ratio greater than or equal to 17.0, greater than or equal to 17.5, greater than or equal to 18.0, greater than or equal to 18.5, greater than or equal to 19.0, greater than or equal to 19.5, or greater than or equal to 20.0 (e.g., from greater than or equal to 17.0 to less than or equal to 25.0, from greater than or equal to 17.5 to less than or equal to 23.0, from greater than or equal to 18.0 to less than or equal to 22.5, from greater than or equal to 18.5 to less than or equal to 22.0, from greater than or equal to 19.0 to less than or equal to 21.5, from greater than or equal to 19.5 to less than or equal to 21.0, from greater than or equal to 20.0 to less than or equal to 20.5, or any range or subrange therebetween.

Throughout the disclosure, the ring-on-ring (ROR) test is a surface strength measurement for testing flat glass specimens, and ASTM C1499-09 (2013), entitled “Standard Test Method for Monotonic Equibiaxial Flexural Strength of Advanced Ceramics at Ambient Temperature,” serves as the basis for the AROR test methodology described herein. The contents of ASTM C1499-09 are incorporated herein by reference in their entirety. The sample is placed between two concentric rings of differing size to determine equibiaxial flexural strength (i.e., the maximum stress that a material is capable of sustaining when subjected to flexure between two concentric rings) with the sample supported by a support ring with diameter D2. A force F is applied by a load cell to the surface of the glass-based article by a loading ring having a diameter D1. Unless otherwise indicated, a ratio of D1/D2 is 0.5. The loading and the support ring were aligned concentrically to within 0.5% of support ring diameter D2. The load cell used for testing is accurate to within ±1% at any load within a selected range. Testing is carried out at a temperature of 23±2° C. and a relative humidity of 40±10%. For fixture design, the radius r of the protruding surface of the loading ring is in a range of h/2≤r≤3 h/2, where h is the thickness of sample. Loading and support rings are made of hardened steel with hardness HRc>40. The intended failure mechanism for the ROR test is to observe fracture of the sample originating from a region of the surface of the sample within both loading rings. Failures that occur outside of this region—i.e., between the loading ring and support ring—are omitted from data analysis. Due to the thinness and high strength of the sample, however, large deflections that exceed ½ of the sample thickness h are sometimes observed. It is therefore not uncommon to observe a high percentage of failures originating from underneath the loading ring. Stress cannot be accurately calculated without knowledge of stress development both inside and under the ring (collected via strain gauge analysis) and the origin of failure in each specimen. ROR testing therefore focuses on peak load at failure as the measured response. As used herein, “ring-on-ring strength” refers to the strength measured using the ROR test.

The foldable apparatus 101, 301, and/or 401 and/or the foldable substrate 201 can comprise a surface profile that provides a smooth and/or non-warped surface that can provide a consistent optical appearance (and aesthetically pleasing viewing of a display device therein and/or therethrough). As used herein, the deflectometer profile is measured using a SpecGAGE3D available from Irsa Vision using the default settings. The raw deflectometry measurements correspond to an array of gradients over the measured area. The measured gradients are integrated by the software provided with the SpecGAGE3D to produce a 3D surface. A zero-point of the 3D surface is set so that the average height of the entire 3D surface is 0. Throughout the disclosure, “skew” (or “skewness”) and kurtosis are given their usual meaning in statistics describing higher-order moments of the corresponding distribution (e.g., surface profile, local curvature profile). As used herein, “warp” is taken as the largest difference in height (vertical axis) of the surface profile along the midline excluding the measurements within 1 mm of the edge of the foldable substrate in the surface profile, where the most extreme 1% on either side of the distribution is removed to avoid using spurious readings. As such, for a distribution of heights along the midline (excluding measurements within 1 mm of the edge), the warp is the height value at the 99% percentile minus the height value at the 1% percentile (since 1% of the most extreme values are removed changing 100%-0% to 99%-1%). As used herein, “local curvature” is taken as the curvature calculated between 3 points adjacent one another in a direction along the measured 3D surface excluding points within 1 mm of the edge of the foldable substrate in the measured 3D surface. Specifically, curvature (K) at point “i” in the Y-direction is calculated as: K (i)=−[(Yᵢ₊₁−2*Yᵢ+Yᵢ₋₁)/(Δy)²]/(1+(m(i))²)^{1.5}, where Yᵢ is the position in the y-direction at point “i”, Δy is the spacing between adjacent points (i to i+1 and i to i−1—such that the 3 points are at i+1, i, and i−1), and m(i) is the slope (m) at point “i” defined as: m (i)=(Yᵢ₊₁−Yᵢ₋₁)/(2*Δy). The “maximum local curvature” at a location is the greater absolute value of the two curvatures (e.g., in the x-direction and in the y-direction) at the location, and the “maximum curvature” refers to the largest value of the maximum local curvature. Unless otherwise indicated, curvature is reported in Diopters (D).

In aspects, the foldable apparatus 101, 301, and/or 401 and/or the foldable substrate 201 can exhibit a parabolic (and/or planar) surface profile taken along a midline of an outer surface (e.g., first major surface) thereof. Without wishing to be bound by theory, buckling is a type of mechanically instability when a critical buckling strain is exceeded and can manifest as a non-parabolic (and non-planar) surface profile. Lesser strain can result in the surface profile exhibiting saddle warp. The strain can be generated due to local differences in compressive stress (e.g., stress profile) across the corresponding article (e.g., across the first major surface of the foldable substrate). Additionally or alternatively, a cosmetic appearance of the corresponding article (e.g., foldable substrate) can be impaired by both fluctuations in large spatial frequencies (e.g., warp) as well as smaller spatial frequencies (that can be detected as local changes in surface profile).

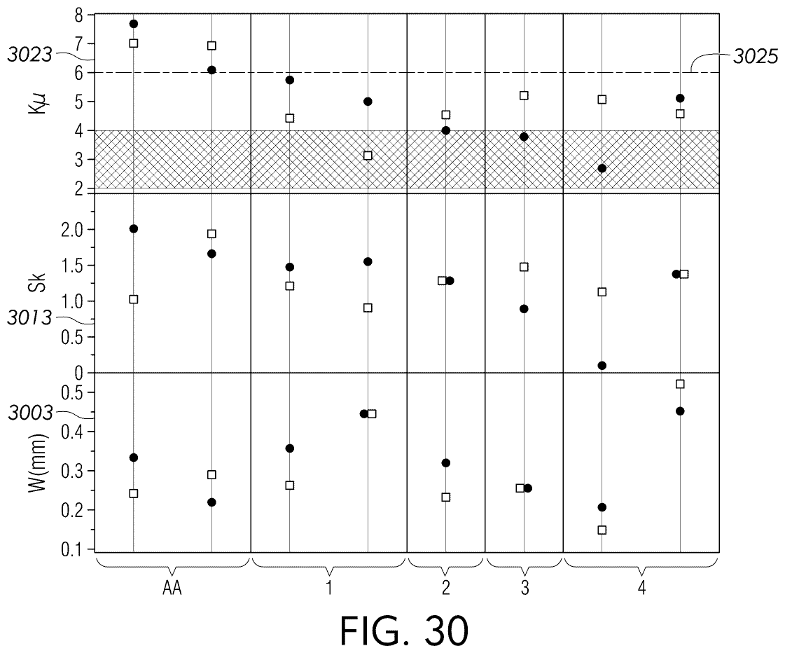

In aspects, a warp of the first major surface 203 of the foldable substrate 201 (e.g., along the midline thereof) can be less than or equal to 1.0 mm, less than or equal to 0.8 mm, less than or equal to 0.5 mm, less than or equal to 0.4 mm, less than or equal to 0.3 mm, less than or equal to 0.2 mm, or less than or equal to 0.1 mm (e.g., from 0.01 mm to 1.0 mm, from 0.05 mm to 0.8 mm, from 0.10 mm to 0.5 mm, from 0.15 mm to 0.4 mm, from 0.20 mm to 0.3 mm, or any range or subrange therebetween). In aspects, a skewness of the surface profile (e.g., “shape skewness,” along a midline) of the first major surface 203 of the foldable substrate 201 can be greater than or equal to −1.5, greater than or equal to −1.2, greater than or equal to −1.0, greater than or equal to −0.8, greater than or equal −0.5, greater than or equal −0.2, greater than or equal 0.0, greater than or equal 0.2, greater than or equal 0.5, greater than or equal 0.8, less than or equal 1.5, less than or equal 1.2, less than or equal 1.0, less than or equal to 0.8, less than or equal to 0.5, less than or equal 0.2, less than or equal 0.0, less than or equal −0.2, or less than or equal to −0.5. In aspects, a skewness of the surface profile (e.g., along a midline) of the first major surface 203 of the foldable substrate 201 can be from greater than or equal to −1.5 to less than or equal to 1.5, from greater than or equal to −1.2 to less than or equal to 1.2, from greater than or equal to −1.0 to less than or equal to 1.0, from greater than or equal to −0.8 to less than or equal to 0.8, from greater than or equal to −0.5 to less than or equal to 0.5, from greater than or equal to −0.2 to less than or equal to 0.2, or any range or subrange therebetween. In aspects, a kurtosis of the surface profile (e.g., “shape kurtosis,” along a midline) of the first major surface 203 of the foldable substrate 201 can be less than or equal to 6, less than or equal to 5, less than or equal to 4, less than or equal to 3, greater than or equal to 2, greater than or equal to 2.5 greater than or equal to 3, or greater than or equal to 4. In aspects, the kurtosis of the surface profile (e.g., along a midline) of the first major surface 203 of the foldable substrate 201 can be from greater than or equal to 2 to less than or equal to 6, from greater than or equal to 2.5 to less than or equal to 5, from greater than or equal to 3 to less than or equal to 4, or any range or subrange therebetween. In further aspects, the shape kurtosis of the foldable substrate 201 in accordance with the present disclosure can be less than a comparative shape kurtosis of a comparative substrate manufactured identically to the foldable substrate other than the heat treating prior to being chemically strengthened (discussed below with reference to step 1003) by from 15% to 75%, from 20% to 70%, from 25% to 66%, from 33% to 60%, from 40% to 50%, or any range or subrange therebetween. For example, FIG. 30 demonstrates that a warp (W) less than or equal to 0.5 mm, an absolute value of the shape skewness (Sk) less than or equal to 1.5, and/or a shape kurtosis less than or equal to 6 can be achieved through the method of the present disclosure (whereas the Example AA does not achieve these shape skewness and shape kurtosis metrics). Indeed, these results indicate that the method of the present disclosure decreases the shape kurtosis by from 15% to 75% relative to Example AA.

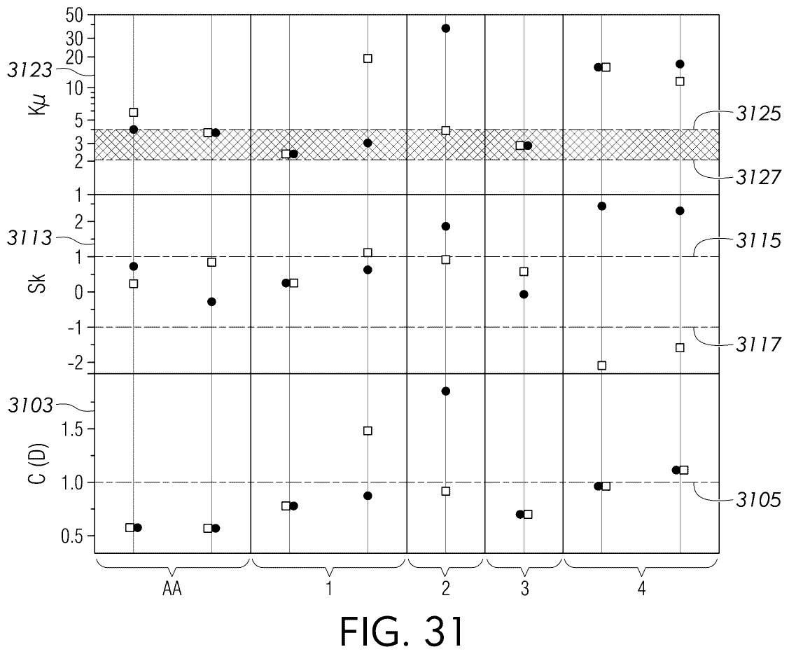

In aspects, a maximum curvature (i.e., maximum value of the maximum local curvature) of the foldable substrate (e.g., first major surface) can be less than or equal to 1.0 Diopter (D), less than or equal to 0.8 D, less than or equal to 0.7 D, less than or equal to 0.5 D, or less than or equal to 0.2 D (e.g., from 0 D to 1.0 D, from 0.1D to 0.8 D, from 0.25 D to 0.7 D, from 0.4 D to 0.5 D, or any range or subrange therebetween. In aspects, a curvature skewness (i.e., skewness of the maximum local curvature) can be can be greater than or equal to −1.0, greater than or equal to −0.8, greater than or equal −0.5, greater than or equal −0.2, greater than or equal 0.0, greater than or equal 0.2, greater than or equal 0.5, less than or equal 1.0, less than or equal to 0.8, less than or equal to 0.5, less than or equal 0.2, less than or equal 0.0, less than or equal −0.2, or less than or equal to −0.5. In aspects, a curvature skewness (i.e., skewness of the maximum local curvature) of the foldable substrate (e.g., first major surface) can be from greater than or equal to −1.0 to less than or equal to 1.0, from greater than or equal to −0.8 to less than or equal to 0.8, from greater than or equal to −0.5 to less than or equal to 0.5, from greater than or equal to −0.2 to less than or equal to 0.2, or any range or subrange therebetween. In aspects, a curvature kurtosis (i.e., kurtosis of the maximum local curvature) of the foldable substrate (e.g., first major surface) can be less than or equal to 4.0, less than or equal to 3.5, less than or equal to 3.0, less than or equal to 2.5, greater than or equal to 2.0, greater than or equal to 2.5, greater than or equal 3.0, or greater than or equal to 3.5. In aspects, a curvature kurtosis (i.e., kurtosis of the maximum local curvature) of the foldable substrate (e.g., first major surface) can be from greater than or equal to 2.0 to less than or equal to 4.0, from greater than or equal to 2.5 to less than or equal to 3.5, from greater than or equal to 2.5 to less than or equal to 3.0, or any range or subrange therebetween. For example, FIG. 31 demonstrates that a curvature (C) less than or equal to 1.0 Diopters, an absolute value of the curvature skewness (Sk) less than or equal to 1.0, and/or a curvature kurtosis from greater than or equal to 2 to less than or equal to 4 can be achieved through the method of the present disclosure.

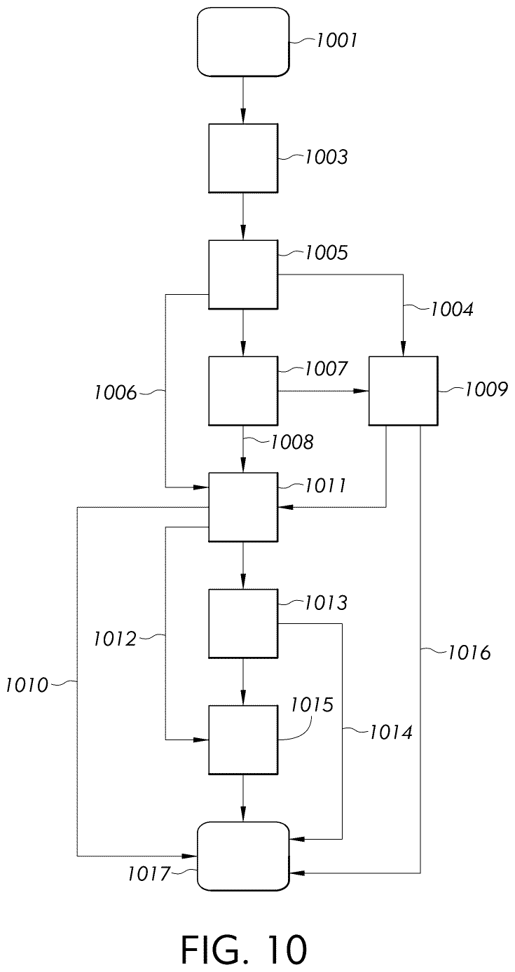

As used herein, an etching rate of the foldable substrate (independent of the methods discussed below with reference to the flow chart in FIG. 10) is measured in an etchant solution that is a 2 wt % HF aqueous solution maintained at 25° C., where the etching rate is reported as the amount of thickness removed from each side of the foldable substrate contacting the etchant, and the thickness removed is measured after an etching time of 5 minutes. For example, if both major surfaces of a sample are contacted, the change in thickness of the sample (per minute) is divided by 2 (for 2 major surfaces) to get the etching rate. Also, the thickness removed is divided by the etching time of 5 minutes to get the etching rate. In aspects, the foldable substrate can exhibit an etching rate less than or equal to 1.0 μm/min, less than or equal to 0.8 μm/min, less than or equal to 0.60 μm/min, less than or equal to 0.57 μm/min, or less than or equal to 0.55 μm/min (e.g., from 0.1 μm/min to 1.0 μm/min, from 0.25 μm/min to 0.8 μm/min, from 0.5 μm/min to 0.60 μm/min, from 0.52 μm/min to 0.57 μm/min, from 0.54 μm/min to 0.55 μm/min, or any range or subrange therebetween). In aspects, the etching rate of the foldable substrate can be less than a comparative etching rate of a comparative substrate of a comparative substrate manufactured identically to the foldable substrate other than the heat treating prior to being chemically strengthened (discussed below with reference to step 1003), as a percentage of the comparative etching range, by from greater than or equal to 3% to less than or equal to 10%, from greater than or equal to 4% to less than or equal to 8%, from greater than or equal to 5% to less than or equal to 6%, or any range or subrange therebetween.

Aspects of methods of chemically strengthening the foldable substrate 201 (e.g., in methods of making the foldable apparatus 101, 301 and/or 401) illustrated in FIGS. 2-3 and 5, in accordance with aspects of the disclosure, will be discussed with reference to the flow chart in FIG. 10 and example method steps illustrated in FIGS. 12-16 along with the cross-sectional view illustrated in FIG. 17.

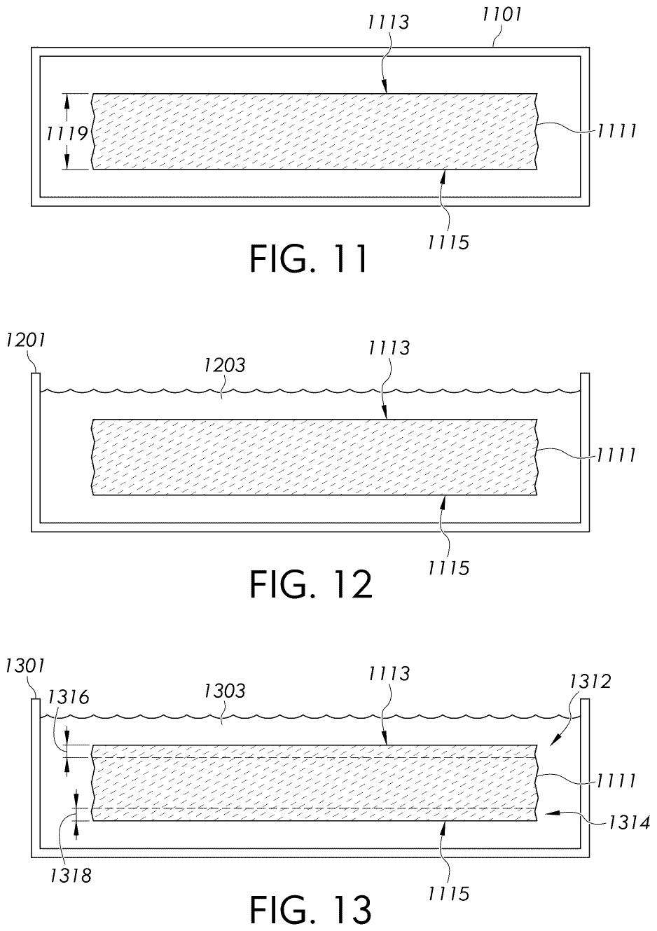

In a first step 1001 of methods of the disclosure, as shown in FIGS. 11-12, methods can start with providing a foldable substrate 1111. In aspects, the foldable substrate 1111 may be provided by purchase or otherwise obtaining a substrate or by forming the foldable substrate. In aspects, the foldable substrate 1111 can comprise a glass substrate. In further aspects, glass substrates can be provided by forming them with a variety of ribbon forming processes, for example, slot draw, down-draw, fusion down-draw, up-draw, press roll, redraw, or float. The foldable substrate 1111 may comprise an existing first major surface 1113 and an existing second major surface 1115 opposite the existing first major surface 1113. In further aspects, an initial thickness 1119 of the foldable substrate 1111 (defined as an average distance between the existing first major surface 1113 and the existing second major surface 1115) can be within one or more of the ranges discussed above and/or may be within 5 μm of the final thickness (e.g., substrate thickness 209) (i.e., greater than the final thickness by from 0.1 μm to 5 μm or from 0.5 μm to 4 μm). In further aspects, the existing first major surface 1113 and/or the existing second major surface 1115 can extend along a plane. In aspects, the foldable substrate 1111 can have a composition within one or more of the ranges discussed above for the glass substrate (e.g., foldable substrate 201). In aspects, at the end of step 1001, the foldable substrate 1111 can be substantially unstrengthened. As used herein, substantially unstrengthened refers to a substrate comprising either no depth of layer, no depth of compression, a depth of layer in a range from 0% to 5% of the substrate thickness, or a depth of compression in a range from 0% to 5% of the substrate thickness.

After step 1001, as shown in FIGS. 11-12, methods can proceed to step 1003 comprising heating the foldable substrate 1111 at a first temperature for a first period of time (to form a heat-treated glass substrate). As used herein, the term “annealing point” refers to the temperature at which the viscosity of the glass composition is 1×10^{13.18} poise. The annealing point of the glass compositions was determined using the fiber elongation method of ASTM C336-71 (2015). In aspects, the first temperature can be less than the annealing point temperature by from greater than or equal to 10° C., greater than or equal to 25° C., greater than or equal to 40° C., greater than or equal to 50° C., greater than or equal to 60° C., greater than or equal to 75° C., greater than or equal to 80° C., greater than or equal to 90° C., less than or equal to 150° C., less than or equal to 125° C., less than or equal to 100° C., less than or equal to 90° C., less than or equal to 75° C., less than or equal to 60° C., less than or equal to 50° C., less than or equal to 40° C., or less than or equal to 30° C. In aspects, the first temperature can be less than the annealing point temperature by from greater than or equal to 10° C. to less than or equal to 150° C., from greater than or equal to 25° C. to less than or equal to 125° C., from greater than or equal to 40° C. to less than or equal to 100° C., from greater than or equal to 50° C. to less than or equal to 75° C., or any range or subrange therebetween. In preferred aspects, the first temperature can be less than the annealing point temperature by from greater than or equal to 10° C. to less than or equal to 150° C., from greater than or equal to 25° C. to less than or equal to 100° C., or from greater than or equal to 50° C. to less than or equal to 75° C. For example, if the annealing point temperature of the foldable substrate is 627° C., then a first temperature that is less than the annealing point temperature by from greater than or equal to 25° C. to less than or equal to 100° C. means that the first temperature is from greater than or equal to 527° C. to less than or equal to 602° C. (i.e., from 627° C.-100° C. to 627° C.-25° C.). In aspects, the first temperature can be from greater than or equal to 500° C. to less than or equal to 650° C., from greater than or equal to 525° C. to less than or equal to 625° C., from greater than or equal to 550° C. to less than or equal to 600° C., from greater than or equal to 550° C. to less than or equal to 575° C., or any range or subrange therebetween. In aspects, the lower bound of the first temperature can be the greater of (a) the temperature below the annealing point temperature from the corresponding range above in this paragraph and (b) the specific temperature (e.g., greater than or equal to 500° C.) from the corresponding range above in this paragraph. For example, the lower bound for the first temperature can be the greater of: (a) greater than or equal to 150° C. below the annealing point temperature and (b) greater than or equal to 500° C.; (a) greater than or equal to 125° C. below the annealing point temperature and (b) greater than or equal to 525° C.; greater than or equal to 100° C. below the annealing point temperature and (b) greater than or equal to 550° C.; etc.

In aspects, the first period of time can be less than or equal to 1.5 hours, less than or equal to 1.25 hours, less than or equal to 1.0 hours, less than or equal to 45 minutes, less than or equal to 30 minutes, less than or equal to 15 minutes, greater than or equal to 1 minute, greater than or equal to 5 minutes, greater than or equal to 10 minutes, greater than or equal to 15 minutes, greater than or equal to 20 minutes, greater than or equal to 30 minutes, greater than or equal to 45 minutes, or greater than or equal to 60 minutes. In aspects, the first period of time can be from greater than or equal to 1 minute to less than or equal to 1.5 hours, from greater than or equal to 5 minutes to less than or equal to 1.25 hours, from greater than or equal to 10 minutes to less than or equal to 1.0 hours, from greater than or equal to 15 minutes to less than or equal to 45 minutes, from greater than or equal to 20 minutes to less than or equal to 30 minutes, or any range or subrange therebetween. In preferred aspects, the first period of time can be in a range from greater than or equal to 1 minute to less than or equal to 1.5 hours, from greater than or equal to 5 minutes to less than or equal to 1.0 hours, or from greater than or equal to 10 minutes to less than or equal to 30 minutes.

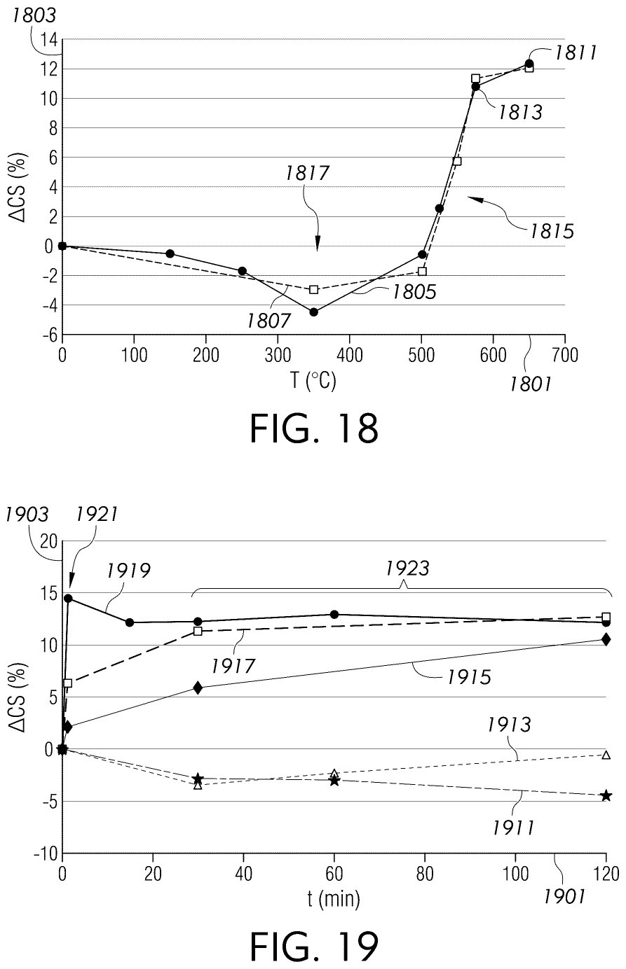

Unexpectedly, as demonstrated by the examples herein (e.g., see FIGS. 18-19 and 21), the heating of step 1003 can enable increased compressive stress to be developed from the chemical strengthening (in step 1005) even though the duration of the heating too short (and/or the temperature too low) to significantly modify the fictive temperature. The fictive temperature is a parameter for characterizing the structure and properties of a glass. The cooling rate from the melt affects the fictive temperature. The faster the cooling rate, the higher the fictive temperature. For many glasses, properties such as Young's modulus, shear modulus, refractive index, and density decrease with increasing fictive temperature. The rate of change in these properties with fictive temperature depends on glass composition. The fictive temperature of the glass can be set by holding the glass at a given temperature in the glass transition range. The minimum time required to reset the fictive temperature is approximated by 30*((the viscosity of the glass at the heat treatment temperature)/shear modulus). To ensure full relaxation to the new fictive temperature, glasses may be held at times far exceeding 30*((the viscosity of the glass at the heat treatment temperature)/shear modulus). Unless otherwise indicated, fictive temperatures of glass substrates where the thermal history is unknown is determined in accordance with the methods described in the following references: (1) Y. Z. Yue, J. deC. Christiansen, S. L. Jensen, “Determination of the fictive temperature for a hyperquenched glass”, Chemical Physics Letters 357 (2002): 20-24 and (2) X. Guo, M. Potuzak, J. C. Mauro, D. C. Allan, T. J. Kiczenski, Y. Yue, “Unified approach for determining the enthalpic fictive temperature of glasses with arbitrary thermal history”, Journal of Non-Crystalline Solids 357 (2011): 3230-3236.

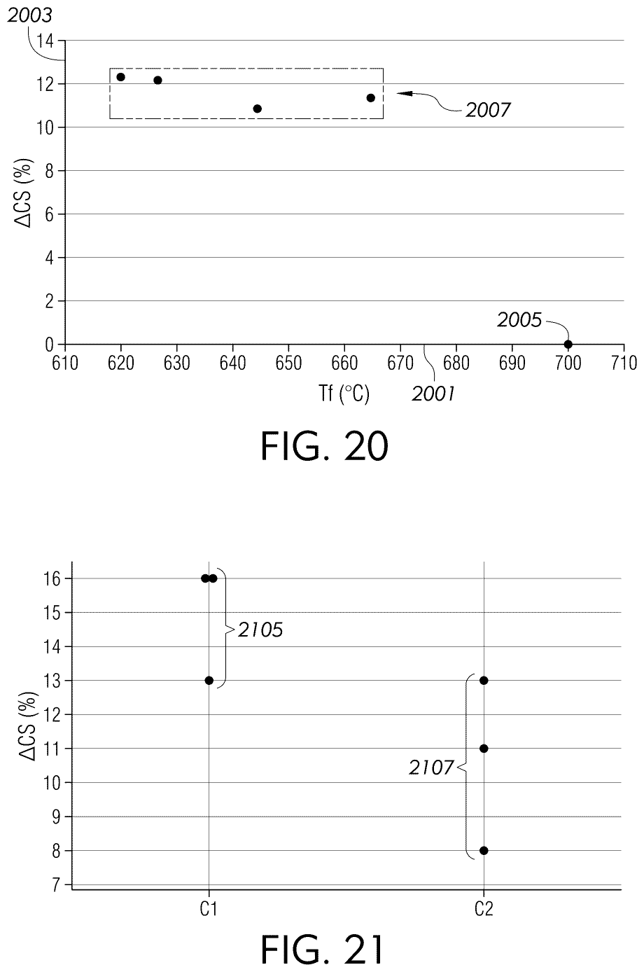

In particular, annealing glass is typically conducted at the annealing point temperature of the glass for multiple hours (e.g., greater than 8 hours) to set the fictive temperature to the annealing point temperature. It has been observed that such annealing can increase the density of the glass (e.g., compaction), and that this increased density can enable higher compressive stress to be obtained (relative to glass that is not annealed). In contrast, the heating of step 1003 is at a temperature less than the annealing temperature and for a period of time less than or equal to 1.5 hours. Consequently, it is unexpected that the heating of step 1003 can provide the improvements in compressive stress seen in FIGS. 18-19 and 21. Further, without wishing to be bound by theory, it would be expected that the strength of any increase due to densification (i.e., decrease in compressive stress) would be highly time-dependent with an exponential (or logarithmic depending on how the relationship is viewed) leading to an asymptote at long time (e.g., 8 hours or more). Instead, FIG. 19 demonstrates that the increase in compressive stress is largely time-independent—from as short as 1 minute to 2 hours or from 30 minutes to 2 hours—e.g., for curves 1919 and/or 1917. Moreover, FIG. 20 demonstrates that the fictive temperature is not significantly effected by the heating of step 1003.

Additionally, the temperature range of the heating associated with the unexpectedly increased compressive stress is bounded, as shown in FIG. 18. At higher temperatures—e.g., around 650° C. corresponding to the annealing temperature—changes in fictive temperature become more pronounced. At lower temperatures (e.g., less than 500° C.-150° C. less than the annealing temperature) the compressive stress is decreased as a result of heating. Without wishing to be bound by theory, it is believed that the glass expands enough that the glass network is not as stressed through the ion-exchange of larger ions into the glass as it would otherwise be. Consequently, the unexpectedly increased compressive stress as a result of the heating in step 1003 occurs between 150° C. below the annealing point temperature to less than the annealing point temperature (e.g., 10° C. less than the annealing point temperature)—with more pronounced increases in compressive stress seen in the range from 100° C. below the annealing point temperature to 25° C. less than the annealing point temperature.

In aspects, as shown in FIG. 11, heating the foldable substrate 1111 can comprise placing the foldable substrate 1111 in an environment (e.g., air, in an oven 1101) maintained at the first temperature for the first period of time. Alternatively, as shown in FIG. 12, heating the foldable substrate 1111 can comprise immersing the foldable substrate in a non-strengthening molten salt solution 1203 (e.g., containing in a salt bath 1201). As used herein, immersing the foldable substrate in the non-strengthening molten salt solution does not develop substantial compressive stress in the foldable substrate—a depth of compression less than 5% of the substrate thickness, including no compressive stress region. In further aspects, the non-strengthening molten salt solution consists of salts of alkali metals that are present in the foldable substrate (before step 1003). In even further aspects, a ratio of the alkali metals in the non-strengthening molten salt solution can be the same as the corresponding ratio of alkali metals in the glass such that no net exchange of ions occurs, which does not develop a compressive stress region. For example, a glass comprising sodium (but no other alkali metals) immersed in a molten salt solution consisting of sodium nitrate does not develop a compressive stress region; thus, the sodium nitrate molten salt solution is a non-strengthening molten salt solution for this example glass. Consequently, the non-strengthening molten salt solution can effectively heat the glass (e.g., having a higher heat capacity and/or specific heat than the environment—air—in FIG. 11) without developing a compressive stress region therein. In further aspects, the non-strengthening molten salt solution can comprise an alkali chloride, an alkali sulfate salt, or combinations thereof. With reference to the example discussed above in this paragraph, an exemplary aspect of the non-strengthening molten salt solution can comprise (or consist of) sodium chloride and/or sodium sulfate maintained at the first temperature.

After step 1001 or 1003, as shown in FIG. 13, methods can proceed to step 1005 comprising contacting at least the existing first major surface 1113 of the foldable substrate 1111 (e.g., heat-treated glass substrate) with a molten salt solution 1303 maintained at a second temperature for a second period of time to develop an initial compressive stress region (in the resulting chemically strengthened glass substrate). Properties of initial compressive stress region (e.g., maximum compressive stress, depth of compression, depth of layer) can be within one or more of the corresponding ranges discussed above. In aspects, as shown in FIG. 13, the molten salt solution 1303 can be contained in a molten salt bath 1301, and the contacting at least the existing first major surface 1113 with the molten salt solution 1303 can comprise immersing the foldable substrate 1111 in the molten salt solution 1203, for example with both the existing first major surface 1113 and the existing second major surface 1115 in contact with the molten salt solution 1203, although only a portion of the foldable substrate may contact the molten salt solution in other aspects. Chemically strengthening the foldable substrate 1111 by ion exchange can occur when a first cation within a depth of a surface of a foldable substrate 1111 is exchanged with a second cation within a molten salt solution 1303 that has a larger radius than the first cation. For example, a lithium cation within the depth of the surface of the foldable substrate 1111 can be exchanged with a sodium cation or potassium cation within the molten salt solution 1303. Similarly, a sodium cation within the depth of the surface of the foldable substrate 1111 can be exchanged with a potassium cation within the molten salt solution 1303 to develop compressive stress within the foldable substrate 1111. Consequently, the surface of the foldable substrate 1111 is placed in compression and thereby chemically strengthened by the ion exchange process since the lithium cation has a smaller radius than the radius of the exchanged sodium cation or potassium cation within the molten salt solution 1303. In aspects, a temperature of the heat-treated glass substrate can be maintained at a temperature greater than or equal to 300° C. between the heat treating (e.g., at the end of step 1003) and the chemically strengthening (e.g., at the beginning of step 1005) the heat-treated glass substrate. In aspects, the chemical strengthening the foldable substrate (e.g., heat-treated foldable substrate at the beginning of step 1005) can begin immediately after the conclusion of the heat-treating in step 1003. Avoiding large temperature swings between step 1003 and step 1005 can reduce thermal shock (and potential damage) to the heat-treated foldable substrate.

In aspects, the second temperature of the molten salt solution 1303 can be 350° C. or more, 360° C. or more, 370° C. or more, 380° C. or more, 450° C. or less, 430° C. or less, 400° C. or less, 390° C. or less, or 380° C. or less. In aspects, the first temperature of the molten salt solution 1203 can be in a range from 350° C. to 450° C., from 360° C. to 430° C., from 370° C. to 400° C., from 380° C. to 390° C., or any range or subrange therebetween. In preferred aspects, the first temperature can be from 350° C. to 450° C. or from 350° C. to 400° C. In aspects, the second period of time that the foldable substrate 1111 (e.g., existing first major surface 1113) is in contact with the molten salt solution 1303 can be 10 minutes or more, 15 minutes or more, 20 minutes or more, 30 minutes or more, 45 minutes or more, 60 minutes or more, 180 minutes or less, 120 minutes or less, 90 minutes or less, 75 minutes or less, 60 minutes or less, 45 minutes or less, 30 minutes or less, 20 minutes or less, or 15 minutes or less. In aspects, the second period of time can be from 10 minutes to 180 minutes, from 15 minutes to 120 minutes, from 20 minutes to 90 minutes, from 30 minutes to 75 minutes, from 45 minutes to 60 minutes, or any range or subrange therebetween. In preferred aspects, the second period of time can be from 10 minutes to 180 minutes, from 15 minutes to 90 minutes, or from 30 minutes to 60 minutes.

In aspects, the molten salt solution 1303 can comprise at least two anions associated with different salts. In further aspects, the at least two anions can be associated with different potassium salts, and the molten salt solution 1303 can comprise potassium ions in addition to the at least two anions. In even further aspects, a concentration of the first potassium salt and a concentration of the second potassium salt in the molten salt solution 1303 can be 2.0 wt % or more, 2.5 wt % or more, 3.0 wt % or more, 4.0 wt % or more, 5.0 wt % or more, 7 wt % or more, 8 wt % or more, 10 wt % or more, 12 wt % or less, 10 wt % or less, 8 wt % or less, 5.0 wt % or less, 4.0 wt % or less, or 3.0 wt % or less of the total 100 wt % of the molten salt solution 1303 (i.e., before immersing the foldable substrate 1111). Unless otherwise indicated, the composition of the molten salt solution 1303 refers to the composition before the foldable substrate 1111 is immersed therein and is based on a total 100 wt % of the molten salt solution. It is to be understood that the molten salt solution can comprise additional components beyond the components of the two potassium salts discussed herein, for example, a sodium salt, a lithium salt, silicic acid, or combinations here. For example, the molten salt solution can comprise silicic acid, as a wt % superaddition to the molten salt solution excluding the silicic acid, from 0.1 wt % to 1.0 wt %, from 0.3 wt % to 0.7 wt %, from 0.3 wt % to 0.5 wt %, or any range or subrange therebetween. In further aspects, a concentration of a first potassium salt in the molten salt solution 1303 be in a range from 2.0 wt % to 12 wt %, from 2.5 wt % to 10 wt %, from 3.0 wt % to 8 wt %, from 4.0 wt % to 5.0 wt %, or any range or subrange therebetween. In preferred aspects, a concentration of the first potassium salt in the molten salt solution (based on a total 100 wt % of the molten salt solution before the foldable substrate is immersed therein) can be from 2.0 wt % to 12 wt % or from 2.5 wt % to 5.0 wt %.

In further aspects, the first potassium salt can comprise two or more potassium atoms per anion. Providing the first potassium salt with multiple (i.e., two or more) potassium atoms per anion can increase an effective concentration and/or activity of potassium in the molten salt solution, which can facilitate increased maximum compressive stress in the resulting chemically-strengthened foldable substrate. Throughout the disclosure, a pKa of a potassium salt is measured in accordance with OPPTS 830.7370 “Dissociation Constants in Water” from the United States Environmental Protection Agency (August 1996) available through the National Service Center for Environmental Publications. In further aspects, the first potassium salt can comprise a pKa of 9 or more, 10 or more, 10.5 or more, 11 or more, 20 or less, 15 or less, 13 or less, or 12 or less. In further aspects, the first potassium salt can comprise a pKa in a range from 9 to 20, from 10 to 15, from 10.5 to 13, from 11 to 12, or any range or subrange therebetween. Providing a first potassium salt in the molten salt solution with a pKa of 9 or above can improve the strength and/or foldability of the resulting chemically-strengthened foldable substrate, for example, by selectively etching flaws inherent in the foldable substrate that might otherwise be magnified by the chemical strengthening treatment. Exemplary aspects of potassium salts with more than two potassium atoms per anion and a pKa of 9 or more include potassium carbonate (K₂CO₃) and potassium phosphate (K₃PO₄). A preferred aspect of the first potassium salt is potassium carbonate (K₂CO₃), and a concentration of potassium carbonate (as the first potassium salt) can be within one or more of corresponding ranges discussed in the previous paragraph (e.g., from 2.0 wt % to 12 wt %, from 2.5 wt % to 5.0 wt %). As discussed herein, potassium carbonate (K₂CO₃) in molten salt solutions can result in increased compressive stress in foldable substrates. Additionally, without wishing to be bound by theory, it is believed that the carbonate anion can facilitate precipitation of other cations (e.g., lithium, sodium) exchanged out of the foldable substrate, which can increase a longevity of the molten salt solution (e.g., by removing components from the solution phase that could otherwise “poison” the molten salt solution).

In further aspects, the molten salt solution comprises a second potassium salt associated with the two or more anions, where the anion of the first potassium salt is different than the anion of the second potassium salt. In even further aspects, the second potassium salt can be or more or more potassium nitrate (KNO₃) and/or potassium chloride (KCl). A preferred aspect of the second potassium salt is potassium nitrate (KNO₃). In further aspects, a concentration of the second potassium salt (e.g., potassium nitrate) in the molten salt solution can be 50 wt % or more, 70 wt % or more, 80 wt % or more, 84 wt % or more, 88 wt % or more, 89 wt % or more, 90 wt % or more, 91 wt % or more, 92 wt % or more, 93 wt % or more, 94 wt % or more, 95.0 wt % or more, 96.0 wt % or more, 97.0 wt % or more, 97.5 wt % or more, or 98.0 wt % or more. In further aspects, a concentration of the second potassium salt (e.g., potassium nitrate) in the molten salt solution can be in a range from 50 wt % to 98.0 wt %, from 70 wt % to 98 wt %, from 80 wt % to 98.0 wt %, from 84 wt % to 98.0 wt %, from 88 wt % to 97.5 wt %, from 89 wt % to 97.5 wt %, from 90 wt % to 97.0 wt %, from 91 wt % to 96.5 wt %, from 92 wt % to 96.0 wt %, from 93 wt % to 95.5 wt %, from 94 wt % to 95.0 wt %, or any range or subrange therebetween. In preferred aspects, a concentration of the second potassium salt (e.g., potassium nitrate) in the molten salt solution can be in a range from 50 wt % to 98.0 wt %, from 88 wt % to 97.5 wt %, or from 95.0 wt % to 97.0 wt %.

In further aspects, the molten salt solution 1303 can comprise a third potassium salt associated with a third anion of the at least two anions, where the third anion is different from the anions associated with the first potassium salt and the second potassium salt (discussed above). In even further aspects, the third potassium salt can have two or more potassium atoms per anion (similar to the first potassium salt). An exemplary aspect of the third potassium salt is potassium sulfate K₂SO₄. For example, the molten salt solution 1303 can comprise K₂CO₃ as the first potassium salt, KNO₃ as the second potassium salt, and K₂SO₄ as the (optional) third potassium salt. In even further aspects, a concentration of the third potassium salt (e.g., potassium sulfate) in the molten salt solution can be 0 wt % or more, 0.1 wt % or more, 0.3 wt % or more, 0.5 wt % or more, 0.8 wt % or more, 1.0 wt % or more, 1.2 wt % or more, 1.5 wt % or more, 5.0 wt % or less, 4.0 wt % or less, 3.0 wt % or less, 2.5 wt % or less, 2.0 wt % or less, 1.8 wt % or less, 1.5 wt % or less, 1.0 wt % or less, 0.8 wt % or less, or 0.5 w % or less. In even further aspects, a concentration of the third potassium salt (e.g., potassium sulfate) in the molten salt solution can be in a range from 0 wt % to 5.0 wt %, from 0.1 wt % to 4.0 wt %, from 0.2 wt % to 3.0 wt %, from 0.5 wt % to 2.5 wt %, from 0.8 wt % to 2.0 wt %, from 1.0 wt % to 1.8 wt %, from 1.2 wt % to 1.5 wt %, or any range or subrange therebetween.

Due to the presence of the first potassium salt (e.g., having a pKa or 9 or more, potassium carbonate), in aspects, the molten salt solution 1303 can be basic (i.e., have a pH greater than 7). In further aspects, a pH of the molten salt solution 1303 can be 8 or more, 9 or more, 10 or more, 10.5 or more, 11 or more, 15 or less, 13 or less, or 12 or less. In further aspects, a pH of the molten salt solution 1303 can be in a range from 8 to 15, from 9 to 13, from 9 to 12, from 10 to 13, from 10.5 to 12, or any range or subrange therebetween. In preferred aspects, the pH of the molten salt solution can be in a range from 9 to 12 or from 10 to 11. Providing pH from 9 to 12 of the molten salt solution can improve the strength and/or foldability of the resulting chemically-strengthened foldable substrate, for example, by selectively etching flaws inherent in the foldable substrate that might otherwise be magnified by the chemical strengthening treatment. Additionally, in aspects, as discussed below and shown in FIGS. 14-15 and 17, the chemical strengthening treatment of step 1005 can create an initial first compressive stress region 1312 and/or an initial second compressive stress region 1314. For example, the presence of the first potassium salt can increase a compressive stress imparted by the contacting the existing first major surface (in at least step 1005) with the molten salt solution 1303 by 5% or more (e.g., 10% or more, from 5% to 20%, from 5% to 15%, or from 7% to 10%) relative to immersing the foldable substrate in a comparative molten salt solution with the same composition as the molten salt solution with the absence of the first potassium salt-even when the foldable substrate is heat treated in step 1003. As demonstrated by the examples herein, the combination of the heat treatment (step 1003) and the multiple anions in the molten salt solution (step 1005) provides further increases to compressive stress relative to doing either treatment on its own.

In aspects, after step 1005, as shown in FIG. 14, methods can proceed to step 1007 comprising transferring the foldable substrate 1111 to a cooling chamber 1401, and a temperature of the cooling chamber is decreased from an initial temperature to a final temperature. In further aspects, as shown in FIG. 14, the foldable substrate 1111 can still contain a residual portion of the molten salt solution (indicated by drop 1405) and/or deposits 1403 on the surface (e.g., existing first major surface 1113) from contact with the molten salt solution in step 1005. In even further aspects, as shown in FIG. 14, the foldable substrate 1111 can be suspended in the cooling chamber 1401, for example, to facilitate removal of any residual portion of the molten salt solution from the foldable substrate 1111 (as indicated by drop 1405) that can run off of the foldable substrate 1111 in a direction of gravity (not shown but presumed to be down in FIG. 14).

In aspects, the initial temperature of the cooling chamber 1401 (e.g., when the foldable substrate 1111 is placed therein) can be 300° C. or less, 280° C. or less, 260° C. or less, 240° C. or less, 220° C. or less, 180° C. or more, 190° C. or more, 200° C. or more, 210° C. or more, or 220° C. or more. In aspects, the initial temperature of the cooling chamber 1401 (e.g., when the foldable substrate 1111 is placed therein) can be from 180° C. to 300° C., from 190° C. to 280° C., from 200° C. to 260° C., from 210° C. to 240° C., from 210° C. to 220° C. or any range or subrange therebetween. In preferred aspects, the initial temperature of the cooling chamber 1401 can be in a range from 180° C. to 300° C. or from 180° C. to 220° C. In further aspects, a difference between the first temperature than the molten salt solution 1303 is maintained at in step 1005 and the initial temperature of the cooling chamber 1401 in step 1007 (i.e., first temperature minus initial temperature) can be 50° C. or more, 75° C. or more, 100° C. or more, 120° C. or more, 140° C. or more, or 160° C. or more. Providing an initial temperature of the cooling chamber that is lower than the molten salt solution (e.g., by 50° C. or more, 100° C. or more, or 140° C. or more) can decrease a residual chemical strengthening occurring from any residual portion of the molten salt solution or deposits from the molten salt solution on the foldable substrate after it is removed from the molten salt solution). In particular, it has been observed that foldable substrates with a thickness of 50 μm or less (e.g., from 10 μm to 50 μm or from 10 μm to 30 μm) are unexpectedly sensitive to what happens after the foldable substrate is removed from the molten salt solution. For these thin foldable substrates, even a relatively small difference in compressive stress across the surface thereof can result in waviness and/or warp that can produce optical distortions that can be visible to a user of a consumer electronic product that the foldable substrate may be incorporated in. Consequently, the controlled temperature of the cooling chamber can facilitate a relatively even compressive stress across the surface of the foldable substrate. Also, providing an initial temperature of the cooling chamber of 180° C. or more (e.g., 200° C. or more or 220° C. or more) can facilitate the removal of a residual portion of the molten salt solution before it solidifies. Without wishing to be bound by theory, the first potassium salt can have a higher melting temperature than the second potassium salt, which means that incorporating the first potassium salt in the molten salt solution can increase a viscosity of the molten salt solution and/or cause the molten salt solution to solidify at higher temperature than a molten salt solution without the first potassium salt. Consequently, allowing a residual portion of the molten salt solution on the foldable substrate after it is removed from the molten salt solution can be especially useful when the molten salt solution includes the first potassium salt.

In further aspects, the final temperature of the cooling chamber 1401 can be 25° C. or more, 40° C. or more, 60° C. or more, 70° C. or more, 90° C. or less, or 80° C. or less, 70° C. or less, or 60° C. or less. In further aspects, the final temperature of the cooling chamber 1401 can be in a range from 25° C. to 90° C., from 40° C. to 90° C., from 60° C. to 80° C., from 70° C. to 80° C., or any range or subrange therebetween. Reducing the temperature of the cooling chamber to a final temperature of 90° C. or less can enable the foldable substrate to be subsequently treated (e.g., relatively quickly or immediately) thereafter using aqueous solutions (e.g., rinsing with water or an alkaline detergent solution, contact with an aqueous acidic solution).

In further aspects, a cooling rate of the temperature of the cooling solution can be obtained using sufficient ventilation and/or circulation of environment (e.g., air) through the cooling chamber. In further aspects, a cooling rate of the temperature of the cooling solution (e.g., from the initial temperature to the final temperature) can be 4° C. per minute (° C./min) or more, 6° C./min or more, 8° C./min or more, 10° C./min or more, 12° C./min or more, 14° C./min or more, 20° C./min or less, 18° C./min or less, 16° C./min or less, 14° C./min or less, or 10° C./min or less. In further aspects, a cooling rate of the temperature of the cooling solution (e.g., from the initial temperature to the final temperature) can be in a range from 4° C./min to 20° C./min, from 6° C./min to 18° C./min, from 8° C./min to 16° C./min, from 10° C./min to 14° C./min, from 12° C./min to 14° C./min, or any range or subrange therebetween. Providing a cooling rate from 4° C./min to 20° C./min can quickly reduce a temperature of the cooling chamber (and foldable substrate) while being able to maintain a relatively consistent temperature throughout the cooling chamber (and/or foldable substrate), for example, to produce a relatively consistent compressive stress across the surface of the foldable substrate.

In aspects, after step 1005 or 1007, as shown in FIG. 15, methods can proceed to step 1009 comprising (e.g., after removing the foldable substrate from the molten salt solution in step 1005 and/or after the cooling chamber reaches the final temperature in step 1007) rinsing the foldable substrate 1111 with a solution 1503. In further aspects, the solution 1503 can be contained in a bath 1501 and/or the foldable substrate 1111 can be immersed in the solution 1503 (e.g., with the existing first major surface 1113 and the existing second major surface 1115 in contact with the solution 1503). In further aspects, as shown between FIGS. 14 and 15, the solution 1503 can remove (e.g., dissolve and/or displace) deposits 1403 from the molten salt solution remaining on the foldable substrate 1111. In aspects, the solution 1503 can be agitated (e.g., ultrasonicated) to further facilitate removal of deposits 1403 and/or contaminants on the surface that could interfere with a uniform treatment of the surfaces of the foldable substrate in subsequent steps. In further aspects, the solution 1503 can be water (e.g., purified, filtered, deionized, and/or distilled), an alkaline detergent solution, or combinations thereof. As used herein, a pH of a solution is measured in accordance with ASTM E70-90 at 25° C. with standard solutions extending to a pH of at least 14. In even further aspects, the alkaline detergent solution (e.g., solution 1503) can comprise an alkaline detergent and a pH of 11 or more, 12 or more, 12.5 or more, 12.8 or more, 14 or less, 13.5 or less, or 13.2 or less. In aspects, the alkaline detergent solution (e.g., solution 1503) can comprise a pH ranging from 11 to 14, from 12 to 14, from 12.5 to 13.5, from 12.8 to 13.2, or any range or subrange therebetween. In aspects, the alkaline detergent solution (e.g., solution 1503) can comprise an alkaline detergent in a concentration from 0.5 wt % or more, 1 wt % or more, 1.5 wt % or more, 2 wt % or more, 4 wt % or less, 3 wt % or less, or 2.5 wt % or less. In aspects, the alkaline detergent solution (e.g., solution 1503) can comprise an alkaline detergent in a concentration ranging from 0.5 wt % to 4 wt %, from 1 wt % to 4 wt %, from 1.5 wt % to 3 wt %, from 2 wt % to 3 wt %, from 2.5 wt % to 3 wt %, or any range or subrange therebetween. An exemplary aspect of an alkaline detergent solution includes SemiClean KG (Yokohama Oils & Fats Industry Co.). Exemplary aspects of sonication include ultrasonication and megasonication. Without wishing to be bound by theory, sonication (e.g., ultrasonication, megasonication) can help remove contaminants (e.g., particles, oils) from a surface by forming microscale bubbles as the surface, by increasing circulation of the alkaline detergent solution through agitation, and/or by loosening contaminants through vibration directly. In aspects, the alkaline detergent solution and/or water can be free of a rheology modifier. As used herein, a rheology modifier is a component other than a solvent or a listed component (e.g., acid, hydroxide-containing base, H₂SiF₆, fluoride-containing compound) that modifies the viscosity of the solution or the shear-dependent behavior (e.g., dilatant, thixotropic). Example aspects of rheology modifiers that the solution can be free of include one or more of cellulose, a cellulose derivative (e.g., ethyl cellulose, methyl cellulose, and AQUAZOL (poly 2 ethyl-2 oxazine)), a hydrophobically modified ethylene oxide urethane modifier (HUER), and an ethylene acrylic acid.

In further aspects, the solution 1503 can comprise a rinsing temperature and/or be in contact with the foldable substrate 1111 for a rinsing period of time. In further aspects, sonication can be applied for at least half of the rinsing period of time, for example, the entire first period of time. In further aspects, the rinsing period of time can be 2 minutes or more, 3 minutes or more, 4 minutes or more, 5 minutes or more, 60 minutes or less, 40 minutes or less, 20 minutes or less, 10 minutes or less, 8 minutes or less, or 6 minutes or less. In further aspects, the rinsing period of time can range from 2 minutes to 40 minutes, from 2 minutes to 20 minutes, from 3 minutes to 20 minutes, from 3 minutes to 10 minutes, from 4 minutes to 8 minutes, from 4 minutes to 6 minutes, or any range or subrange therebetween. Providing a rinsing period of time of at least 2 minutes can effectively remove contaminants and/or deposits from the surface. Providing a rinsing period of time of less than 40 minutes can keep a chance of damage or breakage within acceptable ranges. In aspects, the first temperature can be 20° C. or more, 25° C. or more, 30° C. or more, 35° C. or more, 65° C. or less, 60° C. or less, 55° C. or less, or 45° C. or less. In aspects, the first temperature can range from 20° C. to 65° C., from 25° C. to 60° C., from 30° C. to 55° C., from 35° C. to 45° C., or any range or subrange therebetween. Providing the alkaline detergent solution may selectively act on surface flaws (e.g., removing, rounding, blunting) before removing material from other parts of the surface, which can increase the impact resistance of the substrate without removing a substantial thickness from the surface of the foldable substrate.

As shown in FIGS. 15 and 17, after and/or at the end of step 1005, 1007, and/or 1009, the chemically-strengthened foldable substrate (i.e., foldable substrate 1111) can comprise (e.g., as a result of the chemical strengthening treatment described above) an initial first compressive stress region 1312 extending to an initial first depth of compression 1316 from the existing first major surface 1113 and an initial first depth of layer of one or more alkali metal ions (e.g., potassium) associated with the initial first compressive stress region 1312, and/or the foldable substrate 1111 can comprise an initial second compressive stress region 1314 extending to an initial second depth of compression 1318 from the existing second major surface 1115 and an initial second depth of layer of one or more alkali metal ions (e.g., potassium) associated with the initial second compressive stress region 1314. In further aspects, a maximum initial first compressive stress of the initial first compressive stress region 1312 and/or a maximum initial second compressive stress of the initial second compressive stress region 1314 can be within one or more of the ranges discussed above for the maximum first compressive stress.

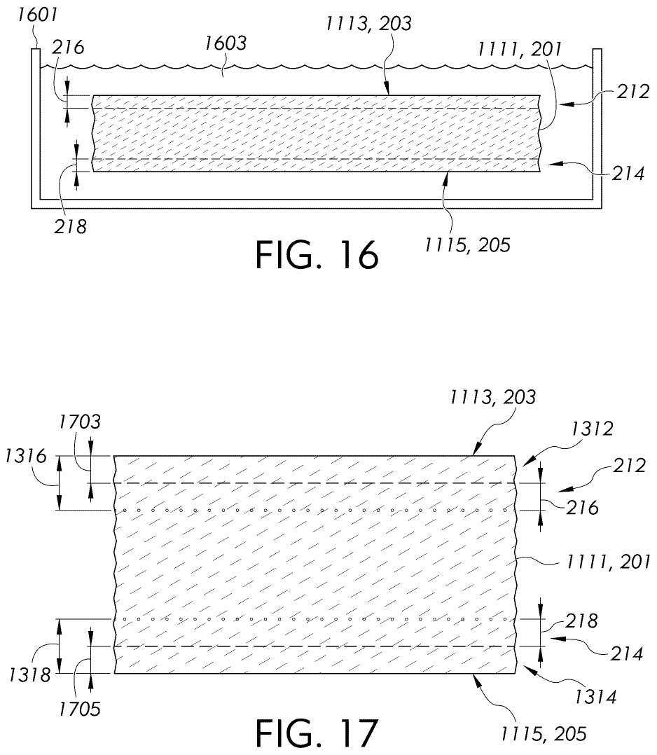

After step 1005, 1007, or 1009, as shown in FIGS. 16-17, methods can proceed to step 1011 comprising contacting at least the existing first major surface 1113 with an etchant (e.g., acidic solution 1603) maintained at a second temperature for a second period of time to remove an outer layer (e.g., outer compressive layer extending to a first outer depth 1703 of the initial first compressive stress region 1312 shown in FIG. 17) to form a new first major surface (e.g., first major surface 203) and the first compressive stress region 212. In aspect, as shown, the existing second major surface 1115 can also be contacted with the etchant (e.g., acidic solution 1603) to remove an outer layer (e.g., outer compressive layer extending to a second outer depth 1705 of the initial second compressive stress region 1314 shown in FIG. 17) to form a new second major surface (e.g., second major surface 205) and the second compressive stress region 214. In aspects, as shown in FIG. 16, the etchant (e.g., acidic solution 1603) can be contained in a bath 1601 and the foldable substrate 1111 can be immersed in the etchant (e.g., acidic solution 1603), although the etchant can contact the foldable substrate (e.g., existing first major surface 1113) in other situations in other aspects. In further aspects, as shown in FIG. 17, the first outer depth 1703 and/or second outer depth 1705 of the outer layer removed by the etchant (e.g., acidic solution 1603—see FIG. 16) can be 3.5 μm or less, 3.0 μm or less, 2.5 μm or less, 2.0 μm or less, 1.5 μm or less, 1.0 μm or less, 0.8 μm or less, 0.1 μm or more, 0.3 μm or more, 0.5 μm or more, 0.8 μm or more, 1.0 μm or more, or 1.5 μm or more. In further aspects, as shown in FIG. 17, the first outer depth 1703 and/or second outer depth 1705 of the outer layer removed by the etchant (e.g., acidic solution 1603—see FIG. 16) can be in a range from 0.1 μm to 3.5 μm, from 0.3 μm to 3.0 μm, from 0.5 μm to 2.5 μm, from 0.8 μm to 2.0 μm, from 1.0 μm to 1.5 μm, or any range or subrange therebetween. Consequently, as shown in FIG. 17, the first outer depth 1703 and/or second outer depth 1705 is less than the initial first depth of compression 1316 and/or the initial second depth of compression 1318, respectively, and the foldable substrate 201 after contact with the etchant (e.g., acidic solution 1603—see FIG. 16) can comprise the first compressive stress region 212 and/or the second compressive stress region 214 with reduced compressive stress relative to the corresponding initial compressive region. In further aspects, an amount of compressive stress reduction (i.e., removed by the acidic solution) as a percentage of the maximum initial first compressive stress and/or maximum initial second compressive stress can be 10% or more, 12% or more, 15% or more, 17% or more, 20% or more, 22% or more, 25% or less, 22% or less, 20% or less, 17% or less, or 15% or less. In further aspects, an amount of compressive stress reduction (i.e., removed by the acidic solution) as a percentage of the maximum initial first compressive stress and/or maximum initial second compressive stress can be in a range from 10% to 25%, from 12% to 22%, from 15% to 20%, from 17% to 20%, or any range or subrange therebetween. In further aspects, the resulting compressive stress regions can comprise a respective maximum compressive stress within one or more of the ranges discussed above with reference to the maximum first compressive stress.

An etching rate (i.e., rate of material removed from each surface—existing major surfaces—of the foldable substrate) of the etchant can be adjusted based on the second temperature, the contents of the etchant including the selection of components, concentration of components, and resulting pH of the etchant. In aspects, an etching rate of the etchant can be 1.0 μm per minute (μm/min) or less (e.g., 1.0 μm/min or less), 0.9 μm/min or less, 0.8 μm/min or less, 0.7 μm/min or less, 0.60 μm/min or less, 0.57 μm/min, 0.55 μm/min or less, 0.50 μm/min or less, 0.1 μm/min or more, 0.2 μm/min or more, 0.3 μm/min or more, 0.4 μm/min or more, 0.5 μm/min or more, 0.52 μm/min or more, or 0.54 μm/min. In aspects, an etching rate of the etchant can be in a range from 0.1 μm/min to 1.0 μm/min, from 0.2 μm/min to 0.9 μm/min, from 0.3 μm/min to 0.8 μm/min, from 0.4 μm/min to 0.7 μm/min, from 0.5 μm/min to 0.60 μm/min, from 0.52 μm/min to 0.57 μm/min, from 0.54 μm/min to 0.55 μm/min, or any range or subrange therebetween. Providing an etching rate of 1.0 μm/min or less can facilitate a substantially uniform removal of material from the surface(s) of the foldable substrate. As discussed above, foldable substrates with a thickness of 50 μm or less (e.g., from 10 μm to 50 μm or from 10 μm to 30 μm) are quite sensitive to differences in compressive stress and thickness variation across its surface. Consequently, providing an etching rate of 1.0 μm/min can remove a relatively uniform thickness and portion of the compressive stress from the surface(s) to reduce an incidence of waviness and/or warp that can produce optical distortions that can be visible to a user of a consumer electronic product that the foldable substrate may be incorporated in.

In aspects, the etchant can be the acidic solution 1603. In further aspects, the second temperature of the acidic solution 1603 can be 20° C. or more, 22° C. or more, 25° C. or more 28° C. or more, 30° C. or more, 40° C. or less, 35° C. or less, 30° C. or less, 28° C. or less, 25° C. or less, or 23° C. or less. In further aspects, the second temperature of the acidic solution 1603 can range from 20° C. to 40° C., from 20° C. to 35° C., from 20° C. to 30° C., from 20° C. to 28° C., from 20° C. to 25° C., from 22° C. to 23° C., or any range or subrange therebetween. Without wishing to be bound by theory, providing a relatively low temperature of the acidic solution (e.g., from 20° C. to 40° C. or from 20° C. to 25° C.) can decrease the concentration of SiF₆ anions since the reaction from H₂SiF₆ and 2H⁺+SiF₆⁻ is endothermic. Decreasing a concentration of SiF₆⁻ anions can be associated with decreased deposition (e.g., redeposition) of silica or silica-like materials on the surface that could otherwise produce variation in the thickness and/or compressive stress across the surface of the foldable substrate. In further aspects, the second period of time that the foldable substrate 201 or 1111 (e.g., existing first major surface 1113 or first major surface 203) is in contact with the acidic solution 1603 can be 20 seconds or more, 30 seconds or more, 45 seconds or more, 60 seconds or more, 75 seconds or more, 90 seconds or more, 120 seconds or more, 3.5 minutes or less, 3 minutes or less, 2.5 minutes or less, 2 minutes or less, 1.5 minutes or less, or 1.0 minute or less. In further aspects, the second period of time can be in a range from 20 seconds to 3.5 minutes, from 30 seconds to 3 minutes, from 45 seconds to 2.5 minutes, from 60 seconds to 2 minutes, from 75 seconds to 1.5 minutes, or any range or subrange therebetween. In further aspects, the acidic solution 1503 can be agitated (e.g., stirred, ultrasonicated) during the second period of time. Without wishing to be bound by theory, agitating the acidic solution can decrease a supersaturation of silica-like compounds near the surface.

As discussed above, a pH of a solution is measured in accordance with ASTM E70-90 at 25° C. In aspects, a pH of the acidic solution 1603 can be 3.5 or more, 3.55 or more, 3.6 or more, 3.65 or more, 3.7 or more, 3.75 or more, 3.8 or more, 4.5 or less, 4.3 or less, 4.0 or less, 3.9 or less, 3.8 or less, or 3.7 or less, although other pH values for the acidic solution (e.g., lower pHs—from 0 to 3.5, from 0.5 to 3.0, from 1.0 to 2.5, from 1.5 to 2.0, or any range or subrange therebetween) can be used in other aspects. In aspects, a pH of the acidic solution 1603 can be in a range from 3.5 to 4.5, from 3.55 to 4.3, from 3.6 to 4.0, from 3.65 to 3.9, from 3.7 to 3.8, from 3.75 to 3.8, or any range or subrange therebetween. Providing a relatively high pH (e.g., from 3.5 to 4.5, from 3.7 to 4.0) can decrease an etching rate that can help produce a relatively uniform compressive stress and thickness across the foldable substrate.

In aspects, the acidic solution can comprise a buffered HF solution and/or an aqueous acidic solution. As used herein, buffered HF means that the solution contains NH₄F or a similar compound that produces F-anions in the acidic solution. In aspects, the acidic solution can comprise HF, as a wt % of the acidic solution, in an amount of 0.5 wt % or more, 0.55 wt % or more, 0.6 wt % or more, 1.5 wt % or less, 1.25 wt % or less, 1.0 wt % or less, 0.75 wt % or less, 0.7 wt % or less, or 0.65 wt % or less. In aspects, the acidic solution can comprise HF, as a wt % of the acidic solution, in an amount from 0.5 wt % to 1.5 wt %, from 0.5 wt % to 1.25 wt %, from 0.5 wt % to 1.0 wt %, from 0.5 wt % to 0.75 wt %, from 0.55 wt % to 0.70 wt %, from 0.6 wt % to 0.65 wt %, or any range or subrange therebetween. In aspects, the acidic solution can contain NH₄F, as a wt % of the acidic solution, in an amount of 0.75 wt % or more, 0.8 wt % or more, 0.85 wt % or more, 0.9 wt % or more, 0.95 wt % or more, 1.0 wt % or more, 1.1 wt % or more, 2.5 wt % or less, 2.25 wt % or less, 2.0 wt % or less, 1.75 wt % or less, 1.5 wt % or less, 1.3 wt % or less, 1.2 wt % or less, 1.1 wt % or less, or 1.0 wt % or less. Providing a combined concentration of HF and NH₄F of 4.0 wt % or less, 3.5 wt % or less, 3.0 wt % or less, 2.5 wt % or less, or 2.0 wt % (e.g., from 1.25 wt % to 4.0 wt %, from 1.3 wt % to 3.5 wt %, from 1.35 wt % to 3.0 wt %, from 1.4 wt % to 2.5 wt %, from 1.5 wt % to 2.0 wt %) can provide relatively controlled and even etching of the foldable substrate and/or reduce deposition of material (e.g., silica, silica-like material, ammonium fluoride crystals) on the foldable substrate that could impair the optical properties of the foldable substrate.

Alternatively, in aspects, the etchant can comprise an alkaline solution. In further aspects, the alkaline solution can comprise a pH within one or more of the ranges discussed herein for the alkaline detergent solution. In further aspects, the alkaline solution can comprise an alkaline metal hydroxide (e.g., NaOH, KOH). In further aspects, the second temperature of the etchant can be 80° C. or more, 90° C. or more, 100° C. or more, 110° C. or more, 150° C. or less, 130° C. or less, 120° C. or less, 110° C. or less, or 100° C. or less (e.g., from 80° C. to 150° C., from 90° C. to 130° C., from 100° C. to 120° C., or any range or subrange therebetween). In aspects, the second period of time can be 1 minute or more, 5 minutes or more, 10 minutes or more, 15 minutes or more, 20 minutes or more, 30 minutes or more, 2 hours or less, 1.5 hours or less, 1 hour or less, 45 minutes or less, 30 minutes or less, or 20 minutes or less (e.g., from 1 minute to 2 hours, from 5 minutes to 1.5 hours, from 10 minutes to 1 hour, from 15 minutes to 45 minutes, from 20 minutes to 30 minutes, or any range or subrange therebetween).

In aspects, after step 1011, methods can further proceed to step 1013 comprises rinsing the foldable substrate with water, an alkaline detergent solution, or combinations thereof. For example, with reference to FIG. 13, step 1013 can comprise rinsing the foldable substrate (e.g., foldable substrate 201 here instead of foldable substrate 1111 in FIG. 13) with a solution 1303 (e.g., alkaline detergent solution, water) that can be contained in a bath 1301. In further aspects, step 1013 can comprise rinsing with water followed by rinsing with an alkaline detergent solution, the reverse order, or multiple rinses involving water and/or an alkaline detergent solution. In further aspects, step 1013 can comprise any one or more of the aspects discussed above with reference to step 1009. For example, providing an alkaline detergent solution in step 1013 can neutralize residual etchant from step 1011, which can prevent surface defects and/or produce a more uniform thickness of the foldable substrate. Providing the alkaline detergent solution in step 1013 can neutralize and/or remove hydrogen (e.g., hydronium) enrichment at the surface of the foldable substrate, which might otherwise lead to large flaws as a result of stress corrosion during the subsequent chemical strengthening. Providing the alkaline detergent solution may selectively act on surface flaws (e.g., removing, rounding, blunting) before removing material from other parts of the surface, which can increase the impact resistance of the substrate without removing a substantial thickness from the surface of the foldable substrate.

In aspects, after step 1009, 1011, or 1013, methods can proceed to step 1015 comprising assembling a foldable apparatus from the foldable substrate. In further aspects, step 1015 can comprise disposing the adhesive layer 311 or a polymer-based portion over the foldable substrate 201 (e.g., first major surface 203). In further aspects, step 1015 can further comprise disposing a layer (e.g., display device, another substrate, PET sheet 321) over the adhesive layer 311 (see FIG. 3) or the polymer-based portion disposed earlier in step 1015. In further aspects, step 1015 can further comprise disposing a release liner over the adhesive layer 311 (see FIG. 3) or the polymer-based portion disposed earlier in step 1015. In aspects, step 1015 can comprise disposing a coating over the foldable substrate (e.g., second major surface).

After steps 1009, 1011, 1013, and/or 1015, the method can be complete at step 1017. In aspects, step 1017 can comprise further assembling the foldable apparatus, for example, by disposing a coating opposite a release liner or display device, or by disposing a release liner or display device opposite a coating. At the end of step 1009, 1011, 1013, and/or 1015, the foldable substrate 201 can be similar to or identical to the foldable substrate 201 shown in FIGS. 2-3. In aspects, methods can proceed along the steps discussed above, for example, sequentially through steps 1001, 1003, 1005, 1007, 1009, 1011, 1013, 1015, and 1017. In aspects, methods can follow arrow 1004 from step 1005 to step 1009, for example, if the chemically-strengthened foldable substrate is rinsed in step 1009 without placing the foldable substrate in a cooling chamber with a controlled temperature profile. In aspects, methods can follow arrow 1006 from step 1005 to step 1011, for example, if the foldable substrate is to go directly from being chemically-strengthened in step 1015 to being etched by the acidic solution (e.g., without rinsing and/or being placed in a cooling chamber with a controlled temperature profile). In aspects, methods can follow arrow 1008 from step 1007 to step 1011, for example, to if the foldable substrate is to be transferred from the cooling chamber to the acidic solution (e.g., without rinsing the foldable substrate therebetween). In aspects, methods can follow arrow 1010 from step 1011 to step 1017, for example, if methods are complete at the end of step 1011. In aspects, methods can follow arrow 1012 from step 1011 to step 1015, for example, if the foldable substrate is to be assembled as part of a foldable substrate after the etching with the acidic solution (e.g., without rinsing therebetween). In aspects, methods can follow arrow 1014 from step 1013 to step 1017, for example, if methods are complete at the end of step 1013. In aspects, methods can follow arrow 1016 from step 1009 to step 1017, for example, if methods are complete at the end of step 1009. Any of the above options may be combined to make a chemically-strengthened foldable substrate and/or foldable apparatus in accordance with aspects of the disclosure.

In aspects, methods in accordance with aspects of the disclosure may consist of the steps discussed above. For example, the foldable substrate may not be further treated between one or more (or even all of) the steps described above with reference to the flow chart in FIG. 10. Throughout the disclosure, the phrase “not further treated” or “not be further treated” excludes treatments to the first major surface other than the stated contacting with a solution and rinsing with water (e.g., purified, filtered, deionized, distilled). Exemplary aspects of treatments that can be excluded under “not further treated” or “not be further treated” include treatment with additional acidic solutions, basic solutions, fluorine-containing solutions, detergents, and mechanical polishing of the foldable substrate.

### Examples

Various aspects will be further clarified by the following examples with reference to FIGS. 18-41. Examples herein use glass substrates having: Composition C0 (nominally, in mol % of: 68.9 SiO₂; 10.3 mol % Al₂O₃; 5.4 mol % MgO; 0.1 mol % CaO; 15.2 Na₂O; and 0.1 mol % SnO₂), Composition C1 (nominally, in mol % of: 69.1 SiO₂; 10.1 mol % Al₂O₃; 4.8 mol % MgO; 0.5 mol % CaO; 15.4 Na₂O; and 0.1 mol % SnO₂), or Composition C2 (nominally, in mol % of: 65.1 SiO₂; 14.0 mol % Al₂O₃; 3.4 mol % MgO; 1.0 mol % CaO; 16.4 Na₂O; and 0.1 mol % SnO₂), as indicated below. Properties of Compositions 0-2 are presented in Table 1. Notably, the annealing point temperatures ranged from 627° C. (C1) to 668° C. 2) with composition C0 having an annealing point temperature of 652° C. As discussed above, the annealing point temperature is determined using the fiber elongation method of ASTM C336-71 (2015). Likewise, the strain point temperature and softening point temperature were determined using the fiber elongation method of ASTM C336-71 (2015). As used herein the term “softening point” refers to the temperature at which the viscosity of a glass is approximately 10^{7.6} poise (P), the term “anneal point” refers to the temperature at which the viscosity of a glass is approximately 10^{13.2} poise. The linear coefficient of thermal expansion (CTE) over the temperature range 0-300° C. is expressed in terms of ppm/K and was determined using a push-rod dilatometer in accordance with ASTM E228-11. The density was determined using the buoyancy method of ASTM C693-93 (2013).

TABLE 1
Properties of Compositions C0-C2

| Composition | C0 | C1 | C2 |
|---|---|---|---|
| Density (g/cm³) | 2.432 | 2.40 | 2.458 |
| CTE (10⁻⁷ 1/° C.) | 8.14 | 8.34 | 8.64 |
| Strain Point | 599 | 576 | 614 |
| Temperature (° C.) | | | |
| Annealing Point | 652 | 627 | 668 |
| Temperature (° C.) | | | |
| Softening Point | 895 | 871 | 920 |
| Temperature (° C.) | | | |

Generally, the substrate thickness was 30 μm, 75 μm, or 100 μm, as indicated below. Examples discussed herein differ in the heat treatment (if any) after being formed and before being chemically strengthened. Example AA did not have any heat treatment. Examples 1-4 were heat treated at 600° C. for 10 minutes, 20 minutes, 30 minutes, and 60 minutes, respectively. Examples 5 and 10 were heat treated in a non-strengthening molten salt solution (a mixture of NaNO₃ and Na₂SO₄) at 530° C. for 0.5 hours and at 600° C. for various periods of time, respectively. In contrast, Example 6 was heat treated in air at 530° C. for 0.5 hours. Unless otherwise indicated, heat treatments occurred in air. Examples 7-9 were heat treated for 0.5 hours at 575° C., 650° C., or 610° C., respectively. The heating treatments are summarized in Table 2. Chemical strengthening treatments K1-K3 corresponded to the glass substrate being immersed in a molten salt solution comprising: (K1) 100 wt % KNO₃ maintained at 420° C. for 30 minutes; (K2) 100 wt % KNO₃ maintained at 380° C. for 69 minutes; and (K3) 2.5 wt % K₂CO₃+97.5 wt % KNO₃ maintained at 380° C. for 69 minutes; although for conditions K2-K3, the duration of the chemical strengthening was modified based on substrate thickness: 18 minutes for a substrate thickness of 30 μm; 69 minutes for a substrate thickness of 69 minutes; and 82 minutes for a substrate thickness of 100 μm.

TABLE 2
Heat Treatment Conditions of Examples 1-8

| Example | Environment | Temperature (° C.) | Time (min) |
|---|---|---|---|
| AA | n/a | n/a | n/a |
| 1 | Air | 600 | 10 |
| 2 | Air | 600 | 20 |
| 3 | Air | 600 | 30 |
| 4 | Air | 600 | 60 |
| 5 | NaNO₃ + Na₂SO₄ | 530 | 30 |
| 6 | Air | 530 | 30 |
| 7 | Air | 575 | 30 |
| 8 | Air | 650 | 30 |
| 9 | Air | 610 | 30 |
| 10 | NaNO₃ + Na₂SO₄ | 600 | See FIG. 24 |

FIG. 18 schematically illustrates a change in compressive stress (%—relative to no heat treatment—Example AA) following chemical strengthening (using treatment K1) on the vertical axis 1803 (i.e., y-axis) as a function of heating temperature (° C.) of the heat treatment along the horizontal axis 1801 (i.e., x-axis). For FIGS. 18-19, the glass samples comprised Composition C0 and had a substrate thickness of 75 μm. Curve 1805 corresponds to a heat treatment of 120 minutes at the corresponding temperature (horizontal axis—x-axis), and curve 1807 corresponds to a heat treatment of 30 minutes at the corresponding temperature (horizontal axis—x-axis). Point 1811 corresponds to heating composition C0 at essentially the annealing point temperature, which produces an increase in compressive stress of 12%. Curves 1805 and 1807 both show a decrease in compressive stress at trough 1817 and an increase at spike 1815—both of these features are unexpected.

As discussed above, it would have been expected that heat treatments below the annealing point temperature for short periods of time (e.g., less than or equal to 2 hours—especially for 30 minutes in curve 1807) would have essentially no effect on the compressive stress developed by subsequent ion-exchange. For example, as discussed herein with reference to FIG. 20, there is not a significant change in fictive temperature, which means that it would have been expected that the density of the glass substrate would be essentially unchanged. However, it has been discovered that heat treatments corresponding to the trough 1817 cause the glass to expand, which reduces the compressive stress developed by subsequent chemical strengthening, as discussed above.

Further, it is unexpected that the spike 1815 occurs for temperatures less than the annealing point temperature (e.g., point 1811; from greater than or equal to 150° C. less than the annealing point temperature to less than the annealing point temperature—corresponding to from greater than or equal to 500° C. to less than 650° C. in FIG. 18). For example, point 1813 is about 50° C. less than the annealing point temperature of composition C0 (e.g., less than the annealing point temperature by from greater than or equal to 100° C. to less than or equal to 10° C.; or less than the annealing point temperature by from greater than or equal to 75° C. to less than or equal to 25° C.), and both the 30 minutes and 120 minutes heat treatment produce an increase in compressive stress of more than 10%. As discussed above, one reason that this effect is unexpected is that it cannot be explained by changes in the fictive temperature (discussed below with reference to FIG. 20).

Moreover, it is unexpected that curves 1805 and 1807 have essentially the same difference in compressive stress (% relative to Example AA). As discussed herein, changes in fictive temperature are strongly dependent on the duration of heat treatments (less than 30*((the viscosity of the glass at the heat treatment temperature)/shear modulus)). Instead, FIG. 18 shows that the heat treatment is largely insensitive to the duration of the heat treatment. This indicates that comparable increases in compressive stress can be achieved by shorter duration heat treatments than would have otherwise been thought possible. For example, these results indicate that compressive stress increases comparable to that of an 8+ hour heat treatment can be achieved by a 30-minute heat treatment (16× less time). This represents a significant savings in energy costs (for maintaining the temperature during the heat treatment) and increased throughput (due to shorter heat treatments).

The time- and temperature dependence of the effect demonstrated in FIG. 18 is further discussed using the results presented in FIG. 19. FIG. 19 schematically illustrates a change in compressive stress (%) following chemical strengthening (using treatment K1) on the vertical axis 1903 (i.e., y-axis) as a function of time in minutes (min) of the heat treatment along the horizontal axis 1901 (i.e., x-axis). Curve 1911 corresponds to heat treatment at 350° C. and curve 1913 corresponds to heat treatment at 500° C. Curves 1911 and 1913 correspond to decreases in compressive stress—corresponding to the trough 1817 see in FIG. 18. Curve 1915 corresponds to heat treatment at 550° C., curve 1917 corresponds to heat treatment at 575° C., and curve 1919 corresponds to heat treatment at 650° C. (corresponding to essentially the annealing point temperature of composition C0). Curves 1915, 1917, and 1919 demonstrate increases in compressive stress greater than or equal to 5% over a wide range of temperatures—region 1923 (i.e., greater than or equal to 30 min). Further, curves 1917 and 1919 demonstrate increases in compressive stress greater than or equal to 10% for region 1923 (i.e., greater than or equal to 30 minutes). As discussed above, this level of compressive stress increase is unexpected. Also, the time-insensitivity is unexpected (e.g., see curves 1917 and 1919). Indeed, significant increases in compressive stress (e.g., greater than or equal to 5% increase in compressive stress) are seen even for a heat treatment of 1 minute (points 1921). Once again, the ability of extremely short heat treatments (and such heat treatments at temperatures less than the annealing point temperature) are unexpected—and beneficial in terms of both energy cost and process throughput while achieving compressive stress increases comparable to annealing at the annealing point temperature for long period of time (e.g., 8+ hours).

FIG. 20 schematically illustrates a change in compressive stress (ΔCS) (%—relative to Example AA) following chemical strengthening on the vertical axis 2003 (i.e., y-axis) as a function of fictive temperature (Tf) in ° C. after the heat treatment on the horizontal axis 2001 (i.e., x-axis) for samples having composition C1 and a substrate thickness of 100 μm. The measured fictive temperatures are also reported in Table 3 for the various heat treatments. As shown, point 2005 (Example AA) had a heat treatment of 700° C. and is the point of reference for the change in compressive stress. The other points 2007 shown in FIG. 20 all have compressive stress increases greater than 10% over a range of fictive temperatures (e.g., from 600° C. to 670° C., from 620° C. to 665° C.). For composition C1, 650° C. is above the annealing temperature (627° C.) and the heat treatments at 650° C. (Examples 8 and 12—last two rows in Table 3) show that the fictive temperature has dropped all the way to the annealing point temperature. In contrast, the heat treatments at 575° C. (about 50° C. below the annealing point temperature of composition C1) have higher fictive temperatures than Example 8. Specifically, Example 7 (575° C., 30 min) produces a fictive temperature of 665° C. while the long 2 hour heat treatment (Example 11—at 575° C.) drops the fictive temperature an additional 20° C. Based on the fictive temperatures alone, it would been expected that Example 12 would have the greatest compressive stress increase and that this compressive stress increase would fall off exponentially as the fictive temperature increased (e.g., from the annealing point temperature to the fictive temperature of Example AA). Unexpectedly, instead, the compressive stress increase is essentially uniform across points 2007.

TABLE 3
Fictive Temperature

| | Fictive Temperature |
|---|---|
| Example/Heat Treatment | (Tf) (° C.) |
| AA (n/a) | 700 |
| 7 (575° C., 30 min) | 665 |
| 11 (575° C., 2 hours) | 645 |
| 8 (650° C., 30 min) | 627 |
| 12 (650° C., 2 hours) | 620 |

FIG. 21 schematically illustrates a change in compressive stress (%—relative to Example AA) following chemical strengthening on the vertical axis 2103 (i.e., y-axis) due to the heat treatment of Example 9 for glasses of composition C1 and C2 followed by condition K3. The points correspond for each composition correspond to thicknesses of 30 μm, 75 μm, and 100 μm. For composition C1 (points 2105), the 30 μm and 75 μm thick samples had an increase in compressive stress of 16% while the 100 μm thick sample had an increase in compressive of 13%. For composition C2 (points 2107), the 30 μm thick sample had an increase in compressive stress of 8%, and the 100 μm thick sample had an increase in compressive stress of 13%. This demonstrates that significant increases in compressive stress (e.g., greater than or equal to 5% increase in compressive stress) can be achieved across multiple compositions and thicknesses (e.g., at least from 30 μm to 100 μm).

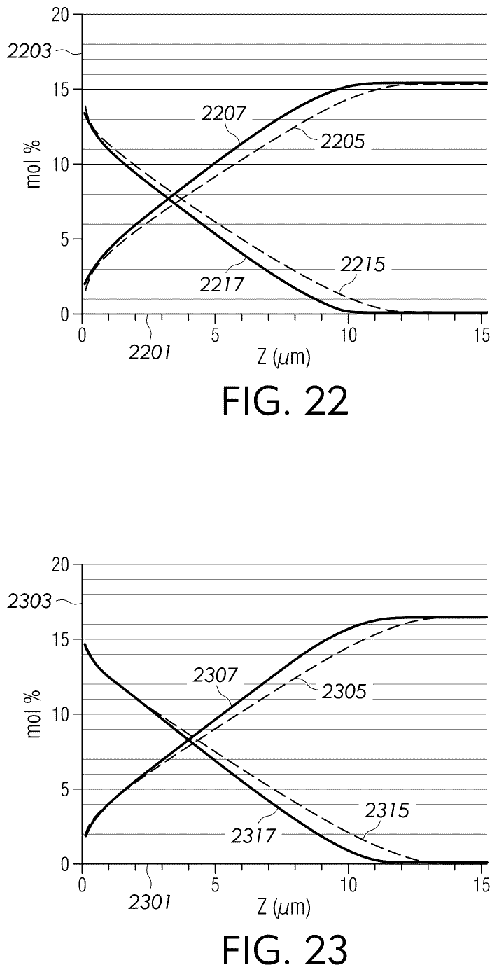

FIG. 22 schematically illustrates a concentration profile in mol % of an alkali metal oxide on the vertical axis 2203 (i.e., y-axis) as a function of depth in micrometers (μm) from the first major surface of glass substrates on the horizontal axis 2201 (i.e., x-axis) for Examples AA and 7 having a composition C1 that were chemically strengthened with condition K3. Curves 2205 and 2207 correspond to concentration profiles of Na₂O, and curves 2215 and 2217 correspond to concentration profiles of K₂O. Curves 2205 and 2215 corresponds to concentration profiles of Example AA chemically strengthened with condition K. Curves 2207 and 2217 corresponds to concentration profiles of Example 7 chemically strengthened with condition AA. As shown, Example 7 has a shallower depth of layer of K₂O (e.g., 10 μm versus 12 μm) despite having the same surface concentration of K₂O (about 14 mol %) with corresponding changes in the Na₂O concentration profile. This shows that less potassium is ion-exchanged for Example 7 (relative to Example AA) and the ion-exchange goes to a shallower depth from the first major surface. These results are consistent with a densified sample (from Example 7 relative to Example AA) since a tighter network would inhibit ion diffusion (and thus ion-exchange) while each potassium ion exchanged into the densified sample would produce larger compressive stress due to the tighter network; however, as discussed above with reference to FIG. 21, it would not have been expected that the sample would be this densified based on the limited change in fictive temperature.

FIG. 23 schematically illustrates a concentration profile in mol of an alkali metal oxide on the vertical axis 2303 (i.e., y-axis) as a function of depth in micrometers (μm) from the first major surface of glass substrates on the horizontal axis 2301 (i.e., x-axis) for Examples AA and 8 having a composition C2 that were chemically strengthened with condition K3. Curves 2305 and 2307 correspond to concentration profiles of Na₂O, and curves 2315 and 2317 correspond to concentration profiles of K₂O. Curves 2305 and 2315 corresponds to concentration profiles of Example AA chemically strengthened with condition K. Curves 2307 and 2317 corresponds to concentration profiles of Example 8 chemically strengthened with condition AA. As shown, Example 8 has a shallower depth of layer of K₂O (e.g., 11 μm versus 13 μm) despite having the same surface concentration of K₂O (about 14 mol %) with corresponding changes in the Na₂O concentration profile. These trends for Example 8 relative to Example AA are consistent with the trend seen in FIG. 22 for Example 7 relative to Example AA. Comparing Example 7 (e.g., curve 2217) with Example 8 (e.g., curve 2317), the higher annealing temperature of Example 8 produced a deeper depth of layer (11 μm>10 μm) than Example 7. This difference in depth of layer is unexpected because it would have expected that Example 8 (having a lower fictive temperature due to the higher temperature heat treatment) would be more densified than Example 7, which would limit the rate and extent of ion exchange, as discussed above; however, the opposite appears to have occurred here.

FIG. 24 schematically illustrates a ratio of compressive stress (CS in MPa) to Young's modulus (E in GPa)—CS/E—of glass substrates on the vertical axis 2403 (i.e., y-axis) as a function of heating time (t) in hours (h) of the heat treatment of Example 10 on the horizontal axis 2401 (i.e., x-axis). Curve 2405 corresponds to a composition similar to composition C2 while curves 2407 and 2409 correspond to other compositions. For FIG. 24, the glass substrates had a thickness of 0.8 mm and were chemically strengthened at 410° C. in 100 wt % KNO₃. Similar to Example 5, Example 10 uses a mixture of NaNO₃ and Na₂SO₄ for the heat treatment. Since these example glass compositions are free of alkali metals other than sodium, this sodium molten salt solution is non-strengthening, as discussed above. Curves 2405, 2407, and 2409 show increasing CS/E (MPa/GPa) as the length of the heat treatment increased. Indeed, all of the samples (with heat treatments from 1 minute to 8 hours) shown in FIG. 24 achieved a CS/E (MPa/GPa) ratio greater than 17.0. As discussed above, increasing the CE/E (MPa/GPa) ratio is associated with improved foldability. Also, this demonstrates that a non-strengthening molten salt solution can be used (e.g., instead of air) for the heat treatment.

FIG. 25 schematically illustrates a survival rate (yield—Y) in percent (%) on the vertical axis 2503 (i.e., y-axis) as a function of parallel plate distance (PP) in millimeters (mm) on the horizontal axis 2501 (i.e., x-axis) for glass substrates having composition C2 and a substrate thickness of 30 μm for Examples AA and 3. 22 samples of each condition were prepared and analyzed to determine the survival rate (Y) based on what percentage of samples were able to reach the corresponding parallel plate distance, where the parallel plate distance was decreased until failure. Curve 2505 corresponds to Example AA while curve 2507 corresponds to Example 3. As shown, the survival rate for parallel plate distances shown is greater for Example 3 (curve 2507) than for Example AA (curve 2505) by at least 10%. For example, at parallel plate distance of 2.6 mm (0.086 (mm/μm) times the substrate thickness), the survival rate for Example 3 is about 80% (greater than a corresponding survival rate of Example AA by about 30%). Also, at a parallel plate distance of 2.4 mm (0.08 (mm/μm) times the substrate thickness), the survival rate of Example 4 is about 60% (greater than a corresponding survival rate of Example AA by more than 40% since Example AA's survival rate at this parallel plate distance is about 15%). Further, at a parallel plate distance of 2.0 mm (0.067 (mm/μm) times the substrate thickness), none of the samples for Example AA survived (0% survival rate) whereas Example 3 had a survival rate of about 25% at this parallel plate distance. Indeed, Example 3 had a survival rate greater than 20% down to at 1.6 mm (0.053 (mm/μm) times the substrate thickness). This demonstrates that the heat treatment before chemically strengthening the glass substrate in accordance with aspects of the present disclosure provides improved foldability and reliability of the resulting foldable substrates.

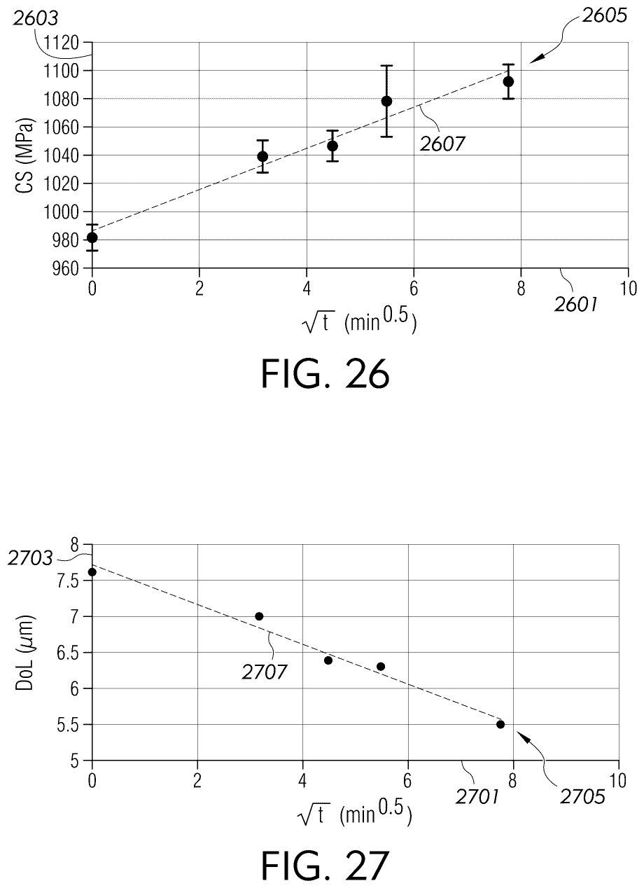

FIG. 26 schematically illustrates compressive stress (CS) in MegaPascals (MPa) of glass substrates on the vertical axis 2603 (i.e., y-axis) as a function of a square root of heating time (√t) in √minute (√min) on the horizontal axis 2601 (i.e., x-axis) for glass substrates of Composition 2 having a substrate thickness of 30 μm subjected to the heat treatment of Example 4 and chemically strengthened under condition K3. As shown, compressive stresses greater than or equal to 800 MPa (e.g., greater than or equal to 900 MPa, greater than or equal to 950 MPa) are obtained for all points shown with heat treatments greater than 1 minute (based on the linear fit or the point at 10 minutes) associated with compressive stresses greater than or equal to 1000 MPa. Indeed, the increase from 0 minutes to about 25 minutes (or more) is greater than 10% of the value for 0 minutes. For the points 2605 at short times (e.g., less than 1 hour) plotted here, there is a linear relationship between compressive stress and the square root of the heating time (fitted line 2607: CS=14.683 √t+985.95 with R²=0.9603). This relationship is consistent with the heat treatment impacting the diffusivity of alkali metal ions since diffusion is proportional to the square root of time, which is consistent with the heating changing the network structure of the glass—even though this would not be expected based on fictive temperature (as discussed above with reference to FIG. 21).

FIG. 27 schematically illustrates a depth of layer (DOL) in micrometers (μm) of glass substrates on the vertical axis 2703 (i.e., y-axis) as a function of a square root of heating time (√t) in √minute (√min) on the horizontal axis 2701 (i.e., x-axis) for glass substrates of Composition 2 having a substrate thickness of 30 μm subjected to the heat treatment of Example 4 and chemically strengthened under condition K3. Here, the points 2705 indicate that heat treatment decreases the DOL. Specifically, a linear relationship is present between the DOL and the square root of the heating time (fitted line 2707: DOL=−0.2715 √t+7.6928 with R²=0.9762). The depth of layer is proportional to the diffusion depth that is proportional to the square root of time. Consistent with FIG. 26 the linear relationship here suggests that the heat treatment changes the network structure of the glass-even though this would not be expected based on fictive temperature (as discussed above with reference to FIG. 21).

FIG. 28 schematically illustrates a failure load (F) in Newtons (N) in a Quasi-Static Puncture Test on the vertical axis 2803 (i.e., y-axis) as a function of heating time (t) in minutes (min) of the heat treatment on the horizontal axis 2801 (i.e., x-axis—not linearly scaled) for glass substrates of composition C2 having a substrate thickness of 30 μm using a tungsten carbide ball tip scribe having a diameter of 0.5 mm. As shown, increasing heat treatment time is associated with increasing failure loads. For example, the sample without a heat treatment (0 minutes) had a failure load of 5.84 N while the sample with a 60-minute heat treatment produced a failure load of 6.17 N.

FIG. 29 schematically illustrates a warp (W) in millimeters (mm) on the vertical axis 2903 (i.e., y-axis) for various example substrates in accordance with aspects of the present disclosure. The samples were chemically strengthened under condition K3 following the heat treatment. The substrate thickness, composition, and heat treatment are labeled in FIG. 29 for these samples. As shown, the sample subjected to the heat treatment at 575° C. for 0.5 hours (Example 7) had a warp less than 1 mm; also, the samples subjected to the heat treatment at 610° C. for 0.5 hours (Example 10) all had warps less than 1 mm. However, several of the samples subjected to the heat treatment at 650° C. for 0.5 hours (Example 9-around the annealing point temperature) had warps in excess of 1 mm. This demonstrates that heat treatments at temperatures less than the annealing point temperature (e.g., less than the annealing point temperature by more than 10° C.) can provide foldable substrates with reduced warp (than heat treatments at or closer to the annealing point temperature).

FIG. 30 schematically illustrates a warp (W) in millimeters (mm), warp skewness (Sk), warp kurtosis (ku) on the vertical axes 3003, 3013, and 3023 (i.e., y-axis), respectively, for substrates having composition C2 and a substrate thickness of 30 μm subjected to the heat treatment of Examples 1˜4 and AA followed by chemical strengthening under condition K3. Two points for each sample are reported since values were calculated separately for the first major surface and the second major surface. For reference, a Gaussian distribution would have a skewness of 0 and a kurtosis of 2. As shown in the bottom of FIG. 30, Examples 1-4 and AA all had warps less than 1 mm (e.g., less than or equal to 0.5 mm). As shown in the middle of FIG. 30, an absolute value of the skewness of Example AA is up to 2.0 whereas an absolute value of the skewness for Examples 1˜4 is less than or equal to about 1.5. As shown in the top of FIG. 30, Example AA has a kurtosis greater than or equal to 6 whereas Examples 1˜4 have a kurtosis less than 6 (see line 3025) and Examples 2-4 have a kurtosis less than 5 (e.g., from greater than or equal to 2 to less than or equal to 5). Overall, Examples 1˜4 have comparably low warp (as Example AA) as well as lower shape skewness and shape kurtosis than Example AA.

FIG. 31 schematically illustrates a maximum curvature (C) in diopters (D), curvature skewness (Sk), curvature kurtosis (ku) on the vertical axis 3103, 3113, and 3123 (i.e., y-axis) for substrates having composition C2 and a substrate thickness subjected to the heat treatment Examples 1˜4 and AA followed by chemical strengthening under condition K3. Two points for each sample are reported since values were calculated separately for the first major surface and the second major surface. As shown in the bottom of FIG. 30, Examples AA and 3 have a maximum curvature less than or equal to 1.0 D (see line 3105) while Examples 1-2 and 4 have at least 1 point with a maximum curvature of less than or equal to 1.0 D and another point with warp greater than or equal to 1.0 D. As shown in the middle of FIG. 31, Examples AA and 3 have a maximum curvature skewness between −1 and +1 (see lines 3115 and 3117, respectively) whereas Examples 1-2 and 4 have at least one point with an absolute value of the curvature skewness greater than 1. As shown in the top of FIG. 31, Example 3 has a kurtosis between 2 and 4 (see lines 3127 and 3125, respectively) whereas Examples AA, 1-2, and 4 have at least 1 point with a kurtosis greater than 4. Overall, Example 3 exhibits comparable curvature skewness to Example AA as well as lower maximum curvature and curvature kurtosis than Example AA. Taken together, FIGS. 30-31 demonstrate that Example 3 provides the best warp and curvature metrics (including maximum, skewness, and kurtosis) that is comparable or better than Example AA while Example 3 further provides increased compressive stress (and foldability) relative to Example AA.

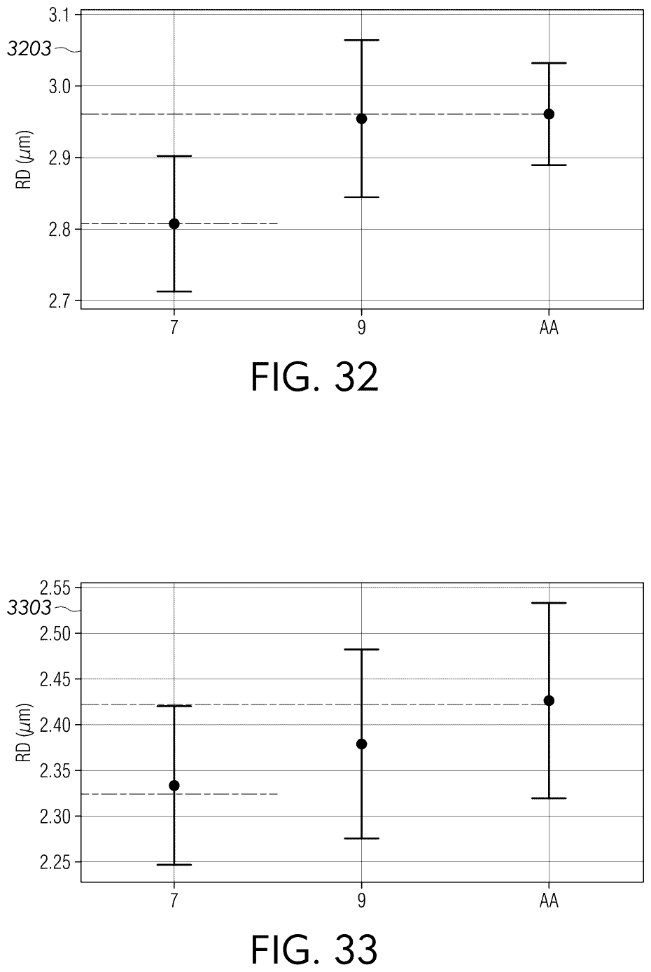

FIG. 32 schematically illustrates a thickness etched (removed dimension-RD) in micrometers (μm) on the vertical axis 3203 (i.e., y-axis) for Examples 7, 9, and AA etched in an aqueous solution of 2 wt % HF for 300 seconds for substrates of composition C1 having a substrate thickness of 75 μm. The total thickness removed is reported on the vertical axis 3203, where the etching rate can be calculated by dividing this amount by 5 (300 seconds=5 minutes). Example AA had a total removal of about 3.0 μm (2.96 μm), Example 8 (heating at about the annealing point temperature) had a total removal of 2.95 μm, and Example 7 (heating below the annealing point temperature) had a total removal of 2.80 μm. As noted, Example 7 had a removal (both total removal and etching rate) that was about 5% less than Examples AA and 9. Again, this is unexpected because both Examples 7 and AA having higher heating and no heating, respectively, had essentially the same etching rate but Example 8 had a lower etching rate. Providing a lower etching rate can enable a more uniform removal amount across the surface(s) of the foldable substrate, which can reduce warp and/or curvature associated with inconsistent stress profiles and/or cosmetic defects.

FIG. 33 schematically illustrates a thickness etched (removed dimension-RD) in micrometers (μm) (vertical axis—y-axis) for Examples 7, 9, and AA etched in a buffered HF solution for 300 seconds for substrates of composition C2 having a substrate thickness of 75 μm. The total thickness removed is reported on the vertical axis 3303, where the etching rate can be calculated by dividing this amount by 5 (300 seconds=5 minutes). Example AA had a total removal of 2.43 μm, Example 9 had a total removal of 2.38 μm, and Example 7 had a total removal of 2.33 μm. As shown, Example 7 had a removal (both total removal and etching rate) that was about 4% less than Example AA. This trend (for composition C2 here) is consistent with that observed for composition C1 in FIG. 32, although relative differences in the etching of Example 9 (compared to Example AA) may be due to differences in the etchant composition or between compositions C1 and C2.

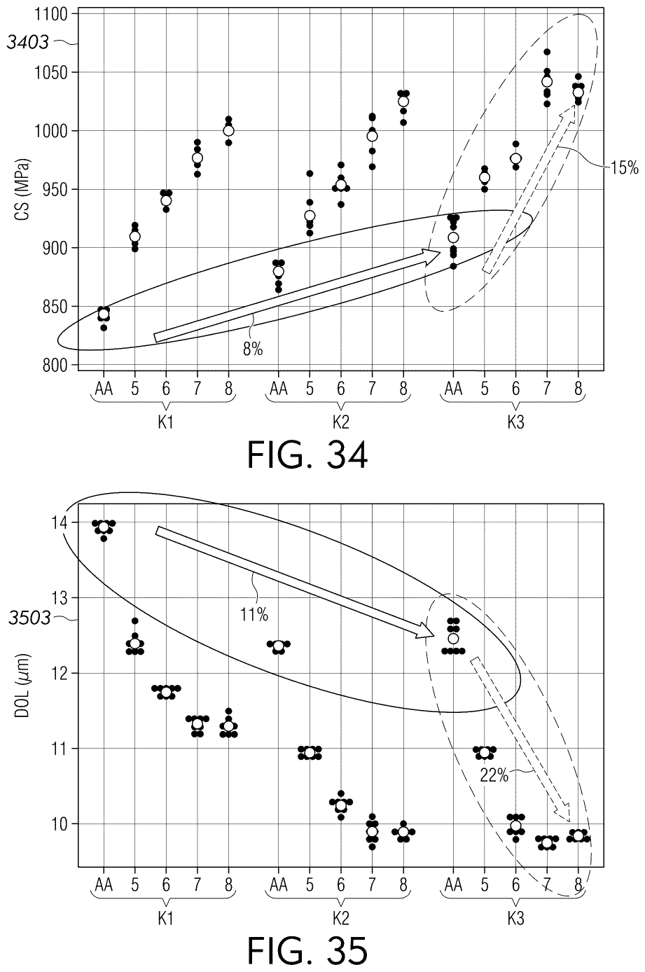

FIG. 34 schematically illustrates compressive stress (CS) in MegaPascals (MPa) on the vertical axis 3403 (i.e., y-axis) for substrates having composition C1 and a substrate thickness of 75 μm subjected to the heat treatments of Examples 5-8 and AA chemically strengthened under conditions K1-K3. As shown, the compressive stress within each chemical strengthening condition increases going from Example AA to Example 5 and sequentially through Examples 5-8; for example under condition K3, the increase in compressive stress from Example AA to Example 8 is about 15% (of the compressive stress of Example AA); this trend reflects the unexpected benefits discussed above with reference to FIGS. 18-21. For a given heat treatment condition, the compressive stress also increases going from condition K1 to condition K2 and further to condition K3. As shown, going from condition K1 to condition K3 (e.g., for Example AA) the compressive stress is increased by 8%. Further, as shown by the arrows in FIG. 34, the 15% increase in compressive stress (from Example AA to Example 8—both under condition K3) is additive (in addition) to the 8% increase in compressive stress (from condition K1 to condition K3-both for Example AA). Consequently, a total increase in compressive stress of about 24% (1.08×1.15) can be achieved by heating according to Example 8 and chemically strengthening under condition K3 (relative to Example AA under condition K1).

FIG. 35 schematically illustrates depth of layer (DOL) in micrometers (μm) on the vertical axis 3503 (i.e., y-axis) for substrates having composition C1 and a substrate thickness of 75 μm subjected to the heat treatments of Examples 5-8 and AA chemically strengthened under conditions K1-K3. As shown, the DOL within each chemical strengthening condition decreases going from Example AA to Example 5 and sequentially through Examples 5-8; for example under condition K3, the decrease in DOL from Example AA to Example 8 is about 22% (of the DOL of Example AA). For a given heat treatment condition, the DOL also decreases going from condition K1 to condition K2 and further to condition K3. As shown, going from condition K1 to condition K3 (e.g., for Example AA) the DOL decreases by 11%. Further, as shown by the arrows in FIG. 35, the 22% decrease in DOL (from Example AA to Example 8—both under condition K3) is additive (in addition) to the 11% decrease in DOL (from condition K1 to condition K3—both for Example AA). Consequently, a total decrease in DOL of about 31% (1−(1−0.11)*(1−0.22)) can be achieved by heating according to Example 8 and chemically strengthening under condition K3 (relative to Example AA under condition K1).

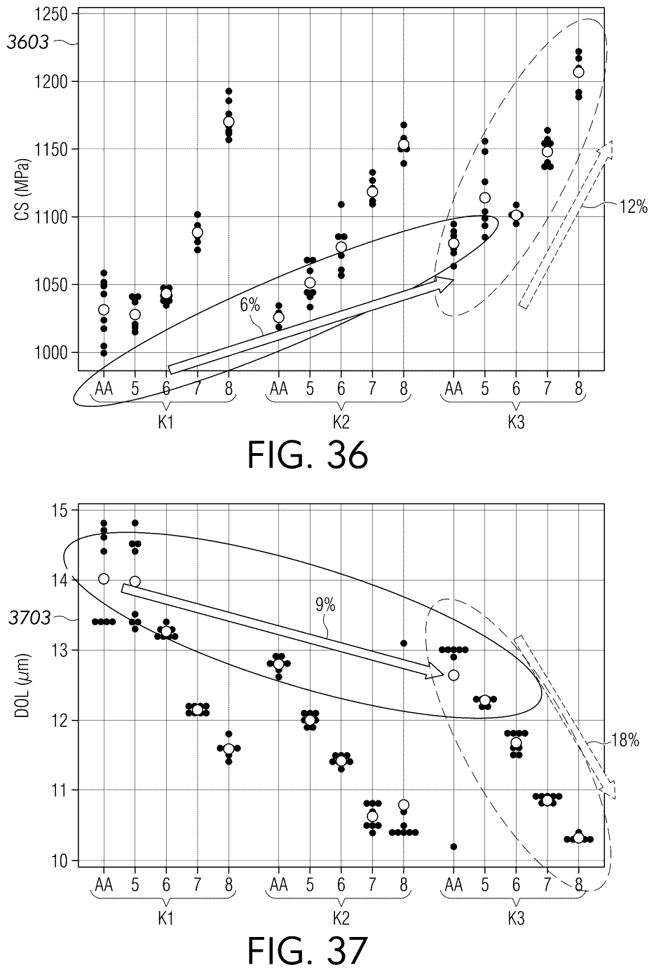

FIG. 36 schematically illustrates compressive stress (CS) in MegaPascals (MPa) on the vertical axis 3603 (i.e., y-axis) for substrates having composition C2 and a substrate thickness of 75 μm subjected to the heat treatments of Examples 5-8 and AA chemically strengthened under conditions K1-K3. As shown, the compressive stress within each chemical strengthening condition increases going from Example AA to Example 5 and sequentially through Examples 5-8; for example under condition K3, the increase in compressive stress from Example AA to Example 8 is about 12% (of the compressive stress of Example AA); this trend reflects the unexpected benefits discussed above with reference to FIGS. 18-21 and is consistent with the trend seen in FIG. 34. For a given heat treatment condition, the compressive stress also increases going from condition K1 to condition K2 and further to condition K3. As shown, going from condition K1 to condition K3 (e.g., for Example AA) the compressive stress is increased by 8%. Further, as shown by the arrows in FIG. 36, the 12% increase in compressive stress (from Example AA to Example 8—both under condition K3) is additive (in addition) to the 8% increase in compressive stress (from condition K1 to condition K3-both for Example AA). Consequently, a total increase in compressive stress of about 21% (1.08×1.12) can be achieved by heating according to Example 8 and chemically strengthening under condition K3 (relative to Example AA under condition K1).

FIG. 37 schematically illustrates depth of layer (DOL) in micrometers (μm) on the vertical axis 3703 (i.e., y-axis) for substrates having composition C2 and a substrate thickness of 75 μm subjected to the heat treatments of Examples 5-8 and AA chemically strengthened under conditions K1-K3. As shown, the DOL within each chemical strengthening condition decreases going from Example AA to Example 5 and sequentially through Examples 5-8; for example under condition K3, the decrease in DOL from Example AA to Example 8 is about 18% (of the DOL of Example AA). For a given heat treatment condition, the DOL also decreases going from condition K1 to condition K2 and further to condition K3. As shown, going from condition K1 to condition K3 (e.g., for Example AA) the DOL decreases by 9%. Further, as shown by the arrows in FIG. 37, the 18% decrease in DOL (from Example AA to Example 8—both under condition K3) is additive (in addition) to the 9% decrease in DOL (from condition K1 to condition K3-both for Example AA). Consequently, a total decrease in DOL of about 25% (1−(1−0.09)*(1−0.18)) can be achieved by heating according to Example 8 and chemically strengthening under condition K3 (relative to Example AA under condition K1).

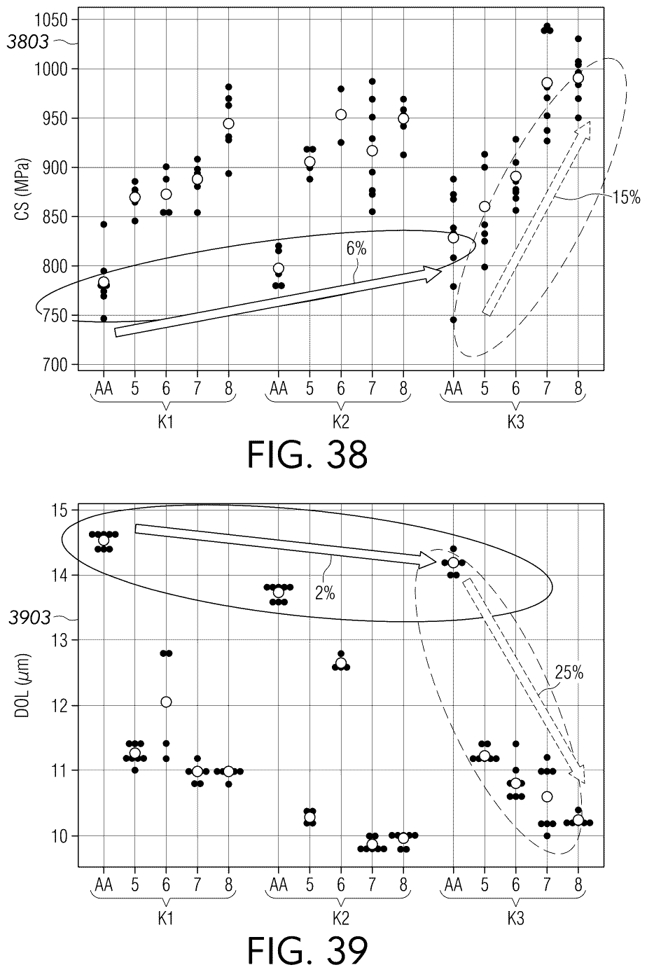

FIG. 38 schematically illustrates compressive stress (CS) in MegaPascals (MPa) on the vertical axis 3803 (i.e., y-axis) for substrates having composition C1 and a substrate thickness of 30 μm subjected to the heat treatments of Examples 5-8 and AA chemically strengthened under conditions K1-K3. As shown, the compressive stress within each chemical strengthening condition increases going from Example AA to Example 5 and sequentially through Examples 5-8; for example under condition K3, the increase in compressive stress from Example AA to Example 8 is about 15% (of the compressive stress of Example AA); this trend reflects the unexpected benefits discussed above with reference to FIGS. 18-21 and is consistent with the trends in FIGS. 34 and 36. For a given heat treatment condition, the compressive stress also increases going from condition K1 to condition K2 and further to condition K3. As shown, going from condition K1 to condition K3 (e.g., for Example AA) the compressive stress is increased by 6%. Further, as shown by the arrows in FIG. 38, the 15% increase in compressive stress (from Example AA to Example 8—both under condition K3) is additive (in addition) to the 6% increase in compressive stress (from condition K1 to condition K3-both for Example AA). Consequently, a total increase in compressive stress of about 22% (1.06×1.15) can be achieved by heating according to Example 8 and chemically strengthening under condition K3 (relative to Example AA under condition K1).

FIG. 39 schematically illustrates depth of layer (DOL) in micrometers (μm) on the vertical axis 3903 (i.e., y-axis) for substrates having composition C1 and a substrate thickness of 30 μm subjected to the heat treatments of Examples 5-8 and AA chemically strengthened under conditions K1-K3. As shown, the DOL within each chemical strengthening condition decreases going from Example AA to Example 5 and sequentially through Examples 5-8; for example under condition K3, the decrease in DOL from Example AA to Example 8 is about 25% (of the DOL of Example AA). For a given heat treatment condition, the DOL also decreases going from condition K1 to condition K2 and further to condition K3. As shown, going from condition K1 to condition K3 (e.g., for Example AA) the DOL decreases by 2%. Further, as shown by the arrows in FIG. 39, the 25% decrease in DOL (from Example AA to Example 8—both under condition K3) is additive (in addition) to the 2% decrease in DOL (from condition K1 to condition K3-both for Example AA). Consequently, a total decrease in DOL of about 27% (1−(1−0.02)*(1−0.25)) can be achieved by heating according to Example 8 and chemically strengthening under condition K3 (relative to Example AA under condition K1).

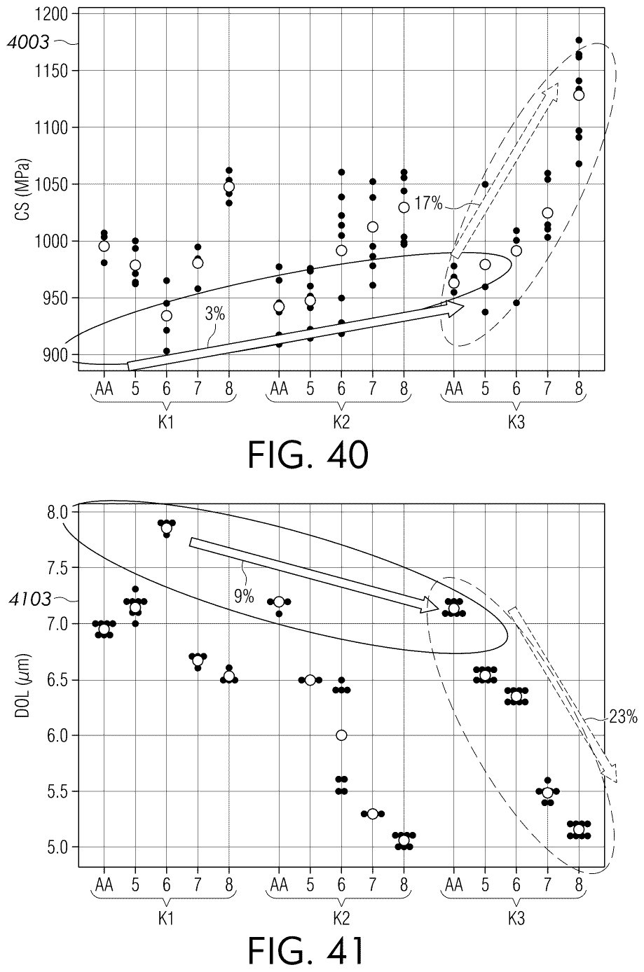

FIG. 40 schematically illustrates compressive stress (CS) in MegaPascals (MPa) on the vertical axis 4003 (i.e., y-axis) for substrates having composition C2 and a substrate thickness of 30 μm subjected to the heat treatments of Examples 5-8 and AA chemically strengthened under conditions K1-K3. As shown, the compressive stress within each chemical strengthening condition increases going from Example AA to Example 5 and sequentially through Examples 5-8; for example under condition K3, the increase in compressive stress from Example AA to Example 8 is about 17% (of the compressive stress of Example AA); this trend reflects the unexpected benefits discussed above with reference to FIGS. 18-21 and is consistent with the trends in FIGS. 34, 36, and 38. For a given heat treatment condition, the compressive stress also increases going from condition K1 to condition K2 and further to condition K3. As shown, going from condition K1 to condition K3 (e.g., for Example AA) the compressive stress is increased by 3%. Further, as shown by the arrows in FIG. 40, the 17% increase in compressive stress (from Example AA to Example 8—both under condition K3) is additive (in addition) to the 3% increase in compressive stress (from condition K1 to condition K3-both for Example AA). Consequently, a total increase in compressive stress of about 21% (1.03×1.17) can be achieved by heating according to Example 8 and chemically strengthening under condition K3 (relative to Example AA under condition K1).

FIG. 41 schematically illustrates depth of layer (DOL) in micrometers (μm) on the vertical axis 4103 (i.e., y-axis) for substrates having composition C2 and a substrate thickness of 30 μm subjected to the heat treatments of Examples 5-8 and AA chemically strengthened under conditions K1-K3. As shown, the DOL within each chemical strengthening condition decreases going from Example AA to Example 5 and sequentially through Examples 5-8; for example under condition K3, the decrease in DOL from Example AA to Example 8 is about 23% (of the DOL of Example AA). For a given heat treatment condition, the DOL also decreases going from condition K1 to condition K2 and further to condition K3. As shown, going from condition K1 to condition K3 (e.g., for Example AA) the DOL decreases by 9%. Further, as shown by the arrows in FIG. 41, the 23% decrease in DOL (from Example AA to Example 8—both under condition K3) is additive (in addition) to the 9% decrease in DOL (from condition K1 to condition K3-both for Example AA). Consequently, a total decrease in DOL of about 30% (1−(1−0.09)*(1−0.23)) can be achieved by heating according to Example 8 and chemically strengthening under condition K3 (relative to Example AA under condition K1).

Table 4 presents the treatment conditions for Examples AAC, AAK, AAN, 8C, 8K, and 8N, where the glass-based substrate comprised composition C2 and had a substrate thickness of 100 μm. The 0.5 wt % silicic acid was added to the molten salt solution by superaddition (SA). Also, the maximum compressive Stress (CS) and depth of layer (DOL) are reported in Table 4. As shown, the heat treatment provided increased compressive stress for Examples 8K and 8C relative to Examples AAK and AAC. Example 8C had about 170 MPa additional compressive stress than Example AAK.

TABLE 4
Treatment Conditions and Properties of
Examples AAC, AAK, AAN, 8C, 8K, and 8N

| | Heat | Ion-Exchange | CS | DOL |
|---|---|---|---|---|
| Example | Treatment | Treatment | (MPa) | (μm) |
| AAN | n/a | n/a | n/a | n/a |
| 8N | 8 (650° C., | | n/a | n/a |
| | 30 min) | | | |
| AAK | n/a | 100 wt % KNO₃ + | 1138 ± 8 | 13.6 ± 0.1 |
| 8K | 8 (650° C., | 0.5 wt % silicic acid | 1241 ± 6 | 11.7 ± 0.1 |
| | 30 min) | (SA) at 410° C. for 33 | | |
| | | minutes | | |
| AAC | n/a | 90 wt % KNO₃ + | 1169 ± 5 | 13.8 ± 0.1 |
| 8C | 8 (650° C., | 10 wt % K₂CO₃ + | 1309 ± 4 | 11.9 ± 0.2 |
| | 30 min) | 0.5 wt % silicic acid | | |
| | | (SA) at 410° C. for 33 | | |
| | | minutes | | |

Table 5 presents mechanical properties measured for the Examples in Table 4 measured using the ring-on-ring (ROR) and the quasi-static puncture (QSP) tests discussed above. The ROR strength is the median strength (50% failure probability on a Weibull plot) while the B10 Strength refers to the stress at which 10% of the samples fail (10% failure probability on a Weibull plot). The results for the ROR test (both B10 strength and ROR Strength) mirror the trends seen for compressive stress: Examples 8N, 8K, and 8C have higher strengths than Examples AAN, AAK, and AAC, respectively; Example 8C has the highest strength (both B10 and ROR Strength) of the Examples shown in Table 5.

TABLE 5
RoR Strength and QSP Load for Examples
AAC, AAK, AAN, 8C, 8K, and 8N

| | B10 | ROR | | Flaw |
|---|---|---|---|---|
| | Strength | Strength | QSP Load | Depth |
| Example | (MPa) | (MPa) | (kgf) | (μm) |
| AAN | 1350 | 1450 | 3.03 | 0.14 |
| 8N | 1410 | 1480 | 2.83 | 0.13 |
| AAK | 1980 | 2140 | 3.22 | 0.29 |
| 8K | 2050 | 2300 | 3.46 | 0.27 |
| AAC | 2350 | 2450 | 3.66 | 0.17 |
| 8C | 2500 | 2730 | 3.75 | 0.14 |

For the QSP test, the QSP load for Examples 8K and 8C is greater than that for Examples AAK and AAC, respectively. Also, Example 8C had the highest QSP failure load of the Examples shown in Table 5. The flaw depth reported in Table 5 was calculated based on the ROR test using the expression σ=K_{IC}/(Y*√a), where the fracture toughness K_{IC} of composition C2 is 0.71 MPa √m, Y* is a constant related to the samples geometry that was 1.24 here, σ is the ROR strength minus the CS, and a is the effective flaw depth. Lower calculated flaw depths are associated with higher strength and higher quality of the sample. As shown in Table 5, Examples 8N, 8K, and 8C have lower calculated flaw depths than Examples AAN, AAK, and AAC. Indeed, Example 8C has the lowest calculated flaw depth of the Examples reported in Table 5.

The above observations can be combined to provide unexpected increases in compressive stress in a chemically strengthened foldable substrate by heating the foldable substrate prior to being chemically strengthened. Unexpectedly, as demonstrated by the examples herein (e.g., see FIGS. 18-19 and 21), the heating can enable increased compressive stress to be developed from the chemical strengthening even though the duration of the heating too short (and/or the temperature too low) to significantly modify the fictive temperature. In contrast to annealing, the heating of the present disclosure is at a temperature less than the annealing temperature and for a period of time less than or equal to 1.5 hours. Further, FIG. 19 demonstrates that the increase in compressive stress is largely time-independent—for as short as 1 minute—in contrast to the expected time-dependence. For example, these results indicate that compressive stress increases comparable to that of an 8+ hour heat treatment can be achieved by a 30-minute heat treatment (16× less time). This indicates that comparable increases in compressive stress can be achieved by shorter duration heat treatments than would have otherwise been thought possible. Also, this represents a significant savings in energy costs (for maintaining the temperature during the heat treatment) and increased throughput (due to shorter heat treatments). Moreover, FIG. 21 demonstrates that this increase in compressive stress cannot be attributed to changes in the fictive temperature since the fictive temperature is not significantly decreased by the heating.

The temperature range of the heating associated with the unexpectedly increased compressive stress is bounded, as shown in FIG. 18. At higher temperatures, changes in fictive temperature become more pronounced. At lower temperatures, the compressive stress is decreased as a result of heating. Consequently, the unexpectedly increased compressive stress as a result of the heating occurs between 150° C. below the annealing point temperature to less than the annealing point temperature (e.g., 10° C. less than the annealing point temperature)—with more pronounced increases in compressive stress seen in the range from 100° C. below the annealing point temperature to 25° C. less than the annealing point temperature. Also, heating the foldable substrate before chemically strengthening the foldable substrate can reduce thermal shock to the foldable substrate in addition to facilitating a more even compressive stress region across the surfaces of the foldable substrate.

Additionally, providing the first potassium salt with multiple (i.e., two or more) potassium atoms per anion can increase an effective concentration and/or activity of potassium in the molten salt solution, which can facilitate increased maximum compressive stress in the resulting chemically-strengthened foldable substrate. Providing a first potassium salt in the molten salt solution with a pKa of 9 or above can improve the strength and/or foldability of the resulting chemically-strengthened foldable substrate, for example, by selectively etching flaws inherent in the foldable substrate that might otherwise be magnified by the chemical strengthening treatment. Exemplary aspects of potassium salts with more than two potassium atoms per anion and a pKa of 9 or more include potassium carbonate (K₂CO₃) and potassium phosphate (K₃PO₄). Providing pH from 9 to 12 of the molten salt solution can improve the strength and/or foldability of the resulting chemically-strengthened foldable substrate, for example, by selectively etching flaws inherent in the foldable substrate that might otherwise be magnified by the chemical strengthening treatment.

Additionally, without wishing to be bound by theory, it is believed that the carbonate anion can facilitate precipitation of other cations (e.g., lithium, sodium) exchanged out of the foldable substrate, which can increase a longevity of the molten salt solution (e.g., by removing components from the solution phase that could otherwise “poison” the molten salt solution). As demonstrated by the Examples discussed herein, providing a first temperature of the molten salt solution less than 400° C. can increase a maximum compressive stress developed for a predetermined depth of layer and/or depth of compression. Also, for some of the molten salt solutions discussed herein, a temperature of 350° C. or more may be used to ensure that salts are molten. Further, increases in compressive stress from the heating are cumulative with increases using the molten salt bath having multiple anions (e.g., including the carbonate anion), as demonstrated in FIGS. 34, 36, 38, and 40.

For example, the presence of the first potassium salt can increase a compressive stress imparted by the contacting the existing first major surface (in at least step 1005) with the molten salt solution 1303 by 5% or more (e.g., 10% or more, from 5% to 20%, from 5% to 15%, or from 7% to 10%) relative to immersing the foldable substrate in a comparative molten salt solution with the same composition as the molten salt solution with the absence of the first potassium salt-even when the foldable substrate is heat treated in step 1003. As demonstrated by the examples herein, the combination of the heat treatment (step 1003) and the multiple anions in the molten salt solution (step 1005) provides further increases to compressive stress relative to doing either treatment on its own. Providing an initial temperature of the cooling chamber that is lower than the molten salt solution (e.g., by 50° C. or more, 100° C. or more, or 140° C. or more) can decrease a residual chemical strengthening occurring from any residual portion of the molten salt solution or deposits from the molten salt solution on the foldable substrate after it is removed from the molten salt solution). In particular, it has been observed that foldable substrates with a thickness of 50 μm or less (e.g., from 10 μm to 50 μm or from 10 μm to 30 μm) are unexpectedly sensitive to what happens after the foldable substrate is removed from the molten salt solution. For these thin foldable substrates, even a relatively small difference in compressive stress across the surface thereof can result in waviness and/or warp that can produce optical distortions that can be visible to a user of a consumer electronic product that the foldable substrate may be incorporated in. Consequently, the controlled temperature of the cooling chamber can facilitate a relatively even compressive stress across the surface of the foldable substrate. Also, providing an initial temperature of the cooling chamber of 180° C. or more (e.g., 200° C. or more or 220° C. or more) can facilitate the removal of a residual portion of the molten salt solution before it solidifies. Reducing the temperature of the cooling chamber to a final temperature of 90° C. or less can enable the foldable substrate to be subsequently treated (e.g., relatively quickly or immediately) thereafter using aqueous solutions (e.g., rinsing with water or an alkaline detergent solution, contact with an aqueous acidic solution). Providing a cooling rate from 4° C./min to 20° C./min can quickly reduce a temperature of the cooling chamber (and foldable substrate) while being able to maintain a relatively consistent temperature throughout the cooling chamber (and/or foldable substrate), for example, to produce a relatively consistent compressive stress across the surface of the foldable substrate.

Taken together, FIGS. 30-31 demonstrate that the heating of Example 3 provides the warp and curvature metrics (including maximum, skewness, and kurtosis) that is comparable or better than Example AA while Example 3 further provides increased compressive stress (and foldability) relative to Example AA. Providing an etching rate of 1.0 μm/min or less (e.g., 0.55 μm/min or less) can facilitate a substantially uniform removal of material from the surface(s) of the foldable substrate. As discussed above, foldable substrates with a thickness of 50 μm or less are quite sensitive to differences in compressive stress and thickness variation across its surface. Consequently, providing an etching rate of 1.5 μm/min can remove a relatively uniform thickness and portion of the compressive stress from the surface(s) to reduce an incidence of waviness and/or warp that can produce optical distortions that can be visible to a user of a consumer electronic product that the foldable substrate may be incorporated in.

It has been observed that foldable substrates with a thickness of 50 μm or less are unexpectedly sensitive to what happens after the foldable substrate is removed from the molten salt solution. For these thin foldable substrates, even a relatively small difference in compressive stress across the surface thereof can result in waviness and/or warp that can produce optical distortions that can be visible to a user of a consumer electronic product that the foldable substrate may be incorporated in. Consequently, the controlled temperature of the cooling chamber can facilitate a relatively even compressive stress across the surface of the foldable substrate. Also, providing an initial temperature of the cooling chamber of 180° C. or more (e.g., 200° C. or more or 220° C. or more) can facilitate the removal of a residual portion of the molten salt solution before it solidifies. Without wishing to be bound by theory, the first potassium salt can have a higher melting temperature than the second potassium salt, which means that incorporating the first potassium salt in the molten salt solution can increase a viscosity of the molten salt solution and/or cause the molten salt solution to solidify at higher temperature than a molten salt solution without the first potassium salt. Consequently, allowing a residual portion of the molten salt solution on the foldable substrate after it is removed from the molten salt solution can be especially useful when the molten salt solution includes the first potassium salt. Reducing the temperature of the cooling chamber to a final temperature of 90° C. or less can enable the foldable substrate to be subsequently treated (e.g., relatively quickly or immediately) thereafter using aqueous solutions (e.g., rinsing with water or an alkaline detergent solution, contact with an aqueous acidic solution). Providing a cooling rate from 4° C./min to 20° C./min can quickly reduce a temperature of the cooling chamber (and foldable substrate) while being able to maintain a relatively consistent temperature throughout the cooling chamber (and/or foldable substrate), for example, to produce a relatively consistent compressive stress across the surface of the foldable substrate.

Directional terms as used herein—for example, up, down, right, left, front, back, top, bottom—are made only with reference to the figures as drawn and are not intended to imply absolute orientation.

It will be appreciated that the various disclosed aspects may involve features, elements, or steps that are described in connection with that aspect. It will also be appreciated that a feature, element, or step, although described in relation to one aspect, may be interchanged or combined with alternate aspects in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.”

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements, or steps of particular aspects may be disclosed using the transitional phrase “comprising,” it is to be understood that alternative aspects, including those that may be described using the transitional phrases “consisting of” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including”, and variations thereof shall be construed as synonymous and open-ended unless otherwise indicated.

The above aspects, and the features of those aspects, are exemplary and can be provided alone or in any combination with any one or more features of other aspects provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

What is claimed is:

1. A method of treating a glass substrate:
heating the glass substrate a first temperature for a first period of time from greater than or equal to 1 minute to less than or equal to 2 hours to form a heat-treated glass substrate, the first temperature is less than an annealing point of the glass substrate by from greater than or equal to 10° C. to less than or equal to 150° C., and the glass substrate having a substrate thickness between a first major surface and a second major surface in a range from greater than or equal to 25 micrometers to less than or equal to 300 micrometers; and
chemically strengthening the heat-treated glass substrate to form a chemically strengthened glass substrate having a first compressive stress region extending from the first major surface to a first depth of compression from greater than or equal to 5 μm to less than or equal to 30% of the substrate thickness.

2. The method of claim 1, wherein the first temperature is less than an annealing point of the glass substrate by from greater than or equal to 50° C. to less than or equal to 75° C.

3. The method of claim 1, wherein the first period of time is from greater than or equal to 5 minutes to less than or equal to 1.5 hours.

4. The method of claim 1, wherein the heating occurs in air or in a non-strengthening molten salt solution, where the heating does not develop a compressive stress region in the heat-treated glass substrate.

5. The method of claim 4, wherein the heating occurs in the non-strengthening molten salt solution non-strengthening molten salt solution comprises an alkali chloride or an alkali sulfate salt.

6. The method of claim 1, wherein the heat-treated glass substrate is maintained at a temperature greater than or equal to 300° C. between the heat treating and the chemically strengthening the heat-treated glass substrate.

7. The method of claim 1, wherein a maximum compressive stress of the first compressive stress region is from greater than or equal to 800 MegaPascals to less than or equal to 1,500 MegaPascals.

8. The method of claim 1, wherein a maximum compressive stress of the first compressive stress region is greater than a comparative compressive stress of a comparative compressive stress region of a glass substrate chemically strengthened without the heating by greater than or equal to 10% of the comparative compressive stress, wherein a comparative etching rate of a glass substrate chemically strengthened without the heating is greater than an etching rate of the chemically strengthened glass substrate including the heat treatment by greater than or equal to 3% to less than or equal to 10% of the comparative etching rate, and wherein a comparative minimum parallel plate distance of a glass substrate chemically strengthened without the heating is greater than a minimum parallel plate distance of the chemically strengthened glass substrate by greater than or equal to 10% of the comparative minimum parallel plate distance.

9. The method of claim 1, wherein the chemically strengthened glass substrate exhibits a shape kurtosis from greater than or equal to 2 to less than or equal to 6, wherein the chemically strengthened glass substrate exhibits a warp of less than or equal to 1 millimeter.

10. The method of claim 1, wherein at least one of:
the chemically strengthened glass substrate exhibits a shape skewness from greater than or equal to −1.5 to less than or equal to 1.5,
the chemically strengthened glass substrate exhibits a maximum curvature less than or equal to 1 Diopter, and
the chemically strengthened glass substrate exhibits a curvature skewness from greater than or equal to −1 to less than or equal to 1 and a curvature kurtosis from greater than or equal to 2 to less than or equal to 4.

11. The method of claim 1, wherein:
the chemical strengthening comprises contacting the heat-treated glass substrate with a molten salt solution maintained at a second temperature from greater than or equal to 350° C. to less than or equal to 450° C. for a second period of time from greater than or equal to 10 minutes to less than or equal to 180 minutes,
the molten salt solution comprises at least two anions associated with at least a first potassium salt and a second potassium salt, a concentration of the first potassium salt potassium salt and a concentration of the second potassium salt is greater than or equal to 2 wt % to less than or equal to 12 wt % of the molten salt solution, the second temperature is from greater than or equal to 350° C. to less than or equal to 400° C., and the second period of time is from greater than or equal to 10 minutes to less than or equal to 90 minutes, and
the first potassium salt comprises two or more potassium atoms per anion, and a pKa of the potassium salt is greater than or equal to 9, and a concentration of the first potassium salt is in a range from greater than or equal to 2.0 wt % to less than or equal to 5.0 wt % of the molten salt solution.

12. The method of claim 11, wherein the first potassium salt is potassium carbonate K₂CO₃, and a concentration of the first potassium salt is in a range from greater than or equal to 2.0 wt % to less than or equal to 5.0 wt % of the molten salt solution.

13. The method of claim 11, further comprising:
transferring the substrate from the molten salt solution to a cooling chamber, a temperature of the cooling chamber decreases from an initial temperature to a final temperature at a cooling rate in a range from greater than or equal to 4° C./min to less than or equal to 20° C./min, the initial temperature is in a range from greater than or equal to 180° C. to less than or equal to 300° C., and the final temperature is in a range from greater than or equal to 25° C. to less than or equal to 90° C.

14. The method of claim 1, further comprising:
contacting the first major surface with an acidic solution for a second period of time to remove an outer layer from the first major surface to form a new first major surface; and then
rinsing the new first major surface with water or an alkaline detergent solution.

15. The method of claim 14, wherein a pH of the acidic solution is in a range from 3.5 to 4.5, and the second period of time is from 10 seconds to 3.5 minutes, wherein the acidic solution removes the outer layer at rate of 1.0 micrometers per minute or less.

16. The method of claim 1, wherein the substrate thickness is from greater than or equal to 30 micrometers to less than or equal to 100 micrometers.

17. The method of claim 1, wherein the foldable substrate exhibits a survival rate of greater than 50% at a parallel plate distance in millimeters equal to 0.08 mm/μm times the substrate thickness in micrometers.

18. The method of claim 1, wherein a composition of the glass substrate, as a mol % of the glass substrate, comprises:
from greater than or equal to 60 mol % to less than or equal to 70 mol % SiO₂;
from greater than or equal to 8 mol % to less than or equal to 16 mol % Al₂O₃;
from greater than or equal to 12 mol % to less than or equal to 18 mol % Na₂O;
from greater than or equal to 2 mol % to less than or equal to 6 mol % MgO; and
from greater than or equal to 0.1 mol % to less than or equal to 2.0 mol % CaO.
